(19) United States
(12) Patent Application Publication
(10) Pub. No.: US 2004/0162807 A1
(43) Pub. Date: Aug. 19, 2004

(54) Cooperative, simultaneous operation on data by many processes, with concurrent retention of process status, resumed processing, and minimal consumption of inter-nodal throughput

(76) Inventor: Michael D. Montagne, Sumpter, OR (US)

Correspondence Address: BURNS DOANE SWECKER & MATHIS L L P, POST OFFICE BOX 1404, ALEXANDRIA, VA, 22313-1404, US

(21) Appl. No.: 10/748,194

(22) Filed: Dec. 31, 2003

Related U.S. Application Data
(60) Provisional application No. 60/447,292, filed on Feb. 14, 2003.

(51) Int. Cl. G06F 7/00

(52) U.S. Cl. 707/1

(57) ABSTRACT

A method and apparatus for cooperative, simultaneous processing of public data by many processes; for concurrent retention of process status; for resumption of processes; and for minimal consumption of inter-nodal throughput, comprises initializing from concurrently registered focus and processing phases; privately isolating public data in representative states concurrently registered to retentive media; operating on private states; and, uniformly, either dedicating timely, obligatory write operations to delegated cooperative posting objects, or conditionally attempting to write, and ensuring write operations will be performed in an environment which can sustain intended operations, by repeatably attempting to secure permission to write, and thereupon writing altered data to public data instances in a substantially minimized period, thereby engendering substantially maximized write opportunity and sustainability across the environment.

### CROSS REFERENCE TO RELATED APPLICATIONS

This application claims the benefit of U.S. Provisional Application No. 60/447,292, filed Feb. 14, 2003, which is hereby incorporated herein by reference in its entirety.

### BACKGROUND OF THE INVENTION

1. Field of the Invention

The present invention relates to cooperative, simultaneous operation on data by many processes; to concurrent retention of process status; to resumed processing; and to minimal consumption of inter-nodal throughput.

2. Definition of Terms

To facilitate the reader's understanding of the invention, a number of terms used in this disclosure are defined as follows:

Possible meanings of “application” may include processes, software applications, hardware applications, or operating systems of any kind, including traditional operating systems or systems which extend functionality to further wares, however modularized, operating on data.

The term “comparison-distribution instance” as used herein, means an assignment-compatible structure used for comparison or distribution of data instances. Distribution may for instance involve assigning a record to or from a “comparison-distribution instance.” Comparison may for instance involve comparing a field of a record to a like field of a “comparison-distribution instance” record.

The term “concurrently” as used herein, qualifies a second action as being “mandatorily invoked in response to a first action.” In this sense, the first and second actions can be considered to be “tied” to one another. For example, in the phrase “concurrent registration to retentive media”, the term “concurrent” indicates that the step of registration to retentive media is mandated by (and therefore tied to) a first action, which in this case is generation of the state to be retained. It is preferred that the second action be caused to occur, to whatever extent as is possible or practical, without delay, although this is not an essential aspect of the invention. Between the tied first and second actions, “concurrent” may mean either of no delay, or of no substantial delay within a series of immediate tasks, particularly in which the objects of concurrent registration may be achieved to within milliseconds, and the consequences of the remote possibility of failure of a process which may be performed in milliseconds may merely be that the undamaging, resumable status of the previous milliseconds' prevails.

The term “cooperative resources” as used herein, means public resources containing the subject public data instance, the collection of private state instances maintained in relation to processing, any resources augmenting the processing of public data and private data related to the public data, and any resources used to negotiate public data instances or the collected private state instances maintained in relation to processing.

The term “inter-nodal throughput” as used herein, means the capacity for an inherent volume of communication and processing between nodes of interconnected systems. Examples of inter-nodal throughput would be the inherent volume of communication and processing which can transpire by given hardware and software processing data between servers and client workstations of common networks. The less restrictive term, “throughput,” as used herein, may include communication and processing which may not have to traverse between nodes of interconnected systems. “Throughput” therefore may involve “inter-nodal throughput” or communication and processing between an application and public data resources which may reside altogether within a given node, and which may not require traversing conduits between separate nodes.

The term “negotiate” as used herein, as applied to tables, means navigating or processing the table. The term “negotiate” as used herein, as applied to data instances which are not members of formal table systems, means focusing or processing the data instance. The term “negotiate” as used herein, as applied to cooperative resources, means managing the availability of cooperative resources to processes, or focusing, navigating, or processing the cooperative resources.

The term “registration” as used herein, means writing to retentive media by an organization from which cooperative processing objects can consistently make registered states available to the processes of an application.

The term “relational registration of status” as used herein, means maintenance of states related to possible multiple instances of operation of applications embodying the present invention. Relational registration of status may for instance be achieved by organizing private work areas in relational tables, in which a regular organization of private states is related to governing respects for which an application is intended to maintain status.

The term “remotely mirrored state” as used herein, means a replicated instance of a locally processed state, retained on a remote system.

The term “retentive media” as used herein, means media capable of retaining registered data across application sessions, despite normal intended events such as termination of power, and despite normal unintended events such as loss of power.

The term “thin client” as used herein, describes possible implementation of a distributed application often composed of minimal functionality, and therefore, where more complex operations are performed, often necessarily interacting with a remote application to perform the objects of the applications altogether. Thin client application implementations may for instance be used on the Internet, in order to efficiently distribute a lighter bulk to and from the client, with the majority of processing potential often residing on a server. In the case of the present invention, remote CPO may provide remote processing.

### DESCRIPTION OF THE RELATED ART

Heretofore, computer processes have competed preclusively for control of data.

In conventional applications, because only one process can write to particular data at once, and thus to eliminate simultaneous write attempts, a convention such as “locking” tokenizes ownership of an exclusive, singular permission to write. Unless simultaneous writing of particular data can and should be resolved, some such convention is necessary for supportable write processes to prevail.

A locked data instance, or its equivalent, has effectively dedicated its singular write privilege to a given process. That process alone can write to the instance over the duration of the lock. At the conclusion of write-necessitated duration, however long, the owning process frees the lock, thus providing further processes the opportunity to obtain the exclusive privilege of writing to the data instance.

As no means or apparatus exists to minimize lock duration across conventional systems, conventional processes may obtain and hold locks substantially beyond a theoretic minimum duration defined by the time it takes to write only concluded phases of operations, without interruption, interceding operation, pause, or inactivity existing in the lock cycle. As locks can persist in conventional systems, possible lock persistence beyond practical capacities to tolerate lock non-availability engenders critical probabilities waiting processes will be precluded by lock denial.

As no means or apparatus either exists to suspend or to re-award locks won by an initial process, therefore to ensure a commenced operation succeeds, winning processes may necessarily retain locks as required by the necessary reliability of completing the operations related to the lock. By prior convention then, to begin a series of operations potentially writing to a data instance, operations of indeterminate duration may need to acquire a lock to perform an initial phase of writing. If then, in the interest of reducing-contention, an uncompleted process were to temporarily give up its lock, then conclusion of the process and reversion of the uncompleted process both are impossible upon failure to re-acquire the lock. To give up a lock which is necessary ultimately to finishing an operation therefore introduces the possibility of unrecoverable failure.

On the other hand, to retain locks over operations of indeterminate duration means locks can persist however long indeterminate operations ultimately require. This in turn introduces the alternate possibility of failure upon denial of write permission.

Thus in conventional systems, any lock which persists beyond the capacity of a subsequent process to tolerate lock denial, engenders failure of the subsequent process. Accordingly, in broad operations which may necessarily write to many data instances, because of the many instances in which locks must be acquired if the entire process is to be completed successfully, even higher probabilities exist for unresolved contention, while possibly disastrous consequences to the process as a whole can precipitate from a single case of persistent lock denial.

The possible duration of locks therefore puts into question both whether process completion is possible, and, if not, whether and how it is possible to recover from process preclusion. In ostensibly reliable software development, tremendous costs are regularly related to both issues, as they often call into play broad and difficult, if not heretofore unsolved areas of engineering. Even if failed processes can recover from unresolved contention without performing their objects, the mere possibility of unresolved contention means unresolvable failure arising in non-performable processes.

Potential preclusive locks are exemplified by operations of typical data-aware controls, which may either display data or provide for manually editing fields of data instances such as table records. In order to perform intrinsic operations, conventional data editing controls are given necessary powers such as to request locks necessary to operate on the focused data.

To maintain data integrity in deploying data-aware controls, in order to avoid posting unvalidated, edited data to a record, it is typically necessary for instance to validate multiple fields of a focused record before a lock on the record can be freed. For instance, given certain circumstances, the value of an integer field may be required to fall within the range of 1 to 5 inclusive, while the circumstances may in part be comprised of the editable values of other fields of the same record. Given alternative circumstances, the value of the integer field may be required to fall within the range of 6 to 10 inclusive. Intended validation processes, ensuring the value of the field falls within the intended range for the existing circumstances, therefore may only be performable after multiple fields of a record might be manually or automatically edited. Tentatively concluded editing of a field addressed by a control therefore does not directly intimate conclusive editing of a record. Data-aware controls thus cannot rightly be endowed with an independent power to free the lock to a record at an assumed conclusion of editing a targeted field.

In order to operate directly on a field however, conventional data-aware controls must acquire a lock on the record or prevailing unit of locked data the moment the control begins writing to the field. By prior convention then, a lock often must persist from the beginning of potential write operations until an ultimate result of broader, record-wide processes is ascertained. Thus, once writing to a field is initiated with a data-aware control, merely because the operator might thereafter leave the process unattended, it is possible a lock might persist across a coffee break, meeting, or even days.

Because conventional operations impose such opportunities or even requisites for locks to persist, operations in conventional systems are confronted with the substantial and critical possibility of precluded write obligations. The probability of lock denial and the lack of means and apparatus to resolve contended locks together, are often why in conventional systems for instance, critical enterprise-wide operations are regularly performed in the absence of possibly contending operations, capable of imposing preclusive locks.

Conventional systems therefore suffer huge disadvantages in both a probability of non-performable operations, and in the possibility of failure to recover from any possible state of denied operations, however complex the overall process. Particularly, conventional systems impose the need to engineer for responsibilities which often prove exceedingly challenging, if not untenable within the prior art. No conventional method exists, accounting for unresolved contention and process failure in as much as every instance of writing to public data.

Consequently, conventional systems impose huge disadvantages upon end users, manifested in the many further costs and consequences of sensitive deployment issues. In conventional systems, inherently sensitive operations are necessarily understood in terms sufficient to avoid, and if possible recover from, critical preclusion of any phase of operations. Important enterprise-wide operations are regularly, necessarily performed in the absence of competing processes. Ongoing work, necessarily performed by multiple, potentially contending processes, regularly results in breakdown. Data integrity is regularly ruined by failed processes, often with no means to reliably or automatically detect and rectify details of complex, failed transactions. Further operations, potentially based on flawed data, might introduce substantial further flaws, making the resultant system of flaws tremendously difficult to repair. Unresolved process failure, resulting in a diversity of consequences, including corruption of vital file structures, often make it necessary to restore a previous status of processed data, and to re-perform all interceding work, even across entire enterprises. Failed processes often mean disastrous and extremely costly consequences.

In conventional systems therefore, the singular, exclusive nature of locks means that further processes needing to write to a public data instance contend with any process, however indeterminate, which has already won the lock by virtue of opportunity. Over the duration of the lock, however persistent, all further processes needing to write to the public data instance can only be denied the opportunity to perform vital obligations to write to the public data instance. Particularly, no conventional means or apparatus make it possible for many processes to operate on particular data simultaneously, within means and apparatus in which processing states and resumable processing will even survive failure of the outer operating environment.

Nor do applications in a conventional environment truly work as we intend, particularly to resume ongoing work, even after inadvertent termination. If for instance a conventional model of retaining operational status by registering operational status at shutdown is followed, failure of the operating environment may preclude registration of current operational status, making resumption of actual status impossible. It is not practical to attempt to provide resumable processing of the entire operational status of applications in conventional systems, particularly as reliability issues introduce even more convoluted questions of how to detect and recover from prevalent failure to register status.

The benefits of reliable, resumed processing however would be considerable. For example, if an application negotiates 120 tables, then at an expense of 30 seconds per interface to manually restore focus of previous sessions, an hour is lost at application initializations, if, and only if operators are so diligent as to recall relevant focus. To reliably resume the very processing status of the application however means every transaction, however tentative, is automatically restored at application re-start, even after inadvertent session termination.

The prospect of applications and systems, however complex, reliably and automatically resuming operations, means the advent of a new genre of application. Operating systems of such a genre for instance, can simply re-activate previously open applications at system startup, and the applications in turn, likewise simply resume their former status, even after power loss.

A further object of the related art is minimal consumption of inter-nodal throughput. Achieving this object would provide the advantages of maximized sustainable system service, and of a higher ceiling under which unproblematic service is provided within the capacities of any operating environment.

Further possible advantages arise in the advent of a generic technology to accomplish these objects, as a consistent set of methods makes it possible to integrate the technology within pre-built development templates, and to further integrate consistent documentation of the technology with the development templates, to eliminate substantial costs of development.

Conventional practice has largely accepted that opportunity-related, exclusive write privileges predicate an environment where simultaneous operation on data is impossible. Resolved, cooperative operation, and reliable, resumed processing, have to now only been futuristic concepts.

### BRIEF SUMMARY OF THE INVENTION

General objects of the invention therefore are to provide means and apparatus for cooperative, simultaneous operation on data by many processes; for concurrent retention of process status; for reliable resumed processing; and for minimal consumption of inter-nodal throughput. Further objects and advantages are apparent from the drawings and detailed description.

Further possible advantages arise in the advent of a generic technology to accomplish these objects, as a consistent set of methods makes it possible to integrate the technology within pre-built development templates, and to further integrate consistent documentation of the technology with the development templates, to eliminate substantial costs of development.

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with an aspect of the invention, cooperative processing of public data comprises distributing the public data to private representative states. Without holding an exclusive privilege to write to the public data, one or more private states of the public data are generated by processing one or more representative states of the public data. The public data is then updated by cooperatively posting data from the private representative states.

In another aspect of the invention, at least one of the generated private states are concurrently registered to retentive media.

### BRIEF DESCRIPTION OF THE SEVERAL VIEWS OF THE DRAWINGS

Persons reasonably skilled in relevant disciplines will understand the objects and advantages of the invention from the detailed description and drawings herein, of which:

FIG. 1 is a data and control flow diagram of a conventional system.

FIG. 2 is a data and control flow diagram of an alternative, “differentiating” embodiment.

FIG. 3 is a data and control flow diagram of an alternative, “differentiating” embodiment.

FIG. 4 is a data and control flow diagram of an alternative, “differentiating” embodiment.

FIG. 5 is a data and control flow diagram of an alternative, “non-differentiating” embodiment.

FIG. 6 is a data and control flow diagram of a “delegated cooperative posting” embodiment.

FIG. 7 is a flow diagram of principal disadvantages of conventional systems solved by the present invention.

FIG. 8 is a flow diagram of “direct,” “differentiated cooperative posting.”

FIG. 9 is a flow diagram of “direct,” “non-differentiated cooperative posting.”

FIG. 10 is a flow diagram of “delegated cooperative posting.”

FIG. 11 is a timeline of write permission duration during operations of conventional systems.

FIG. 12 is a timeline of write permission duration for “direct cooperative posting.”

FIG. 13 is a timeline of write permission duration for “delegated cooperative posting.”

FIG. 14 is a flow diagram of “direct cooperative posting.”

FIG. 15 is a flow diagram of “extended, direct, cooperative write-related operations.”

FIG. 16 is a flow diagram of “extended, delegated, cooperative write-related operations.”

FIG. 17 is a data and control flow diagram of an alternative, “cooperative, thin client, locally and remotely processed” embodiment with differentiated or non-differentiated cooperative posting.

FIG. 18 is a data and control flow diagram of an alternative, “cooperative, thin client, locally and remotely processed” embodiment with differentiated or non-differentiated cooperative posting and remotely mirrored states.

FIG. 19 is a data and control flow diagram of an alternative, “cooperative, thin client, locally and remotely processed” embodiment with delegated cooperative posting and remotely mirrored states.

FIG. 20 is a flow diagram of an alternative initialization process automatically resuming application focus and processing.

FIG. 21 is a flow diagram of an alternative embodiment in which, during navigation and processing of an application, CPO automatically manage cooperative resources, and resumable application focus and processing status are concurrently registered.

FIG. 22 is an object and control flow diagram of a cooperative client-server or desktop application development template.

FIG. 23 is an object and control flow diagram of a cooperative server-side application development template.

### DETAILED DESCRIPTION OF THE INVENTION

### Conventions Used in this Description

Abbreviations and acronyms used in the specification are enclosed in parentheses following a usage from which the abbreviation or acronym is derived.

In the drawings, the suffix ‘A,’ ‘B,’ ‘D,’ or ‘H’0 indicates association with a respective public data instance or table likewise bearing the suffix ‘A,’ ‘B,’ ‘D,’ or ‘H.’ The suffix ‘X’ indicates an element or instance of conventional technology. The suffixes ‘C,’ ‘T,’ or ‘I,’ used in reference to an application, indicate cooperative embodiments in accordance with the present invention.

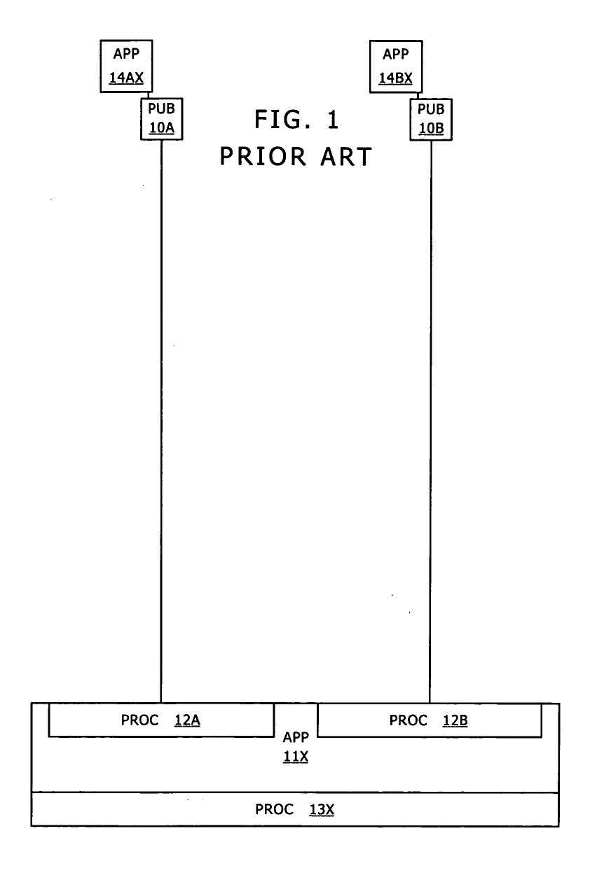

In FIGS. 1 through 6 inclusive, horizontal rows of data instances indicate membership to a hypothetical, formal table, privately maintained in relation to the public data instance. In each example of embodiments of the present invention, components negotiating such tables provide one record cursor per negotiating component, which components therefore, by virtue of the record cursor, provide focus to a record of the table, addressable by its' fields, however many.

Public data is referred to by instance, which instance, may be a member of a formal table, as commonly referred to as a “record.” The structures of instances may be comprised of fields, which such structured instances are also commonly referred to as “records.” In the examples, formal tables are used for the purpose of illustrating more complex classes of operations as performed by the invention, but the illustrative examples are not to be taken as restrictive to applications of formal tables. Operations on a single instance of public data independent of a table for example will not require table navigation to negotiate with the given data instance. The many methods of negotiating data instances, regardless of membership to a larger data set, are well known to the present art, and therefore are not described here in detail.

In the examples, privately isolated states are registered to retentive media by virtue of being members of formal tables registered to retentive media. Conventional data-aware controls are readily connected to fields of such tables, and usually, thereby, each such data-aware control represents a field of a record of a table by virtue of independent placement of a singular record cursor on a given record of the table, often for instance represented to the application or process by a component or components interfacing with the table and typically providing a singular record cursor per instance of the components. Some data-aware controls merely display a representation of the value of a field. Some data-aware controls provide for manually editing the value of a field. Typically, by virtue of the record cursor, the operated field is the given field of the record indicated by the record cursor.

To achieve the objects of the invention, it may not be necessary to register “comparison-distribution instances” to retentive media. In the examples, for the sake of presenting a clearly understandable, uniform form of data instances, formal tables are used to contain comparison-distribution instances, which results in comparison-distribution instances being registered to retentive media, concurrent with processing. However, comparison-distribution instances may exist in any form which necessarily is assignment compatible to the related public data instance. A further alternative embodiment of the invention therefore is to combine the private states and comparison-distribution instances of any embodiment in objects serving the same purposes of comparison or distribution, or retention, with the representative data instances addressed as elements of the objects. What is illustrated in the examples as separate tables of private data states may be retained for instance within a singular file of any appropriate kind. The examples therefore are not to be taken as restrictive, as the intention of the examples is to abstract the process of engineering embodiments of the invention from any appropriate classes of objects.

“Auxiliary states” are maintained for purposes not necessarily related to the subject public data instance, such as retention of a located record. For instance, data-aware controls may display the auxiliary state in a search dialog, capable then from the retained auxiliary state of restoring and relocating a public data instance regardless of interceding session terminations, however inadvertent.

As a “field” of a formal “record” structure is the smallest subunit of a record which must be considered as a whole determining the value of the record, such smallest, determinative subunits will be referred to by the term, “field.” As a purpose of the present invention is concurrent registration of states of data to retentive media, a registered state of data may likewise be referred to as a “record.” Records or public data instances may exist independently, or as records of formal tables. Public data instances addressed by the invention may be of any simple or complex structure. In cases where a data instance involves only a single field, processing of a “field” of a record therefore is to be understood to only involve such a single field, with “fields” implying a plural form of obvious or defined scope.

Regardless of the subject public data instance, the “Cooperative Processing Objects” of a given implementation may address elements related to the public data instance by the common organization of the elements. Among a group of public data instances addressed by given cooperative processing objects therefore, a given registered state may for instance be uniformly located by virtue of the state being registered uniformly to a given record of a table.

For clarity and uniformity, the spatial distribution of consistent, comparable, or related elements may be replicated across the drawings.

The various aspects of the invention are described in connection with a number of exemplary embodiments. To facilitate an understanding of the invention, many aspects of the invention are described in terms of sequences of actions to be performed by elements of a computer or other processing system. It will be recognized that in each of the embodiments, the various actions could be performed by specialized circuits (e.g., discrete or integrated logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

### OVERVIEW

Cooperative, Simultaneous Operation On Data

To achieve cooperative, simultaneous operation on public data, the invention isolates private representative states, where operations can be performed by focusing on the private representative states until confirmed operations as reflected in operated data are to be assigned to the public data state. Without needing to lock the actual public data, simultaneous operation on data is freely achieved in private work areas comprising collections of data states and resources related to a public data instance, meant to be the subject of operations of the governing process or application until confirmed processing is to be assigned to the public data state in an operation of substantially minimal duration.

Cooperative behavior in any sustainable environment is achieved particularly by substantially minimizing write duration, and by ensuring write processes can be performed under sustainable throughput. It is not necessary to the successful operation of the invention to achieve absolute minimum read or write durations. The methods of reducing read and write cycle duration are so effective as to make public data available for writing the approximate maximum time possible. “Sufficiently minimal” durations, as defined herein, particularly in the write cycle, achieve the objects of the invention in any environment which can reliably support necessary read and write incidence. Minimum read cycle durations are achieved by requiring only a single original state of the data. Minimal write cycle durations are achieved by alternative methods.

In one alternative write method, the privately processed data is written altogether to the public data instance. This method achieves the objects of the invention in appropriate circumstances, but has no power to determine what fields of a data instance have been processed. This method therefore is appropriate where re-writing the focused scope of data is tolerable.

In another alternative method, referred to herein as “direct,” “differentiated cooperative posting,” more complex data is conditionally written, comprehensive of any subdivisions of the data, by locally determining if and what alterations of the original data have occurred. Differentiation of a need to post is performed by comparing a local work state to a retained original state of the data, or to a last posted state of the data. In conjunction with posting, fields of the original state may optionally be updated to posted content by a process herein described as “differentiated cooperative posting, updating private states” (DCPUPS). Local “differentiation” by comparing a work state to an original state, or by comparing a work state to an original state as updated by DCPUPS (which makes the “original state” equivalent to a “last posted” state), consumes no inter-nodal throughput, as both the examined cases of data states and the examination process itself exist on the local terminus of inter-nodal throughput. Where private work areas are local to the governing application, it is not necessary to consume inter-nodal throughput at all therefore to “differentiate” any need to write locally performed alterations to the public data instance. If no alteration is locally detected by the examination process, no write operation is necessary. If a write cycle is necessary, only altered units are written to the public data instance. Thus in each case and phase, minimum inter-nodal throughput consumption is achieved, and many processes can operate on a same data instance simultaneously, writing only intended processing, however particular, to the public data instance.

With public data available to write processes the approximate maximum time possible, cooperative behavior is achieved therefore by ensuring that a write process will succeed in any environment which can sustain necessary operations. To ensure write processes will succeed in every such environment, write cycles are performed by a two-phase algorithm, first repeatably attempting to secure the public write privilege, and thereupon, performing a write process of substantially minimized duration. If contention for write privilege should occur under a system which can reliably sustain necessary operations, then across a system of embodiments of the present invention, an initially denied operation is successfully performed in a first successive opportunity, with successive opportunities potentially occurring at a rate of incidence of no more than a substantially minimal write duration.

The invention never therefore fails to support cooperative, simultaneous processing of data within an environment capable of supporting intended operations on data. Successful, cooperative, simultaneous processing is as great as can be supported by the given operating environment. Thus obstruction by persistent locks is overcome, and cooperative, simultaneous operation on data by many processes is provided.

Concurrent Retention of Process Status

A further advantage of the invention is concurrent retention of process status, as reflected in private states of the represented data. To achieve concurrent retention of process status, states are processed to retentive media.

Integrated Process States

Integrated process states is an inherent advantage of process focus on states concurrently registered to retentive media. As retained states are the direct subject of processes, states exist as an inherent, constant part of an application.

Minimal Consumption of Inter-nodal Throughput

Minimal consumption of inter-nodal throughput, in respect to processing data, is an advantage of “distributing” a single copy of data to its private work area, and of locally performing “direct,” “differentiated cooperative posting.” Read operations require only one copy of public data, comprising a minimal incoming transmission for processing the data. Write operations determine minimal outgoing write traffic, by locally differentiating any need to write without consuming inter-nodal throughput, and, where writing is necessary, by determining minimal units of data to be written to the public data instance.

General Advantages

There are many further advantages of the associated functions of the invention. For instance, embodiments of the invention can exist amongst non-compliant (conventional) applications, providing nonetheless to every embodiment of the invention a capacity to cooperatively process data, and to tolerate without damage or further provision by engineers, the preclusive behavior of conventional applications. Because applications embodying the invention concurrently retain process states, should the invention encounter preclusive locks imposed by conventional applications, the invention's attempts to process data remain resumable, even across inadvertent shutdown. Embodiments of the invention therefore, without adverse consequence, survive the inconsistencies of conventional practice, however preclusive.

Truly cooperative, concurrent processing is a vital goal of future applications, as non-cooperative, conventional processing comprises vast, unresolved obstructions to processing data. The invention therefore solves a broad expanse of problems plaguing conventional practice. The benefits to engineers, administrators, and end users, include elimination of all obstructions related to the potential for unresolved contention in conventional practice. One benefit of this alone is simultaneous operation on data by every sustainable process of a system. Further benefits of reliable simultaneous processing are reliable integrity of the data system itself, and reliable, concurrent maintenance of data. The means and apparatus of accomplishing simultaneous operation on data however, further mean applications embodying the invention serve as safe containers for suspended operations related to or resulting from a myriad of further difficulties such as lost network connectivity, failure of hardware, or failure of operating systems. Embodiments of the invention thus provide both for suspension and automatic resumption of processing, even after failure of diverse, vital components of a system.

### Important Concepts to be Understood from this Description

Registration and Restoration of Process Status

An object of the invention is reliable registration and restoration of process states as reflected in data. Without concurrent registration of relevant status to retentive media, it is possible for obstructive events to intercede before the opportunity to otherwise, eventually register process status as reflected in data. In embodiments of the invention, concurrent registration of status ensures status persists at initialization, because the application processes the very status itself. Applications embodying the invention therefore comprise ongoing, resumable processing.

Simultaneous Operation on Data

Simultaneous operation on public data is achieved by operating on representative states in private work areas, with affirmed operations on private, representative states written to public data as necessary.

Cooperative Behavior

In the present invention, cooperative behavior therefore is achieved on the one hand by sufficiently minimizing write durations so that across a system of embodiments of the present invention, wherein necessary write operations are performed, maximal write opportunity prevails; and on the other hand, by ensuring as much as possible, that write processes will succeed. In the latter object, alternative methods of delegated writing, or repeatable attempts to secure the write privilege, succeed, because the opportunity to write exists within any environment capable of sustaining necessary write operations, and because alternative methods of the invention therefore will perform the write operation in any environment providing practical opportunities to write.

Simultaneous Operation on Data by Many Processes

While embodiments of the present invention provide for an unlimited number of network processes to simultaneously process data in private work areas, maximum capacities for inter-nodal throughput and processing may impose exterior limits on the volume of read or write operations which may successfully be supported by a given environment.

Read operations of embodiments of the present invention require a minimal, single copy of data. In the write phase of simultaneous operation on data by many processes, direct, differentiated cooperative posting, or DCPUPS, ensure posting in any environment which provides an opportunity to write. Maximum possible processes are supported by altogether minimizing the volume, necessary incidence, and duration of write operations, which in turn provides maximum opportunity to successfully perform write operations in any operating environment, respective of the volume of competing functions. While the operating environment may be capable of supporting only a given volume of minimized read and write operations, nevertheless, without modification, embodiments of the invention sustain read and write operations as great as the capacity of the operating environment, however vast.

Wherever the outer operating environment fails to sustain minimized reading and writing, embodiments of the invention retain the processed state of data for resumption of processing when operational conditions are restored in the operating environment.

“Writing Over a Theoretic, Absolute Minimal Possible Duration”

“Writing over a theoretic, absolute minimal duration” may be defined, within a given operating environment, as predetermining what necessarily must be written to a targeted public data instance; securing the privilege to write to the public data instance; writing the prepared stream of data altogether over a minimum possible duration; and immediately releasing the privilege to write to other processes. “Writing over a theoretic, absolute minimal duration” is not necessary to the successful achievement of the objects of the invention.

“Writing Over a Substantially Minimal Duration”

“Writing over a substantially minimal duration” may be defined, within a given operating environment, as securing the privilege to write to the public data instance; writing over a substantially minimal duration as exemplified for instance by differentiating fields the CPO may be obligated to write to the public data instance; writing each differentiated field; and immediately releasing the privilege to write to other processes. In other words, a substantially minimal duration comprises reasonable involvement of further operations which does not unduly multiply write duration beyond a minimal duration, so that, in a system of embodiments “writing over a substantially minimal duration” is “approximately” as useful as “writing over a theoretic, absolute minimal duration” in achieving the objects of the invention, because, practiced across a system of embodiments of the present invention, the overall potential for write privilege denial is reduced approximately to the possible minimum.

Across a system of embodiments of the present invention, uniformly “writing over a substantially minimal duration” therefore means approximately maximum opportunity to write, provided to every “write to public instance event.”

“Writing Over a Sufficiently Minimal Duration”

“Writing over a sufficiently minimal duration” may be defined, within a given operating environment theoretically capable of supporting intended operations, as reduction of write durations to a total altogether which can be supported by the operating environment. “Writing over a sufficiently minimal duration” therefore is sufficient to achieve the objects of the invention, and, within a system of embodiments of the present invention, represents the upper limit of tolerable write duration.

Across a system of embodiments of the present invention, uniformly “writing over a sufficiently minimal duration” therefore means sufficient opportunity to write, provided to every “write to public instance event.”

Implications of “Direct cooperative Posting”

“Direct cooperative posting,” as defined in the specification, therefore succeeds by virtue of “writing over” no more than “a sufficiently minimal duration,” as the repeatable attempt to secure write permission comprising “direct cooperative posting” will find sufficient opportunity to write.

Implications of “Delegated Cooperative Posting”

“Delegated cooperative posting,” as defined in the specification, therefore succeeds by delegating posting responsibilities to a dedicated posting object, operating on the scope of subject data therefore by intention, tolerably without competition imposed by further processes.

Particularly if “delegated cooperative posting” is performed over sufficiently minimal durations by cooperatively posting from the delegated cooperative posting object, therefore, uniformly performing “delegated cooperative posting” means successful, uncompetitive performance of write operations in response to every “write to public instance event.”

Overall Implications of “Cooperative Posting”

The implications of “cooperative posting” and “substantially minimal write durations” of the present invention thus are readily evaluated.

If for instance a “substantially minimal” write duration is 100 milliseconds, then even if an interceding process may own an exclusive permission to write to a public data instance, a subsequent process may acquire the write permission in as little as no more than 100 milliseconds.

If the targeted data instance is written to one thousand times per day, the probability of write permission denial is a mere 100 seconds out of every day, with contention resolved by “cooperative posting” in as little as no more than 100 milliseconds, in every case of conflict.

At any moment therefore, the probability of write permission denial is a mere 100 seconds in 24 hours, with contention resolved, if any, in as little as no more than 100 milliseconds.

Conversely, in conventional systems, because lock duration may persist beyond process tolerance for write permission denial, the probability of acquiring write permission, even over extensive, indeterminate durations, may be, and often is, zero.

### FIG. 1—Conventional System

FIG. 1 is a data and control flow diagram illustrating a typical conventional system.

In FIG. 1, elements relate to two public data instances, 10A or 10B. In FIG. 1, a conventional application 11X involves processes 13X for responding to possible and probable write permission denial, processes 12A potentially acting on public data instance 10A, and processes 12B potentially acting on public data instance 10B.

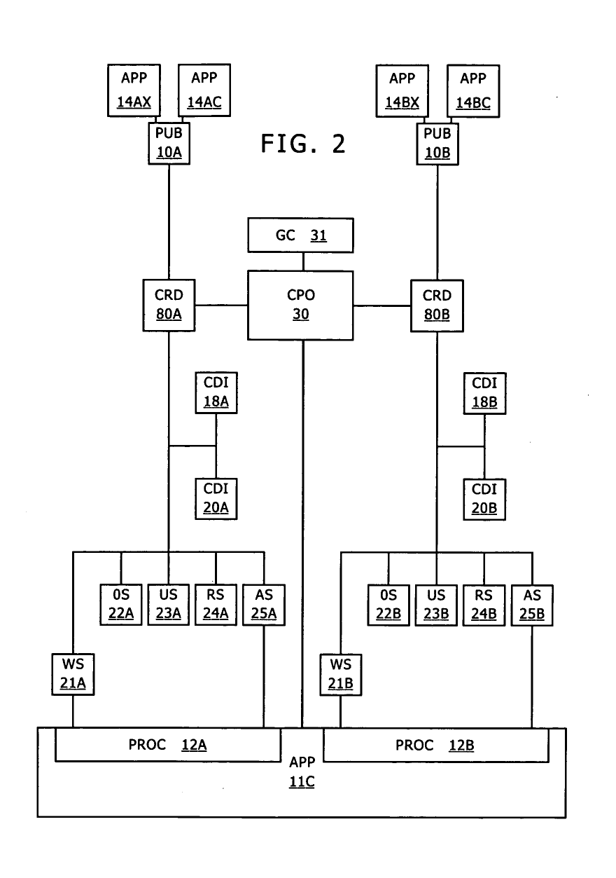

In FIG. 1, as In FIGS. 2 through 6 and 17 through 19 inclusive, a conventional application 14AX, or further instances of conventional applications such as application 14AX, may compete for the exclusive, opportunistic write privilege to public data instance 10A. A conventional application 14BX, or further instances of conventional applications such as application 14BX, may compete for the exclusive, opportunistic write privilege to public data instance 10B.

It is to be noted that cooperative applications as embody the present invention (not shown in FIG. 1) require no processes 13X for responding to write permission denial, as in FIG. 1. It is further to be noted that as instances exist in conventional systems where write permission denial can persist beyond the reasonable capacity of processes to tolerate write permission denial, those conventional system processes 13X responding to possible and therefore probable write permission denial have no power to avert failure resulting from possible indeterminate persistence of write permission denial.

FIG. 1—Evident Faults of Conventional System Objects

The engineering of conventional systems therefore defaults to the assumption that because only a single process can write to a data instance at once, it follows that failure to acquire a vital, singular, exclusive write privilege predicates process failure. As processes of conventional systems compete opportunistically and preclusively for an exclusive write privilege possibly held indeterminately, a critical fault and potential for failure of conventional systems therefore is that, if in any instance of processing given data, a write privilege can be denied beyond a practical tolerance of processes for persistent write permission denial, processes will fail.

As a consequence, true cooperative behavior, where simultaneous operations on any given instance of data are guaranteed success in any environment which can truly sustain intended operations, therefore would be impossible on the mere grounds that processes can and will fail for the very prevailing lack of cooperative means and apparatus, to simultaneously process data, and to uniformly ensure write operation success in conventional systems.

A further fault of conventional systems is that as states reflected in the momentary condition of processed data are not concurrently registered to retentive media, and as interceding failures of the operating environment itself may preclude process continuance, no means and apparatus exist to reliably retain resumable process status. Particularly, no means and apparatus exist to reliably retain resumable process status in any and every case of possible critical failure, possibly interceding before registration of vital states to retentive media. Particularly by concurrent registration of states, specifically, the writing of states to retentive media as an immediate and substantially direct result of processing the states, therefore is it possible to reliably register resumable process status. Furthermore then, by reliably registering process status concurrently, it is possible to reliably resume processing in subsequent worksessions, however inadvertent the termination of a preceding worksession.

Conventional systems therefore lacked the vital means and apparatus for truly cooperative, resumable processing.

FIG. 1—Conventional System Operation

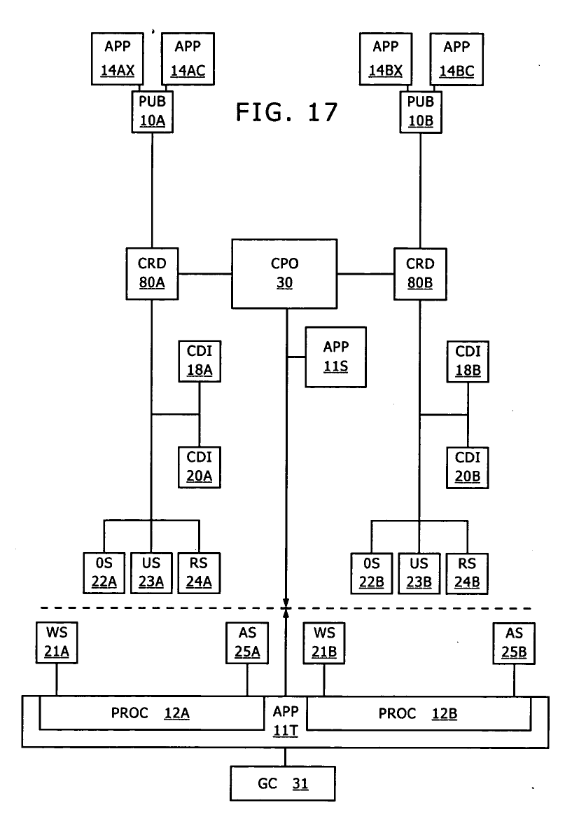

As we have elected for illustrative purposes, to uniformly depict embodiments of conventional systems, or embodiments of the present invention, with instances of public data being members of typical, formal tables, the resultant detailed description engenders non-restrictive explanation, intended to be comprehensive of negotiating tables. In negotiating tables, the life cycle of processed data in the embodiment of FIG. 1 begins, as does the embodiments of FIGS. 2 through 6 inclusive and FIGS. 17 through 19 inclusive, with setting cursors on the given public data instances 10A or 10B of the tables to which public data instances 10A or 10B belong, as makes the public data instances 10A or 10B available to processes 12A or 12B respectively. Despite this illustrative convention, in any of the FIGS. 1 through 6 inclusive and FIGS. 17 through 19 inclusive, public data instances 10A or 10B might exist in any possible form.

It is to be noted however, that in FIG. 1 the setting of cursors makes each public data instance 10A or 10B the immediate focus of application processes 12A or 12B respectively. That public data instances are the immediate focus of operations within the means and apparatus of conventional systems in turn means unavailable write permission results in failure of processes such as processes 12A or 12B. In order to operate on the public data instance, processes 12A potentially acting on public data instance 10A or processes 12B potentially acting on public data instance 10B must acquire exclusive write permission to the public data. If a preceding process has already acquired and not relinquished the singular write permission, no means or apparatus exists to perform intended operations on the targeted data, public data instance 10A or 10B.

### FIG. 1—Conventional System Conclusions, Ramifications

Therefore in conventional systems for instance, data-aware controls as in processes 12A providing for manual operation on public data instance 10A must acquire write permission to perform operations on the data. As no means or apparatus exist to minimize lock duration, a lock may persist indefinitely.

In conventional systems, no means or apparatus exists to reliably register resumable process status, however tentative. Neither did means and apparatus exist for concurrent registration and for reliable restoration of a multitude of states processed by many processes.

Although truly resumable processing is a goal not evident in the feats of conventional system engineering, nevertheless, reliable, resumable processing is a necessary goal, if for instance, applications are to initialize as in the last state of a previous work session, regardless of inadvertent shutdown, hardware failure, or even operating system failure. Resumable processing is also an obligatory functionality for instance in the case of indefinitely lost network connectivity. In a system consistent with these objects, a single means and apparatus is therefore sufficient for both purposes.

For the lack of privately isolated work areas, concurrent registration of states, process focus on private states, and ensured write methods together, cooperative, resumable processing therefore is beyond the capacity of conventional systems.

### Elements of FIGS. 2, 3, 4, 5, 6, 17, 18, and 19, Described

In FIGS. 2 through 6 and 17 through 19 inclusive, illustrative embodiments may include some or all of the following elements.

In FIGS. 2 through 6 and 17 through 19 inclusive, elements relate to either of two public data instances, 10A or 10B. Regular processes of a cooperative application 11C, cooperative server-side application 11S, or cooperative thin client application 11T act in conjunction with processes 12A potentially acting on public data instance 10A, or processes 12B potentially acting on public data instance 10B.

It is to be noted that cooperative applications as embody the present invention require no processes 13X accounting for contention, as in FIG. 1.

In FIGS. 2 through 6 and 17 through 19 inclusive, a conventional system application 14AX and a cooperative application as embodies the present invention, application 14AC, may compete for the exclusive, opportunistic write privilege to public data instance 10A. A conventional system application 14BX and a cooperative application as embodies the present invention, application 14BC, may compete for the exclusive, opportunistic write privilege to public data instance 10B.

In FIGS. 2 through 6 and 17 through 19 inclusive, privately isolated representative states are arranged in tables relative to an addressed public data instance, with the various privately maintained states each contained in and negotiated by a consistent organization of the records of the tables, so that for instance, a given private state instance will always be the subject of negotiation intending to negotiate the given state, whenever the record representing that state is the focus of negotiation. In the FIGS., the depiction of private data instances in horizontal rows indicates membership in a particular table, relative to and assignment compatible to a public data instance.

Negotiation of tables is discussed without implied restriction as being predicated by availability of a singular record cursor per component used to interface a table with an application. Such components predicate negotiation of a table, by way of the interface, by a given record at a time.

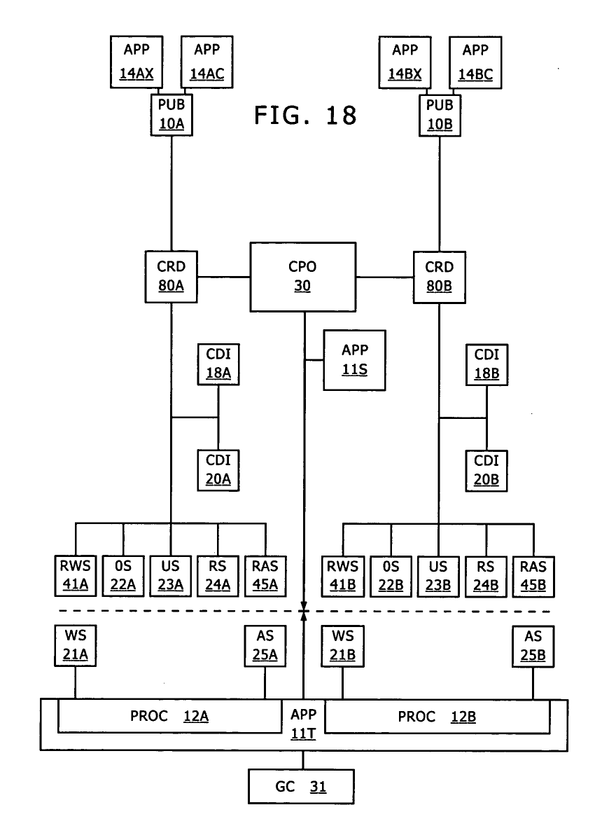

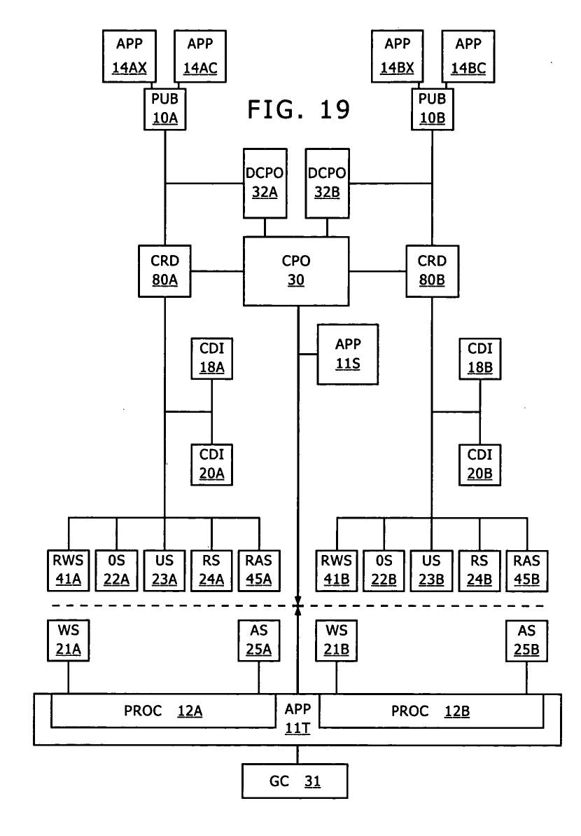

In FIGS. 2 through 6 and 17 through 19 inclusive, a private work state 21A, original state 22A, undo state 23A, and re-do state 24A are maintained relative to public data instance 10A. A remotely mirrored instance of a work state 41A (see FIGS. 18 and 19) may be maintained relative to private work state 21A. An auxiliary state 25A is maintained relative to independent instances of public data instance 10A as may exist for instance in the form of any of the various records of a formal table containing public data instance 10A. Remotely maintained instances of further states may be maintained as remotely mirrored instance of an auxiliary state 45A is maintained relative to auxiliary state 25A. A private work state 21B, original state 22B, undo state 23B, and re-do state 24B are maintained relative to public data instance 10B. A remotely mirrored instance of a work state 41B (see FIGS. 18 and 19) may be maintained relative to private work state 21B. An auxiliary state 25B is maintained relative to independent instances of public data instance 10B as may exist for instance in the form of any of the various records of a formal table containing public data instance 10B. Remotely maintained instances of further states may be maintained as remotely mirrored instance of an auxiliary state 45B is maintained relative to auxiliary state 25B.

In FIGS. 2 through 6 and 17 through 19 inclusive, private comparison-distribution instances 18A, 19A, and 20A are maintained relative to public data instance 10A. In FIG. 2, the comparison-distribution instance 20A may be used not only as a comparison-distribution instance, but also as the “last posted” state of the focused record of 10A. Private comparison-distribution instances 18B, 19B, and 20B are maintained relative to public data instance 10B. In FIG. 2, the comparison-distribution instance 20B may be used not only as a comparison-distribution instance, but also as the “last posted” state of the focused record of 10B. Cooperative posting (CP) is provided by a cooperative processing object (CPO) 30. In this description and the related drawings, CPO are illustrated as a single object. However this is not essential. In alternative embodiments, the CPO may in fact comprise multiple objects or equivalents, which together perform the functions described herein. The CPO 30 may reside, together or in part, within or without the application. Graphic controls 31 may act on the CPO 30. Delegated cooperative posting (DCP) may be provided by delegated cooperative posting objects (DCPO) 32A operating as on public data instance 10A, or by DCPO 32B operating as on public data instance 10B. DCPOs 32A, 32B may reside within or without the application. Cooperative resources associated with public data instance 10A are represented by cooperative resource descriptor 80A. Cooperative resources associated with public data instance 10B are represented by cooperative resource descriptor 80B.

Intrinsic Means and Apparatus Defined

In FIGS. 2 through 6 and 17 through 19 inclusive, illustrating alternative embodiments of the present invention, given the scope of resources made available to the particular embodiment, some or all of the following processes may be possible. Any operation may necessarily be implemented differently to achieve its object, given the resources made available to the particular embodiment. Any number of further operations are supported by extending the principles described herein.

In the following description, generic operations exemplify how embodiments may accomplish not only objects of conventional systems, but provide to such objects the further objects of simultaneous, cooperative operation on data, concurrent retention of states, automatic restoration of states without code dedicated to this purpose, resumable processing regardless even of inadvertent shutdown, and minimal consumption of inter-nodal throughput.

In FIGS. 2 through 6 and 17 through 19 inclusive, privately isolated operations, representing work on the public data instance, focus on a private work state related to a given public data instance. For instance, data-aware controls therefore may be focused on the given work state by virtue of the record cursor of a given table being focused on the work state record of the table. Likewise, data-aware controls may be focused on a given auxiliary state by virtue of the record cursor of a given table being focused on the auxiliary state record of the table. In FIGS. 2 through 6 and 17 through 19 inclusive, such a private work state 21A and such an auxiliary state 25A are maintained in relation to public data instance 10A. A private work state 21B and such an auxiliary state 25B are maintained in relation to public data instance 10B.

“Cooperative, Simultaneous Processing of Public Data”

Embodiments of the present invention are capable of “cooperative, simultaneous processing of public data.” “Cooperative, simultaneous processing of public data” comprises privately isolating and operating upon representative instances of public data so as to emulate direct processing of the public data; and comprises, thereupon, ensuring intended writing to the public data instance will be performed within any system which can sustain intended operations. “Cooperative Posting” (CP) ensures intended writing to the public data instance will be performed.

“Resumable, Cooperative, Simultaneous Processing of Public Data”

Where privately operated representative states of data are concurrently registered to retentive media, cooperative operations are resumable because processes are oriented to the concurrently registered states. A startup procedure re-triggering any previously running process from a given phase of operation therefore, automatically resumes an active process, should it be terminated, however inadvertently.

“Relational Registration of Status”

Within private work areas, process status may be registered concurrently, and as for instance relates to a given end user, a given purpose, a given period, a general or specific phase of operations, or any combination thereof. In other words, while states may be retained in instances that are assignment compatible to the public data instance, and while such states may therefore be comprised of records containing at least the negotiated fields of the public data instance, additional fields of a table of maintained states may provide for “relational registration of status,” associating the private states of data operations to any further classification. Such additional fields may for instance record an associated user identity, and an identity indicating each particular state, if more than one such state is maintained per user identity in the given table. By such conventional methods of orienting the scope of registered status to any such governing, relational prescriptions, a multitude of processing status, corresponding to and maintained in relation to many relational entities, may be kept concurrently, and resumed automatically.

In “relational registration of status,” any private work area related to a public data instance may further be related to any distinguishing characteristics of application, such as operator, operator authority, purpose, period, or phase; and where a given private data instance may be described in reference to the FIGS. in terms of count, the count of such data instances in the table, in relational registration of status, is multiplied by the distinguished relational instances negotiated by the embodiment of the invention. In reference to the FIGS., the focused records are cited as the count. The counted private data instances comprising the private work area therefore are identified by associating those private data instances with the distinguished focus of the application. A typical means of associating private data instances with distinguished focus of the application for instance, may be, in the private tables and data instances, to include fields for operator, and for enumerating records associated with the operator. The CPO 30 therefore can collect a private work area for an operator by focusing on enumerated records associated with the operator.

How Developers May Create Cooperative Applications Which Register Relational Status

A non-restrictive example may illustrate how developers may readily create and benefit from applications which register relational status.

Application developers may readily produce application behavior sensitive to work area classifications by working from a development template already endowed with the capacities to make available, to focus, to process, and to manage relationally registered status. One or more cooperative processing objects in the development template may be endowed with these capacities. Leveraging the core capacities of the cooperative processing objects for unique public tables of the application therefore requires merely preparing the tables of the private work area wherein the public data may be privately processed.

If a developer wants to build an application which supports work areas for user, purpose, and period, they may therefore start with a template endowed with the capacities to process these work area classifications. The CPO of this template simply provides to focus on any possible combination of classifications, each of which may be determined by a table of the classifications.

Each member of the possible values of the classification set can for instance be identified by an integer, to which a literal name of the value of the classification may be associated. An interface provides to add classification values to the table for that classification. By simply adding a record to the table indicating the integer identifier of the record and whatever identifying nomenclature is necessary in relation to the record, a further interface provides for the operator to select and operate on a set of work areas related to that classification.

To build the tables for a private work area for a public table “MyDatabase,” the developer may copy MyDatabase to the private work area, empty the table, strip its specification of relational definitions and key/unique field prescriptions, add to the table key/unique fields for UDS_User, UDS_Purpose (which may for instance be to negotiate backup tables or demonstration tables), UDS_Period, and, UDS_State; and finally, they may make the combination of these identifying fields key/unique. Although the CPO may be endowed with alternative capacities to manage relational record populations without specifying the identifying fields are key/unique, prescribing the key/unique fields may make a database engine automatically maintain the kind of indexes which may be desirable to the implementation intended by the developer.

For the architecture described with FIG. 2, a copy of this table may be saved as MyDatabase1, MyDatabase2, MyDatabase3, and MyDatabase4 in the private work area directory of the application; the names of the tables are assigned to corresponding properties of a cooperative resource descriptor (“CRD”, described below) associated with the public table, MyDatabase, and the first time the application is opened, and every time a new work area is created of a given classification, the CPO may automatically populate the local work area as necessary for the logged user. The developer can simply empty the tables to ship product.

By using the UDS_Purpose field to preserve private work areas related to commercial jobs, end users can instantly switch from work areas related to one job to a work area related to another, with the entire focus of the work area preserved intact. The application can readily therefore track time dedicated to each such job from logon to the work area to discontinuance of work, and the application can automatically produce billing and accounting data related to any and all jobs. From this information, the application can further produce job cost projections for similar work. Thus relational registration of status is highly important to automating diversities of further related functions.

“Cooperative Resource Descriptors” (“CRD”)

Cooperative resource descriptors (CRD) represent the organized elements of a private work area related to a public data resource, as is necessary for management of the resources and operations related to the public data resource. In object oriented programming for instance, “cooperative resource descriptor” objects may facilitate resource and process management by indicating involved tables, so that management of necessary resources may be automated. By indicating the public and private tables associated with focus on a given public data instance, a “cooperative resource descriptor” may be assigned for instance to a cooperative processing object or objects (CPO), so that the CPO may alternatively release or deactivate any cooperative resources previously focused, so that the CPO may automatically prepare newly focused cooperative resources, and so that the CPO may direct generic CPO processes at the focused public data instance and related private resources, thus leveraging a common internal body of processes against however many public data instances and related private work areas.

In the FIGS., “cooperative resource descriptor” 80A for instance represents the private work area of 18A, 19A, 20A, 21A, 22A, 23A, 24A, 25A, 41A, 45A, and any further, related resources, to the CPO 30, for, and inclusive of the public data resource containing public data instance 10A. “Cooperative resource descriptor” 80B for instance represents the private work area of 18B, 19B, 20B, 21B, 22B, 23B, 24B, 25B, 41B, 45B, and any further related resources, to the CPO 30, for, and inclusive of the public data resource containing public data instance 10B. In the case of “relational registration of status,” the focus of the governing relation predicates the scope of private records available to the CPO 30. In other words, the states available to the CPO are the states related to the identity owning the given process, representing to that identity, the status of its processing of subject data.

When a “cooperative resource descriptor” is the focus of a CPO, by virtue of the organization of the cooperative resources, operations performed by the CPO are applied to the related cooperative resources.

“Cooperative Negotiation of Many Data Resources”

By endowing the CPO with the further capacities to process (e.g., prepare, activate, deactivate, or release) cooperative resources on demand, thus by generic techniques of creation, opening, activation, deactivation, closure, and freeing of resources as are well known to the present art, and by demand being indicated by assigning any given “cooperative resource descriptor” to the focus of the CPO, many cooperative resources are negotiable where extrinsic limiting factors might otherwise preclude negotiating a given collection of cooperative resources.

It is important to consider for instance that prevalent conventional database systems have been subject to upper limits on the number of tables an application can negotiate at once. Likewise, operating environments may impose limitations which in turn may limit the number of tables an application can negotiate at once. “Cooperative negotiation of many data resources” overcomes such limitations by providing a capacity for applications to rely upon only the resources necessary to the immediate focus of data-centric processes.

“Graphic Controls Acting on the CPO”

Graphic controls 31 acting on the CPO 30 can invoke processes endowed to the CPO against a private work area or its public data resources by virtue of the “cooperative resource descriptor” upon which the CPO 30 is focused.

When for instance “cooperative resource descriptor” 80A is the focus of the CPO 30, any generic process endowed to the CPO can be performed against the cooperative resources 18A, 19A, 20A, 21A, 22A, 23A, 24A, 25A, 41A, 45A and 10A. When “cooperative resource descriptor” 80B is the focus of the CPO 30, any generic process endowed to the CPO can be performed against the cooperative resources 18B, 19B, 20B, 21B, 22B, 23B, 24B, 25B, 41B, 45B and 10B.

“Automatic Assignment of Resource Descriptors to the CPO”

“Cooperative resource descriptors” may be associated with a container of the interface operating on the associated, cooperative resources. By populating parallel arrays or sufficient equivalents, one with the identities of “cooperative resource descriptor objects,” and the other with the identities of the containers of the related interfaces, an OnEnter event of each container object for instance can call a centralized process looking up the corresponding “cooperative resource descriptor” and assigning it to the CPO, which thereupon may perform any processes with which it is endowed, focused on the cooperative resources described. Applications embodying “automatic assignment of resource descriptors to the CPO” may thus automatically prepare, focus, and release their resources without further program code dedicated to this purpose.

In object oriented programming for instance, graphic controls may provide for manual operation on the fields of a record. In embodiments of the invention, the record processed by a graphic interface of an application may be the record of the private work state. Typically then, each such data-aware control would be assigned to a field of the table containing the private work state. The controls comprising such an interface typically belong to a “container” object. Examples of container objects would be pages of a tabbed page control, graphic panels which are areas or layers of interfaces, or the very form or window housing the controls. To implement the technique of “automatic assignment of resource descriptors to the CPO” however, distinct, different containers must house the controls of a given interface related to given cooperative resources related to a public data instance. Thus by populating dual arrays of interface container objects by a process assigning the identity of the container object of the interface to an array or sufficient equivalent, and assigning a corresponding “cooperative resource descriptor” to a parallel array or sufficient equivalent; and by assigning the OnEnter event or sufficient equivalent of the container object to a common process, most appropriately endowed to the governing CPO itself, which process looks up the corresponding “cooperative resource descriptor” for the interface container, and which process then assigns the “cooperative resource descriptor” to the focus of the CPO, therefore processes endowed to the CPO to manage resources can, automatically, as an end user navigates an application, manage the preparation, negotiation, and release of all cooperative resources without further program code dedicated to this purpose. Ideally, the CPO itself can iterate the parallel arrays, for instance at initialization of the application, with the CPO itself even assigning the OnEnter events of each container object to the very process of the CPO performing “automatic assignment of resource descriptors to the CPO.”

“Subsequent Session Resumption with Interfaces and Cooperative Focus Intact”

By concurrently registering to retentive media an identity of the active interface container “on entry” of the container, and by invoking a startup process further utilizing the parallel arrays or sufficient equivalents intrinsic to “automatic assignment of resource descriptors to the CPO” to set the active interfaces of every group of interfaces, however deeply nested, every previously focused interface of an application, regardless of depth of nesting, is automatically restored at startup. By concurrently registering the identity of the focused “cooperative resource descriptor” on assignment of the “cooperative resource descriptor” to the CPO, and by invoking a startup process assigning that “cooperative resource descriptor” to the CPO, subsequent sessions are automatically restored with their cooperative focus intact.

“Concurrently Retained Distribution to the Private Work Area”

In the life cycle of any processing of public data by the present invention, an initial responsibility of the CPO 30, when new public data is focused, is distribution of the public data to the private work area, where operations on representative states, however many, will suffice as work performed on the public data instance, and which results of such operations, reflected in the private state of the data, will be cooperatively posted to the public data instance whenever appropriate. “Concurrently retained distribution to the private work area” substantially eliminates the potential for obstructive events to preclude registration of the state of processing.

Because tables are used in examples provided herein, and because the tables themselves exist, as processed, in retentive media, the exemplified “distribution” process inherently stores each retained state to retentive media by writing data to the records of the table. Each registered state thereafter endures in malleable, concurrent form. “Concurrently retained distribution to the private work area,” in conjunction with registration of processing concurrent with performance of processes, and in conjunction with cooperative posting of affirmed process results reflected in the private state of data, therefore produce momentarily correct public data, altogether with concurrently registered states providing for constantly resumable processing, as fast as an operating environment may support necessary processing. Because write cycles are substantially minimized, embodiments of the invention substantially optimize the capacity of any exterior environment to support necessary processing and concurrent registration of public states of data.

“Remotely Mirrored States”

In alternative embodiments of the invention, private work areas may exist in part or whole on a remote system. Some states, and particularly a locally processed work state, may exist on the local system. The record of the remotely mirrored state may be used for instance to restore the status of a resumed worksession on the local system. It is important therefore to the integrity of resumable processing status to ensure that “remotely mirrored states” are updated with the affirmed status of locally processed states, to substantially eliminate opportunities for interceding, obstructive events to preclude registration of states concurrent with processing.

“Concurrently Retained Distribution to Remotely Mirrored States”

When a state is distributed to a client application by concurrently retained distribution to the private work area, “concurrently retained distribution to remotely mirrored states” likewise distributes the public data to the remotely mirrored state.

“Concurrently Retained Tentative Accept Processes”

A “concurrently retained tentative accept” process may be defined as registering the current work state so as when a concurrently retained undo process is performed, it will restore the tentatively accepted, registered work state.

To perform a “concurrently retained tentative accept process” by methods leveraged outwardly to however many public data instances and related private work areas of a given organization, the CPO 30 may therefore assign the private work state to the private undo state related to the public data instance. In the FIGS. then, where an illustrated embodiment of the invention therefore involves the necessary elements, a “concurrently retained tentative accept” operation performed in respect to public data instance 10A is performed by assigning private work state 21A to undo state 23A. A “concurrently retained tentative accept” operation performed in respect to public data instance 10B is performed by assigning private work state 21B to undo state 23B. “Concurrently Retained Re-do Processes”

A “concurrently retained re-do” process may be defined as restoring the private work state to a former status existing at a moment when an “undo” process, if any, was last performed. Such a definition further means that an “undo” process must register the private work state to a re-do state before performing any further operations which might alter the private work state.

To perform a concurrently retained re-do process by methods leveraged outwardly to however many public data instances and related private work areas of a given organization, the CPO 30 may therefore assign the private re-do state to the private work state related to the public data instance. In the FIGS. then, where an illustrated embodiment of the invention therefore involves the necessary elements, a “concurrently retained re-do” operation performed in respect to public data instance 10A is performed by assigning re-do state 24A to private work state 21A. A “concurrently retained re-do” operation performed in respect to public data instance 10B is performed by assigning re-do state 24B to private work state 21B.

“Concurrently Retained Undo Processes”

A “concurrently retained undo” process may be defined as restoring the last tentatively accepted state, if any, or if none, the last retained “undo” state of private processes, to the private work state. Because our definition of a “concurrently retained re-do” process further means that a “concurrently retained undo” process must register the private work state to a re-do state before performing any further operations which might alter the private work state, therefore a first phase of a “concurrently retained undo” process must register the private work state to the re-do state.

To perform a concurrently retained undo process by methods leveraged outwardly to however many public data instances and related private work areas of a given organization, the CPO 30 may therefore first assign the private work state to the re-do state, and subsequently assign the private undo state to the private work state related to the public data instance. In the FIGS. then, where an illustrated embodiment of the invention therefore involves the necessary elements, a “concurrently retained undo” operation performed in respect to public data instance 10A is performed by first assigning private work state 21A to re-do state 24A, and subsequently assigning undo state 23A to private work state 21A. A “concurrently retained undo” operation performed in respect to public data instance 10B is performed by first assigning private work state 21B to re-do state 24B, and subsequently assigning undo state 23B to private work state 21B.

“Concurrently Retained Restore to Original Status Processes”

A “concurrently retained restore to original status” process may be defined as restoring the private work state to the original value of the related public data instance as initially acquired and assigned to the record of the original state, which original state thereafter may be updated to any local processing applied to the state of the public data instance by assigning fields posted to the public instance to the original state.

To perform a concurrently retained restore to original status process by methods leveraged outwardly to however many public data instances and related private work areas of a given organization, the CPO 30 may therefore assign the private original state to the private work state related to the public data instance. In the FIGS. then, where an illustrated embodiment of the invention therefore involves the necessary elements, a “concurrently retained restore to original status” operation performed in respect to public data instance 10A is performed by assigning original state 22A to private work state 21A. A “concurrently retained restore to original status” operation performed in respect to public data instance 10B is performed by assigning original state 22B to private work state 21B.

“Concurrently Retained Zero Throughput Cancel Processes”

A “concurrently retained zero throughput cancel” process may be defined as restoring a local private work area related to a public data instance to the original state as acquired from the public data instance, or as updated to any local processing applied to the state of the public data instance, without asking for the public data instance. In the present invention, a “zero throughput cancel process” therefore can be performed without throughput consumption by assigning the original state to the remainder of representative states.

To perform a concurrently retained zero throughput cancel process by methods leveraged outwardly to however many public data instances and related private work areas of a given organization, the CPO 30 may therefore assign the private original state related to the public data instance to the remainder of representative states. In the FIGS. then, where an illustrated embodiment of the invention therefore involves the necessary elements, a “concurrently retained zero throughput cancel” operation performed in respect to public data instance 10A is performed by assigning original state 22A to private work state 21A, undo state 23A, and to re-do state 24A. A “concurrently retained zero throughput cancel” operation performed in respect to public data instance 10B is performed by assigning original state 22B to private work state 21B, undo state 23B, and to re-do state 24B. If more representative process states were included in the examples, necessarily the process would assign the original state to those states.

“Concurrently Retained Cancel to Current State Processes”

A “concurrently retained cancel to current state” process may be defined as discontinuance of private processing and re-population of the private work area to the current state of the public data instance. In the FIGS. then, where an illustrated embodiment of the invention therefore involves the necessary elements, a “concurrently retained cancel to current state process” therefore may be performed by simply re-“distributing” the public data instance to the private work area.

“Concurrently Retained Refresh from Public Status Processes”

A “concurrently retained refresh from public status process” may be defined as refreshing the private work area to the current state of the public data instance except for units of the data already privately processed. A “concurrently retained refresh from public status process” therefore refreshes only unmodified fields of the private work area, as if the current state of the public data instance had been acquired and made the object of private processes already performed, if any. A “concurrently retained refresh from public status process” therefore must refresh any unmodified fields of the private representative states with the corresponding value of the public data instance.

To perform a “concurrently retained refresh from public status process” by methods leveraged outwardly to however many public data instances and related private work areas of a given organization, the CPO 30 therefore must compare the fields of the original state to the corresponding field of each other representative state, and, where finding a representative state field matches the original state, the CPO must assign the corresponding field of the public data instance to the field of the representative state. The public data instance is then assigned to the “refreshed” original state.

In the FIGS. then, where an illustrated embodiment of the invention therefore involves the necessary elements, a “concurrently retained refresh from public status” operation performed in respect to public data instance 10A is performed by assigning the value of the corresponding field of the public data instance 10A to private work state 21A, to undo state 23A, and to re-do state 24A, wherever the field of the private state matches the value of original state 22A. Finally, the value of the public data instance 10A is assigned to the “refreshed” original state 22A. A “concurrently retained refresh from public status” operation performed in respect to public data instance 10B is performed by assigning the value of the corresponding field of the public data instance 10B to private work state 21B, to undo state 23B, and to re-do state 24B, wherever the field of the private state matches the value of original state 22B. Finally, the value of the public data instance 10B is assigned to the “refreshed” original state 22B.

“Uninterrupted Processing Concurrent with Performance of Concurrently Retained Refresh from Public Status Processes”

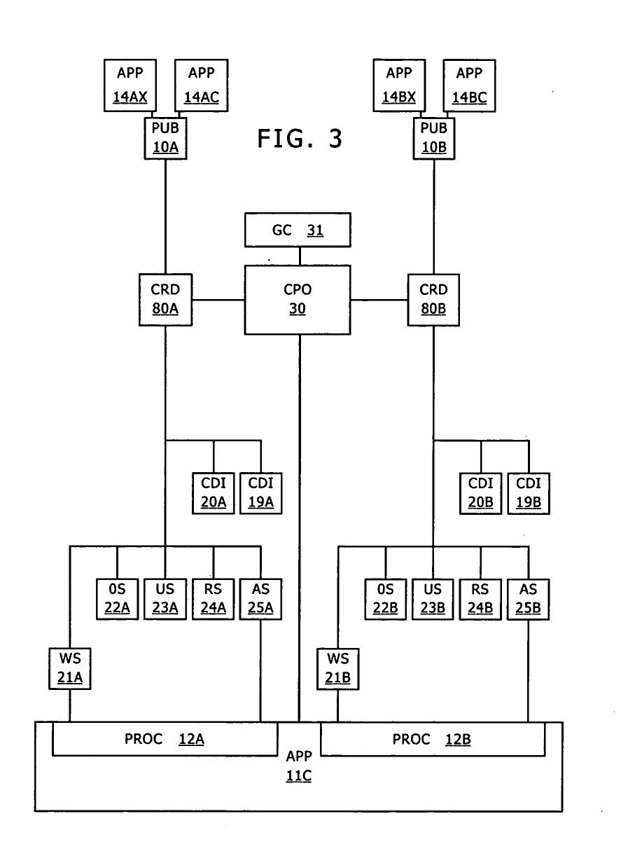

If the architecture of the particular embodiment isolates the private work state, 21A, 21B, so as connections to data-aware controls are not broken during the process, as in FIG. 2 and FIG. 3, a “concurrently retained refresh from public status” process therefore will detect a field of the private work state momentarily under processing, and by definition of a “concurrently retained refresh from public status process,” in not assigning to such a field, provides for uninterrupted processing, concurrent with performance of a “concurrently retained refresh from public status process.”

“Write to Public Instance Events” (“WTPIE”)

A “write to public instance event” (WTPIE) causes the CPO 30 to perform “cooperative posting” (CP). Thus by invoking a WTPIE, “differentiated” or “non-differentiated” cooperative processing are performed by the CPO 30, which either performs direct “cooperative posting” (CP), or alternatively invokes “delegated cooperative posting” (DCP) by delegating posting to a “delegated cooperative posting object,” 32A or 32B.

“Write to Remotely Maintained State Events” (“WTRMSE”)

A “write to remotely maintained state event” (WTRMSE) causes the CPO 30 to write a local state to a remotely maintained record of the state.

“Post to Private Instance Events (“PTPIE”)

A “post to private instance event” causes the CPO 30 to conclude momentary registration of private state instances. Thus by invoking a PTPIE, registration of status of focused, private state instances is finalized. For instance, in conventional object oriented development, to edit a record of a table, it may be necessary to set the unit of editable data, often a record, into an editable state, with the actual writing to retentive media being finalized by terminating the editable state. PTPIE therefore may be performed by the CPO 30 by methods leveraged outwardly to however many public data instances and related private work areas of a given organization, by way of cooperative resource descriptors. In response to PTPIE, the CPO 30 may for instance explore private tables to discover tables in editable state, terminating editable states it encounters to momentarily complete registration of private processing.

“Differentiation” of Processing

“Differentiation” determines which fields of a private work state have been modified by private processes, and is important therefore to writing only intended processing to public data without unintentionally overwriting fields possibly operated by other processes. Differentiation determines what processing has been performed by comparing a private work state to a private original state, or to a private original state updated to any local processing applied to the state of the public data instance by assigning fields posted to the public instance to the original state, or to a separate, “last posted” state (as described for 20A and 20B in FIG. 2), equivalent at any moment to said original state updated to any local processing applied to the state of the public data instance by assigning fields posted to the public instance to the original state. In conjunction with posting, fields of the original state may optionally be updated to posted content by a process herein described as “differentiated cooperative posting, updating private states” (DCPUPS).

As a result of given implementations of “differentiation,” unaltered field content is not posted back to the public data instance. Local differentiation therefore results in minimal consumption of inter-nodal throughput in posting to public data because if operations, however many, do not result in a need to post, therefore without consuming throughput even to differentiate, local differentiation results in non-performance of unnecessary posting. Moreover, differentiation resulting in posting predicates a minimal-conveyance of data across inter-nodal throughput.

In the FIGS. then, where an illustrated embodiment of the invention therefore involves the necessary elements, “differentiation” may be performed in respect to public data instance 10A by comparing private work state 21A to original state 22A, or to a private original state updated to any local processing applied to the state of the public data instance by assigning fields posted to the public instance to the original state, or to a “last posted” state 20A as described in the alternative method for maintaining a separate “last posted” state, for FIG. 2. “Differentiation” may be performed in respect to public data instance 10B by comparing private work state 21B to original state 22B, or to a private original state updated to any local processing applied to the state of the public data instance by assigning fields posted to the public instance to the original state, or to a “last posted” state 20B as described in the alternative method for maintaining a separate “last posted” state, for FIG. 2. Differing fields are “differentiated.”

“Cooperative Posting” (“CP”)

Within an operating environment capable of sustaining intended operations, “cooperative posting” (CP) ensures write processes will be performed amongst a system of embodiments of the present invention. Cooperative posting may be performed “directly” by the CPO 30, or cooperative posting may be “delegated” to a “delegated cooperative posting object” (DCPO) 32A, 32B.

Two forms of “direct cooperative posting” are described, “differentiated cooperative posting,” and “non-differentiated cooperative posting.” “Direct cooperative posting” succeeds amongst a system of embodiments of the present invention, by the virtues altogether of sufficiently maximized opportunity to write; of repeatably attempting to secure the privilege to write; and of writing in a sufficiently minimized duration.

A basic form of non-direct cooperative posting is described as “delegated cooperative posting.” “Delegated cooperative posting” succeeds by virtue of sufficiently minimized competition for write privileges, by delegating the responsibility to write to a dedicated entity.

“Differentiated Cooperative Posting” (“DCP”)

In “differentiated cooperative posting,” the CPO 30 performs “cooperative posting,” “differentiating” content necessarily written to the public data instance.

“Differentiated Cooperative Posting, Updating Private States” (“DCPUPS”)

“Differentiated cooperative posting, updating private states” (“DCPUPS”) is a process optionally performed with respect to posting to the public data instance. DCPUPS is a process comprising a DIFFERENTIATED COOPERATIVE POSTING aspect, and an UPDATING PRIVATE STATES (UPS) aspect. Where DCPUPS is performed, the “UPDATING PRIVATE STATES” aspect of DCPUPS is at least performed on the state we have herein referred to as the “original state,” unless a separate “last posted” state is maintained, in which case DCPUPS is at least performed on the “last posted” state (20A, 20B, in FIG. 2). The “UPDATING PRIVATE STATES” aspect of DCPUPS does not involve “updating” the state we have herein referred to as the “private work state,” which, prior to the UPS aspect of DCPUPS, is already “updated” as would result from the UPS aspect of DCPUPS.

An object of DCPUPS is, in conjunction with posting to the public data instance, to update corresponding, unmodified fields of private representative states to the value posted to the field of the public data instance. DCPUPS does not require reading the public data. The consequence of DCPUPS is that unmodified fields of representative states subject to DCPUPS are updated to values posted to the public data instance.

In conjunction with posting to the public data instance therefore, DCPUPS is performed, in respect to any given representative state other than the private work state, by comparing the field of the representative state for a match to the field of the original state as updated to field values posted to the public data instance, and, where the field of the representative state matches the field of the original state, by assigning the value posted to the field of the public state to the field of the representative state, which field will be an altered field of the private work state.

DCPUPS has no effect or object therefore of being performed on a work state posted to the public data instance. Some or all of the representative states beyond the original state may be subject to DCPUPS. An alternate original version of the public data may be kept in conjunction with DCPUPS if for instance it is necessary, for further objectives, to maintain a record of the originally distributed state of the public data instance.

Necessarily, DCPUPS must lastly be performed on the original state as updated to field values posted to the public data instance, unless a copy of the original state as updated to field values posted to the public data instance is first assigned to a comparison-distribution instance or other sufficiently equivalent resource from which it can be compared to further representative states.

Representative states subject to DCPUPS result in a given application behavior consequent to posting. A consequence of applying DCPUPS to an original state or separate last posted state for instance is that subsequent “differentiations” of potentially modified fields of the work state are performed against the updated fields of the original state or last posted state, the further consequence of which is that in differentiated cooperative posting of any kind, which compares the original state (as updated to last posted status) or last posted state (which is the equivalent) to the work state to determine that operations have resulted in modification of the work state, modified fields of the work state are never again, redundantly posted to the public data instance unless the field has been further modified. DCPUPS applied to the “original state” (as updated to posted values), or applied to a separate “last posted” state, therefore is obligatory to absolutely minimal consumption of inter-nodal throughput. Under DCPUPS applied to the original state or last posted state, the “original state” or “last posted state” represents the original state of the acquired public data instance, as updated in compliance with fields posted to the public instance.

The effect of DCPUPS on representative states is equivalent to re-distributing a posted field to the subject representative states of the private work area wherever that field of the representative state has not been modified in the private work area. Further objects of DCPUPS therefore may be that undo and re-do operations or concurrently retained restore to original status processes revert work state fields to the last posted state of the field of the public data instance, wherever the corresponding field of the representative state assigned to the work state was unmodified since distribution to the private work area, or last performance of DCPUPS.

Where a separate “last posted” state is maintained therefore, it may be an object of an application not to apply DCPUPS to an “original state,” in order to provide for restoring all private operations on the subject public data instance to the original state acquired.

“Non-differentiated Cooperative Posting” (“NDCP”)

In “non-differentiated cooperative posting,” the CPO 30 performs “cooperative posting” without “differentiation.” The private work state is written to the public data instance.

“Delegated Cooperative Posting” (“DCP”)

In “delegated cooperative posting,” (DCP) the CPO 30 requests that a “delegated cooperative posting object” (DCPO) 32A, 32B perform writing to the public data instance. The DCPO preferably writes to the data by direct cooperative posting, because, thereby, multiple independent systems can cooperatively process the data, even if the original intent of a system was to be the sole instrument of data management or processing.

“Delegated Cooperative Posting Objects” (“DCPO”)

A “delegated cooperative posting object” performs “delegated cooperative posting,” preferably on behalf of a CPO 30. Although it is not a requirement of the invention, a single DCPO 32A, 32B is preferably dedicated to a given public data resource, performing requests to post to public data as it can, so that competition to write to that public data resource is eliminated. A DCPO 32A, 32B for instance may be dedicated to writing to a given public table.

“Cooperative, Simultaneous Processing of Public Data with Minimal Consumption of Inter-nodal Throughput”

An acquisition phase of “cooperative, simultaneous processing of public data with minimal consumption of inter-nodal throughput” comprises distribution of a single copy of the public data instance across inter-nodal throughput to an assignment compatible instance of the public data in a local, private work area, and therefrom to the remainder of local, private, representative states, with such a method thus consisting of minimum possible incoming data traversing inter-nodal throughput. A write phase of “cooperative, simultaneous processing of public data with minimal consumption of inter-nodal throughput” comprises “differentiated cooperative posting,” whereby the obligation to post and a minimal scope of posted content are determined locally. Such a method thus consists of no need to traverse throughput to determine either an obligation to post, or what units of data must be posted. No consumption of inter-nodal throughput results in regard to posting, in any case where it is determined to post or where it is determined what to post. In the alternate case that posting is to be performed, local differentiation determines minimum possible outgoing units of data, traversing inter-nodal throughput.

“Extended, Direct, Cooperative Write-related Operations”

“Extended, direct, cooperative write-related operations” extend the capacity of the present invention to cooperatively process public data, particularly to developer processes needing to write to public data.

By extending CPO capacities for direct, cooperative write-related operations to further processes needing to write to public data, the cooperative behavior endowed to the CPO is extended to the data writing operations of entire applications. “Extended, direct, cooperative write-related operations” extend the capacity of the present invention to cooperatively, simultaneously process public data, by providing “cooperative posting” (CP) to processes comprised of phases, the first phase being determination of what is to be written to the public data instance.

In “direct cooperative posting,” the first phase then passes the responsibility of repeatably attempting to secure the write privilege to the CPO 30. Upon successful acquisition of the write privilege, the CPO 30 passes control to a subsequent phase, the responsibility of which is to write to the targeted public data instance in “a sufficiently minimal duration,” thereupon which write access to the public data instance is freed to provide the opportunity to write to further processes, if any. If write access cannot be secured, as in encountering a persistent lock imposed by a non-cooperative, conventional application, or as in failure of the outer operating environment, the process “times out” (exhausts the intended scope of effort), with, owing to concurrent registration of status, data states always intact.

Where privately operated representative states of the data are concurrently registered to retentive media, “extended, direct, cooperative write-related operations” engineered to process the retained states are resumable. Should the process fail as a result of extrinsic circumstances, concurrent registration of process status has ensured that processing can resume, even despite session termination, however inadvertent. In alternative cases, where developers may elect not to concurrently register processed states of an extended process to retentive media, the subsequent phase of the extended, direct, cooperative write-related process may handle write failure upon notification by the CPO 30. In the case of concurrently registered processing, if a process is merely made resumable by any conventional programming structure which provides that if the process is resumed, it will begin anew from any phase to perform operations as if no interruption had occurred, then no “handling” of failure is necessary. A “timed out” process is merely suspended, with a resumable state intact.

“Extender, Delegated, Cooperative Write-related Operations”

By extending CPO capacities for delegated, cooperative write-related operations to the engineering of further processes needing to write to public data, the cooperative behavior endowed to the CPO 30 is extended to the data writing operations of entire applications. “Extended, delegated, cooperative write-related operations” extend, particularly to developers of processes needing to write to public data, the capacity of the present invention to cooperatively, simultaneously process public data, by providing “delegated cooperative posting” (DCP) to processes comprised of phases, the first being determination of what is to be written to the public data instance. In “delegated cooperative posting,” the first phase then passes the responsibility of writing to the CPO 30, which takes control of the possibility of process failure, and attempts to pass the responsibility of writing to the DCPO 32A, 32B. Upon successful passing of the write responsibility to the DCPO 32A, 32B, the CPO 30 passes control to a subsequent phase of the “extended, delegated, cooperative write-related operation,” if any. If the write responsibility is not successfully passed to the DCPO 32A, 32B, as in failure of the outer operating environment to provide or sustain access to the DCPO 32A, 32B, the CPO 30 uniformly handles extended, delegated, cooperative write-related operation failure, for instance, and most usefully, by reporting detected obstruction of the process, trouble-shooting, and remedial procedure altogether.

Where privately operated representative states of the data are concurrently registered to retentive media, “extended, delegated, cooperative write-related operations” engineered to process the retentive states are resumable. Should the process fail as a result of extrinsic circumstances, concurrent registration of process status has ensured that processing can resume, even despite session termination, however inadvertent. In alternative cases, where developers may elect not to concurrently register processed states of an extended process to retentive media, the subsequent phase of the extended, delegated, cooperative write-related process may handle write failure upon notification by the CPO 30. In the case of concurrently registered processing, if a process is merely made resumable by any conventional programming structure which provides that if the process is resumed, it will begin anew from any phase to perform operations as if no interruption had occurred, then no “handling” of failure is necessary. A “timed out” process is merely suspended, with a resumable state intact.

Concurrent Registration of Phase Identifiers in Resumable Performance of “Extended, Direct, Cooperative Write-related Operations” and “Extended, Delegated, Cooperative Write-related Operations”

Phase identifiers are important to resumption of ongoing processes—unfinished, active processes, usually of custom/specialized nature, generally engineered by the developer in addition to the intrinsic processes of the principal invention.

Phase identifiers are not necessary to the regular interfaces of an application for manually editing data for instance, because the entire state is concurrently preserved in a form from which can be determined the one thing the usually non-active, brief processes of the interfaces require to resume any further brief processing, which is to perform posting. Applications of the present invention therefore automatically resume their processing state in regard to manual operations on data, because, from the concurrently registered states, the remaining aspect of posting can and will be performed, even after inadvertent termination.

Resumable developer operations however (which might be lengthy, which might not preserve any other evidence of their state, and which might be interrupted in process with no other means and apparatus for resumption), need to be constructed so as they register 1) an identifier of the active process, and 2) a descriptor of a completed phase or phase to initiate (some sort of progress marker from which to resume); and the code to the process must be constructed to iterate either from a registered, completed phase, or, alternatively, at a phase to initiate (in accord with the progress marker).

Startup code examines a table to which active resumable processes are registered at commencement, and are unregistered at finalization. Active processes are re-invoked at startup simply by looking up the index value of the process in a TList (or similar convention) of resumable processes; and the structure of the process therefore automatically resumes its iteration(s) from the proper point of resumption, until it can be completed and fulfill its obligation to unregister the finalized process from the set of active processes.

“Extended Representative States”

Like the regular organization of representative states made available to CPO processes, an additional number of representative states may be made available to initial distribution of the public data instance by the CPO 30, and particularly to developers of processes needing to write to public data and wanting to concurrently register status of the process to a dedicated state, particularly to avoid conflict with intended CPO operations by virtue of an independent, dedicated private workspace. “Extended representative states” therefore can be maintained and negotiated by a CPO 30 from a cooperative resource descriptor 80A, 80B indicating the scope of extended representative states. To address a given extended representative state, the index identity of the given state may provide to identify the given state from the number of extended representative states.

In the context of the present invention, an “extended representative state” is a privately maintained state, populated by the CPO 30 on identity of a focused public data instance, registered to retentive media concurrent with private processing, available to further private processes writing to the state, and therefore privately representative of the current public data instance focus. On behalf of the application, the CPO 30 may perform distribution or comparison of the extended representative state to other privately maintained states or the public data state. The purposes and existence of any “extended representative state” are therefore exemplified by illustrated usages of any of the regular representative states.

“Concurrently Retained Auxiliary States”

In the context of the present invention, a “concurrently retained auxiliary state” is a privately maintained state registered to retentive media concurrent with private processing, not necessarily representative of the current public data instance focus. An auxiliary state for instance may retain a record earlier sought from the public data table, and may be used for instance to represent sought records in data-aware controls of a record searching dialog. Concurrently retained auxiliary states differ from extended representative states in that the CPO 30 does not perform distribution to auxiliary states when focus moves to a potentially different public data instance. It is the obligation of further processes, either endowed to the CPO 30 or specifically engineered, to populate and maintain auxiliary states as necessary to the further processes.

Any number of auxiliary states can be created by the CPO 30 on behalf of an application or process, the scope of which can be described by a cooperative resource descriptor 80A, 80B, so that the CPO 30, by generic processes, can provide access to any given auxiliary state, and further resources necessary to its processing, on behalf of the application. In a search dialog where an auxiliary state may for instance be used to retain the last examined record of a search procedure, lookup tables can be linked to the given record, to provide a further scope of searched records. The CPO 30 may manage the necessary cooperative resources automatically.

“Concurrently Retained Auxiliary State Processes”

In the context of the present invention, a “concurrently retained auxiliary state process” is any process giving focus to a concurrently retained auxiliary state. Such “processes” therefore include for instance making the auxiliary state the focus of a dialog, or the container of values potentially involved particularly with processes which the CPO 30 may not appropriately be endowed with. For instance, a concurrently retained auxiliary state process may make an auxiliary state the focus of a specialized search dialog, engineered to navigate a specific table containing the public data instances.

“Comparison-Distribution Instances”

In the context of the present invention, “comparison-distribution instances” are private data instances which in part or whole are assignment compatible to the public data instance and not necessarily used for retaining processed states. A comparison-distribution instance may however serve the additional purpose of retaining a state such as a “last posted” state as described alternatively and without implied restriction, as in FIG. 2. By providing a vehicle for assignment and comparison, comparison-distribution instances provide to compare and distribute instances of the public data to and from both auxiliary states, and instances of private representations of the public data. Because their purposes therefore are not necessarily critical to resumption, comparison-distribution instances may exist either as volatile memory entities, or as entities concurrently or subsequently registered to retentive media.

“Cooperative Processing Objects” (“CPO”)

In the context of the present invention, “cooperative processing objects” (CPO) 30 at least perform distribution of public data to the private work area, and ensure “cooperative posting” is performed, either by performing “direct cooperative posting,” or by delegating cooperative posting to delegated cooperative posting objects 32A, 32B. The CPO 30 may otherwise perform any further responsibilities appropriately consolidated in the CPO 30. Particularly, it is desirable to endow the CPO 30 with capacities which, by cooperative resource descriptors 80A, 80B, can be applied to a logical organization of private and public states, especially if such capacities can be applied to plural instances of public data, or plural tables of different public data which can be addressed by logical organization of the private work area related to the public data.

“Write-ensuring, Navigating Cooperative Processing Objects” (“WENCPO”)

“Write-ensuring, navigating cooperative processing objects” (WENCPO) are “cooperative processing objects” given any power to perform navigation of organized data resources, such as tables, as will essentially acquire the value of different public data instances from the overall, navigable data organization, and which WENCPO invoke a “write to public instance event” before conditionally performing navigation. WENCPO therefore perform navigation only if any intended attempt to write to the previously focused public data instance is successful.

A CPO 30 endowed with the generic capacity to place record cursors on different records of formal tables for instance, if first invoking a WTPIE before conditionally performing navigation on the success of an intended write, is therefore a “write-ensuring, navigating cooperative processing object.” In the drawings, any instance of the CPO 30 may further be interpreted as a WENCPO, as a WENCPO is always a CPO, with the distinguishing notability therefore being that on any attempted navigation to a new public data instance, intended write operations will be performed automatically by the WENCPO invoking a WTPIE, with subsequent navigation being suspended until cooperative posting is successfully performed or ensured.

An important, inherent attribute of “write-ensuring, navigating cooperative processing objects” in conjunction to concurrent registration of states therefore, is that writing operations are fully automated, even in subsequent work sessions, however inadvertent the interceding session termination or obstructive the circumstances temporarily imposed by the operating environment. Data operations will always be posted, even in subsequent sessions, because whenever new data is acquired, a write operation, if necessary, and if intended, will be performed at least in the event of focusing on new public data, regardless of the session. If an intended write operation cannot be performed, by prescription therefore, the navigation process is suspended with processing status intact, ready and compelled to be posted, whenever obstructive exterior circumstances are rectified.

“Universal Development Templates”

Any of the intrinsic means and apparatus of the present invention may be integrated in “universal development templates,” endowing to development projects the integral capacities of the present invention. From such templates, developers may initiate development projects already embodying capacities of the present invention, and to which processes of the development projects, negotiating any scope of data, may readily be wed the cooperative or resumable capacities of the invention, merely, as in illustrated cases, by building appropriate private work areas, by registering resource descriptor objects with cooperative processing objects or by otherwise passing essential resource descriptions to the CPO 30, and by focusing private processes on representative or auxiliary states, thereupon invoking “write to public instance events” as necessary to register operations to public data instances in an intentionally, timely manner.

“Cooperative, End User Database Systems”

Any of the intrinsic means and apparatus of the present invention may be integrated in “cooperative, end user database systems,” providing to build or maintain cooperative databases or operations. Cooperative end user database systems may be endowed with capacities to create respective private work areas, to generate interfaces, and to provide cooperative operation.

“Cooperative Operating System Objects”

Any of the intrinsic means and apparatus of the present invention may be integrated in “cooperative operating system objects,” endowing processes of the operating system, or operating subject to the operating system, with any integral capacity of the present invention.

Orchestrated, Status-comprehensive, Momentary Backup”

An advantage of present-invention applications, which relate directly to their status and private work areas as concurrently registered to retentive media, is that a global flag may be set, inducing every participating application of the present technology to make a momentary copy of its status data and private work areas before performing any further operations. Should the operational data of the system ever become corrupted or irretrievable, this orchestrated, status-comprehensive, momentary backup of the entire system can be restored, with the result being that data integrity is maintained, not only in operational data, but in the very state, however tentative, of every node involved in the system. Each node thus restores to the very state at which a backup is invoked, even if applications are not operating at the time a flag is set, because, even if installed applications at remote nodes are not operating at the time a flag is set, by checking for flags at application startup and responding to backup flags at startup, copies of the subject node are made as if the node were operating at the time a flag was set (registering the state of the node as if it were operating), and therefore status and data integrity may be maintained periodically, across an entire system.

“Restoration of Remote Client Navigational Status by Client Instance-and-process-identifying Uniform Resource Indicators (URI)”

“Restoration of remote client navigational status by client instance-and-process-identifying uniform resource indicators”, is a URI-and-retained-data-instance-based technique wherein a client application session is assigned a unique ID by a server-side application 11S, which unique ID is thereafter passed in URIs exchanged between a cooperative local application 11C or 11T and the server-side application 11S, endurably identifying the local client application. Records of private state instances, remotely maintained private state instances, and “remotely mirrored states” are associated with the client application session by way of the unique ID. Where more than one process exists in the server-side application 11S (which server-side application 11S, by convention, must be identified in the URI), a further, “focused process argument” of the URI indicates the process of the cooperative local application 11C or 11T, or of the server-side application 11S, to which processes belong any associated, processed data. By the unique ID and “focused process argument” elements of a URI therefore, and by identifying retained states by the unique ID, cooperative processing status can be resumed from the URI, complete in all retentive status data. When the URI is requested by the client, the server-side application 11S performs the process corresponding to the “focused process argument”, which process, by the unique ID of the resumable session, identifies the data related to the resumable session, stored locally or remotely, and thereupon, the associated applications are populated with the resumed data of the process.

A URI therefore may, at the option of the local application, be retained for intentional resumption, without invasive registration of status on the client system. An object and advantage of the associated elements of this method are that from a URI and concurrently registered states existing in server or client resources, the process status of a given URI can be resumed from the client system by merely a URI comprising a unique ID and process (if more than one process is performed by URIs by the respective applications). The method therefore eliminates the need for conventional system conventions such as “cookies,” and thus provides for concurrently resumable functionality, particularly where intrusive methods such as “cookies” are intentionally disabled. The method does not store data in a “cookie,” and is an alternative embodiment of resumable status generally appropriate for resumption based on remotely mirrored states, however complex, from a relatively simple URI. In embodiments of “restoration of remote client navigational status by client instance-and-process-identifying uniform resource indicators” particularly, complex relational data therefore may be handled by native methods, without transformation of datasets as would be necessary if cookie-stored data were to be processed by native methods, with the further advantage that “cookies” are not necessarily appropriate containers for potentially complex and/or extensive tables.

“Restoration of Remote Client Navigational Status from Concurrently Registered Navigation Logging by Uniform Resource Indicators (URI)”

“Restoration of remote client navigational status from concurrently registered navigation logging by uniform resource indicators”, is a technique wherein a client application session is assigned a unique ID which is passed thereafter in URIs exchanged between a cooperative local application 11C or 11T and the server-side application 11S, perpetually identifying the local client application. Records of private state instances, remotely maintained private state instances, and “remotely mirrored states” are associated with the client application session by way of the unique ID. Where more than one process exists in the server-side application 11S (which server-side application 11S, by convention, must be identified in the URI), a “focused process argument” of the URI indicates the process of the cooperative local application 11C or 11T and/or of the server-side application 11S to which processes belong any associated, processed data.

In “restoration of remote client navigational status from concurrently registered navigation logging by uniform resource indicators”, whenever the client application requests a URI from the server-side application, the requested URI is logged to a table. An object of this table and identification system therefore, from any URI comprising the client application's identity, is the capacity to look up the last log entry related to the identity, and to restore to the client application its previous, ongoing navigational and/or work status. In the commencement of subsequent sessions therefore, whenever the client application requests any URI specific to the client application's history, “restoration of remote client navigational status from concurrently registered navigation logging by uniform resource indicators” is performed by the server-side application looking up the last URI logged for the client, to restore to the client application its previous navigational status, with retained data intact. Therefore, as such a process, in the context of the present invention, involves presenting data associated to the client by the unique ID of the client, merely invoking the last logged URI restores operational status.

A single URI therefore may, at the option of the local application, be retained for intentional resumption, without invasive registration of status on the client system. An object and advantage of the associated elements of this method are that from a URI and concurrently registered states existing in server or client resources, that merely from the identifying elements of a URI the last process and navigational status of the client system can be resumed from the client system, while a URI might likewise be alternatively deployed to restore the specific process status of a given process, not necessarily comprising the last navigational status of the system. From a given URI therefore, the client application may be provided the option to retrieve the status indicated by the URI, or the last navigational status of the system. The “restoration of remote client navigational status from concurrently registered navigation logging by uniform resource indicators” method therefore eliminates the need for conventional system conventions such as “cookies,” and thus provides for concurrently resumable functionality, particularly where intrusive methods such as “cookies” are intentionally disabled. The method does not store data in a “cookie,” and is an alternative embodiment of resumable status derived from a relatively simple URI. In embodiments of “restoration of remote client navigational status by client instance-and-process-identifying uniform resource indicators” particularly, complex relational data therefore may be handled by native methods, without transformation of datasets as would be necessary if cookie-stored data were to be processed by native methods, with the further advantage that “cookies” are not necessarily appropriate containers for potentially complex and/or extensive tables.

“Concurrently Retentive Navigation by Registered Navigation Logging”

A further possible implementation of the URI logging of “restoration of remote client navigational status from concurrently registered navigation logging by uniform resource indicators”, is that the very logged URIs can be presented to the client as a usually remotely (server-side) retained history of client navigation, providing to re-orient the client to any moment of past history processes, by presenting the URI history in the form of links to each URI of the history. It will be recognized that links to-each universal resource indicator are themselves universal resource indicators. Thus, it may also be said that the very logged URIs can be presented to the client as a usually remotely (server-side) retained history of client navigation, providing to re-orient the client to any moment of past history processes, by presenting the URI history in the form of links comprising universal resource indicators of the history. “Concurrently retentive navigation by registered navigation logging” involves presenting the URI history to the client application so as the client application may recall URIs comprising the history.

“Absolutely Secure Client Functionality”

A prevalent fault of conventional system practice is to support processes invoked from sectors of the operating environment such as browsers, which processes may operate on data or launch processes beyond the concept of an application processing only its own, integral data. In other words, only if the responsibilities of the operating environment and hosted applications are conceived to be restrictive obligations in terms of operations on application-specific data, permitting applications only to process their own data within restrictive storage areas unless otherwise explicitly granted the privilege to operate on further data, no threat to the operating environment is presented, and then only may the capacity to operate on data by hosted applications be restricted to the private work areas intrinsic to the present invention.

The vital and distinguishing principal of “absolutely secure client functionality” therefore is restriction of operations to permitted, integral data. In “absolutely secure client functionality”, foreign applications, imported for instance by URIs, are allowed only to operate locally on private instances of their data, and “publicly,” by processes intentionally endowed to the server-side application, to operate on exterior data belonging to the domain of the server-side application. In “absolutely secure client functionality”, no other processes can be launched than explicitly permitted, and no other data can be operated on.

“Absolutely secure client functionality” can be implemented integrally with all cooperative remote client embodiments of the present invention.

### Operation—Intrinsic Life Cycle of Concurrently Retained, Cooperatively Processed Data

Identification of Targeted Data

As we have elected to uniformly depict embodiments of both conventional systems and the present invention as illustrate instances of public data being members of typical, formal tables, the life cycle of processed data begins with setting cursors on the given public data instances 10A or 10B, of respective tables containing the public data instance. Despite this illustrative convention, public data instances 10A or 10B might exist in any possible form. The beginning of the life cycle of potentially processed data in the present invention therefore corresponds to focusing on the targeted data.

Distribution to Private Work Areas, and Simultaneous Operation

The present invention hereafter departs from conventional systems by distributing the public data instance to private, representative states of the invention, where processing can be carried out as the timely equivalent of operation on the targeted public data, but as uncompleted or unaffirmed processing does not require privileges to write to the actual public data instance.

Distribution to the Private Work Area

“Distribution” comprises assigning the value of the public data instance to the “representative states” of the private work area. In the FIGS., where private comparison-distribution instances 20A and 20B are available to an illustrated embodiment of the present invention, private comparison-distribution instances 20A and 20B are uniformly used to illustrate a method requiring only a single incoming copy of data to traverse inter-nodal throughput. Any other available comparison-distribution instance or private state instance might be used for the same purpose.

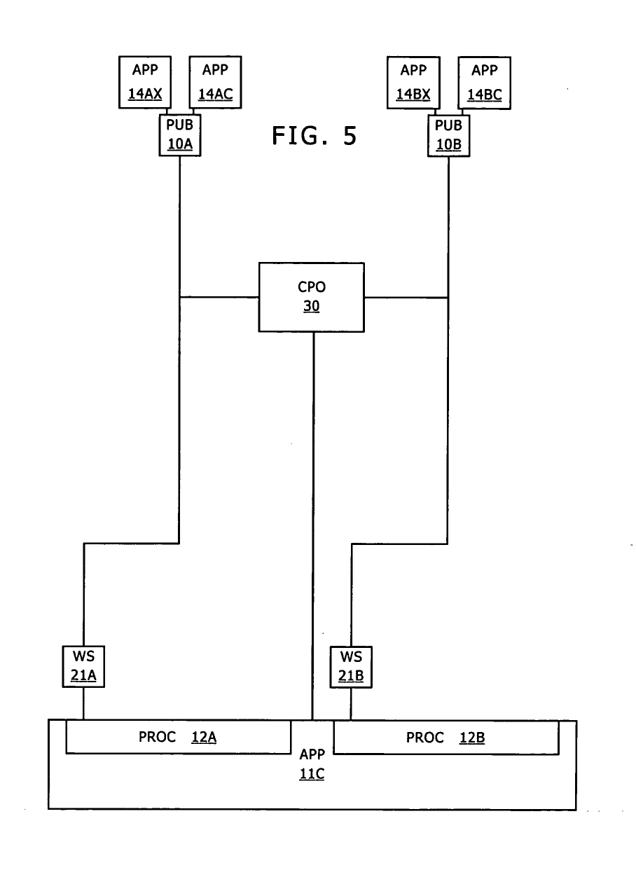

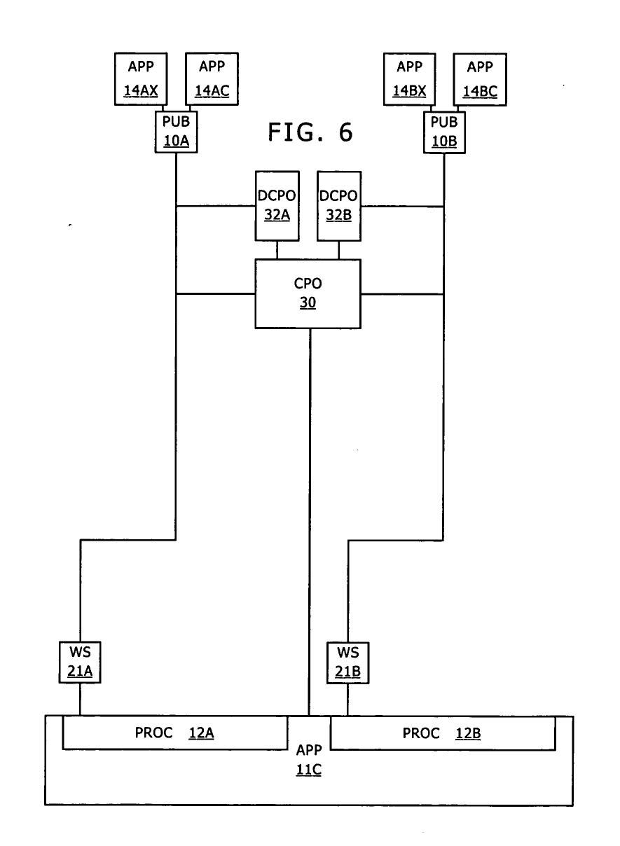

A preferable method of distribution, where a comparison-distribution instance is available, is to assign the value of the public data instance once across throughput, to a private comparison-distribution instance, and therefrom, internally, to the remainder of related, representative states. In FIGS. 2 through 4 inclusive therefore, in an embodiment of such a method involving minimal consumption of inter-nodal throughput for incoming data, “distribution,” in respect to public data instance 10A, would be comprised of assigning the value of public data instance 10A to private comparison-distribution instance 20A, and therefrom to “representative” states 21A, 22A, 23A, and 24A. “Distribution,” in respect to public data instance 10B, would be comprised of assigning the value of public data instance 10A to private comparison-distribution instance 20B, and therefrom to “representative” states 21B, 22B, 23B, and 24B.

Where a comparison-distribution instance is not available, as in FIG. 5 and FIG. 6, “distribution,” in respect to public data instance 10A, would be comprised of assigning the value of public data instance 10A to private work state 21A. “Distribution,” in respect to public data instance 10B, would be comprised of assigning the value of public data instance 10B to private work state 21B. Minimal incoming throughput consumption is likewise achieved in these cases, by assigning the value of the public data instance once and directly to the single private state instance.

Simultaneous Operation Achieved

In the private work areas of embodiments of the present invention therefore, processes can be carried out as is equivalent to operation on the targeted public data, but as does not require privileges to write to the actual public data instance. In private work areas of each application's focus on public data therefore, many processes can operate on a given instance of public data simultaneously, and can “cooperatively post” the results of privately performed processes to the public data instance whenever appropriate to the purposes of the application 11C, 11S, 11T, 14AC, or 14BC of the FIGS., by invoking a “write to public instance event.”

Scope of Apparatus Predicated by Scope of Objects

In embodiments of the present invention, within a private work area, a given apparatus provides for a scope of intrinsic methods. The population and organization of the work area thus are necessarily tailored both to the intended service of an embodiment, and to the characteristic behavior of the objects deployed to embody the invention.

To illustrate this concept, the provided examples represent registered data to the application 11C, 11S, 11T, 14AC, or 14BC and its processing of data by processes 12A or 12B, by way of hypothetical table components which provide one, single record cursor per table, indicating and providing the value of that one particular record to the respective processes 12A or 12B, or to the CPO 30. This illustrative stipulation of one record cursor per table interfacing component means that engineering of an embodiment of the invention from the given components can address only one record of a table at a given moment, and that to address a different record of the table, it is necessary to move the “cursor” to that record of the given table. In the FIGS., formal tables comprising a private work area in respect to a given public data instance therefore are symbolized by horizontal rows of records related to the respective public data instance. Nonetheless, a “private work area” may be comprised of any appropriate organization of states necessary to isolate representative states for private processing, as in private work states 21A or 21B, for which processing, until necessary to write to a public data instance 10A or 10B respectively, it is not necessary to acquire a write privilege to the public data instance.

Thus any private processing by the application, 11C, 11S, 11T, 14AC, or 14BC, can be carried out simultaneously by every other application, 11C, 11S, 11T, 14AC, or 14BC, with “cooperative posting” ensuring successful writing to the public data instance 10A or 10B whenever affirmation of processes is appropriate.

Concurrent Registration and Retention of States

Because embodiments of the invention substantially operate on retained states, status is concurrently registered to retentive media.

Potential Implementations of Auxiliary States

Auxiliary states such as 25A and 25B may be deployed for any purpose. “Auxiliary states” are distinguished from “representative states” in that auxiliary states do not necessarily reflect processing of respective, currently focused public data instances, 10A or 10B. Auxiliary states may for instance reflect different records of tables containing, respectively, public data instances as 10A or 10B.

An illustrative purpose of an auxiliary state therefore can be retention of a public data instance representing a record found by a previous search process, and presented to a search dialog by connecting data-aware controls to components interfacing with either table containing auxiliary state 25A or 25B, and by moving the cursor of the particular table containing auxiliary state 25A or 25B to the record of auxiliary state 25A or 25B, to populate the dialog without consuming inter-nodal throughput to the actual public data instance represented in the auxiliary state. Consequently, the contents of the last sought record, as previously located from the tables containing public data instances 10A or 10B respectively, would be reflected in the contents of private auxiliary states 25A or 25B respectively.

A lookup table can be assigned to either table containing auxiliary states 25A or 25B, which table might be populated with every such record of subsequent search processes, however many or limited. When the cursor of the table containing the auxiliary state is placed on the auxiliary state, typical lookup table components therefore will automatically place the lookup cursor on the auxiliary state as belongs to the table, and therefore the search dialog can make the last accepted search the focus of controls providing for operators to select the object of any previous search.

Automatic Resumption of Previous Status

Because applications embodying the invention process and interface with private work areas by negotiating the organization, and because private work areas are registered to retentive media concurrent with processing, therefore the life cycle of processed data can withstand obstructive exterior circumstances, and even inadvertent session termination. Regardless even of activation of the application, the private work area and its relation to public data persist in the organization and content of the private work area, which the application is always able to negotiate by virtue of cooperative resource descriptors. An application's relationship to this organization cannot be destroyed by either intended or inadvertent termination of worksessions, or non-destructive failure of the outer operating environment.

Resumable Processing Achieved

Resumable processing therefore is achieved without code dedicated to this purpose. Application of any process operating on concurrently registered states is possible in subsequent sessions as it is in current sessions. Furthermore, the obligation to post to the public data instance persists in any subsequent session as in any current session. It may be observed therefore that any concurrently registered operation described in this specification is inherently resumable. A “concurrently retained undo process” for instance, can be performed in subsequent sessions as well as a current session, no matter how many times between an application may be restarted.

### FIG. 2—“Differentiating” Embodiment with Capacity for Faster “Concurrently Retained Refresh from Public Status Processes”

### FIG. 2 Objects

Distinguishing characteristics of FIG. 2 are private work areas featuring two tables of comparison distribution instances (e.g., records) for each public data resource, with each of the comparison-distribution tables of a private work area providing one comparison-distribution record to the private work area, in respect to the public data instance and session. An illustrative object of this arrangement of the given components is faster performance of “concurrently retained refresh from public status processes” than feasible in FIG. 3.

In accord with this interest in faster performance of operations in FIG. 2, the comparison-distribution instances 20A, 20B may serve the further purpose of retaining separate “last posted” states in respect to public data instances 10A, 10B. In the case of this alternative embodiment, once the public data instance 10A, 10B is distributed to the private work area, the comparison-distribution instances 20A, 20B serve thereafter as separate instances of the last posted state, making it possible to retain the original states 22A, 22B as records of the public data instances 10A, 10B as first acquired. Thus in FIG. 2, in performing Differentiated Cooperative Posting, Updating Private States (DCPUPS), the “last posted” states of FIG. 2 are updated to reflect values posted to fields of the public data instances 10A, 10B. (In FIG. 3, as no separate “last posted” states are maintained, instead the original states 22A, 22B must be updated by DCPUPS to reflect values posted to fields of the public data instances 10A, 10B.) In the interest of retaining and restoring status in the illustrative embodiment of FIG. 2, comparison-distribution instances 20A, 20B must be concurrently registered to retentive media.

FIG. 2 Operation—“Concurrently Retained Refresh from Public Status Processes,” for Comparison to FIG. 3

With the organization of the comparison-distribution tables of FIG. 2, to prepare to perform a “concurrently retained refresh from public status process” operation from public data instance 10A, public data instance 10A can be assigned to comparison-distribution instance 18A. The last posted state is already retained in comparison-distribution instance 20A. To prepare to perform a “concurrently retained refresh from public status process” operation from public data instance 10B, public data instance 10B can be assigned to comparison-distribution instance 18B. The last posted state is already retained in comparison-distribution instance 20B. Thus the operation may be performed without moving record cursors from private work states 21A or 21B, and without iteratively moving comparison-distribution table cursors as necessary in FIG. 3.

In FIG. 2 therefore, even while fields of the private work state may be concurrently processed by further functions, a relatively high speed “concurrently retained refresh from public status” operation from public data instance 10A is performed by assigning the value of the corresponding field of the public data instance 10A to private work state 21A, undo state 23A, re-do state 24A, and finally to original state 22A, wherever the field of the retained state matches the value of the original state 20A. A “concurrently retained refresh from public status” operation from public data instance 10B is performed by assigning the value of the corresponding field of the public data instance 10B to private work state 21B, undo state 23B, re-do state 24B, and finally to original state 22B, wherever the field of the retained state matches the value of the original state 20B. In the case of FIG. 2, it is possible to perform the necessary assignments therefore by focusing on a representative state and comparing for a match to the original state retained in comparison-distribution instances 20A or 20B, whereupon, in finding a match to the original state, in fact any operations on the representative state have not resulted in modification, and therefore, in keeping with the definition of the process, the corresponding field of the public data instance represented in comparison-distribution instances 18A or 18B respectively may be assigned to the focused, representative state. Because record cursors do not have to be moved back and forth between comparison-distribution instances as in FIG. 3, in FIG. 2 therefore, the process is performed faster than feasible in FIG. 3.

FIG. 2 Operation—Differentiated Cooperative Posting, Updating Private States (DCPUPS)

Exemplary DCPUPS may be performed in FIG. 2 and in relation to public data instances 10A or 10B respectively.

So as not to extend the lock cycle by performing DCPUPS while retaining a lock on the public data instance, the “updating private states” (UPS) respect of DCPUPS may be performed after differentiated cooperative posting frees the lock on the public data instance.

Auxiliary states 25A or 25B are not processed by DCPUPS. DCPUPS however may be applied to the representative states 22A, 23A, 24A, or to the representative states 22B, 23B, 24B. As FIG. 2 implements separate “last posted” states, 20A, 20B, the UPS phase of DCPUPS must at least be performed on 20A, 20B.

Thus in performing DCPUPS on representative states 22A, 23A, 24A, or 20A, it is possible to iterate the fields of the private work state 21A to compare for differences between the fields of private work state 21A and each corresponding field of comparison-distribution instance and “last posted” state, 20A. In finding that a field of private work state 21A does not match the corresponding field of comparison-distribution instance 20A, it is known from the logic applied to differentiated posting that the value of the field of the private work state 21A was posted to the public data instance 10A, and it is known because DCPUPS is uniformly applied to the last posted state 20A, that 20A, until 20A is lastly updated by UPS, represents any previously posted state, prior to the present differentiated cooperative posting (DCP) cycle. The representative states 22A, 23A, and 24A therefore may be iterated, examining the respective field of each for a match to that field of comparison-distribution instance 20A, and by, upon finding a match, assigning the value of the respective field of private work state 21A to that field of the representative state.

Thus in performing DCPUPS on representative states 22B, 23B, and 24B, it is possible to iterate the fields of the private work state 21B to compare for differences between the fields of private work state 21B and each corresponding field of comparison-distribution instance and “last posted” state, 20B. In finding that a field of private work state 21B does not match the corresponding field of comparison-distribution instance 20B, it is known from the logic applied to differentiated posting that the value of the field of the private work state 21B was posted to the public data instance 10B, and it is known because DCPUPS is uniformly applied to the last posted state 20B, that 20B, until 20B is lastly updated by UPS, represents any previously posted state, prior to the present differentiated cooperative posting (DCP) cycle. The representative states 22B, 23B, and 24B therefore may be iterated, examining the respective field of each for a match to that field of comparison-distribution instance 20B, and by, upon finding a match, assigning the value of the respective field of private work state 21B to that field of the representative state.

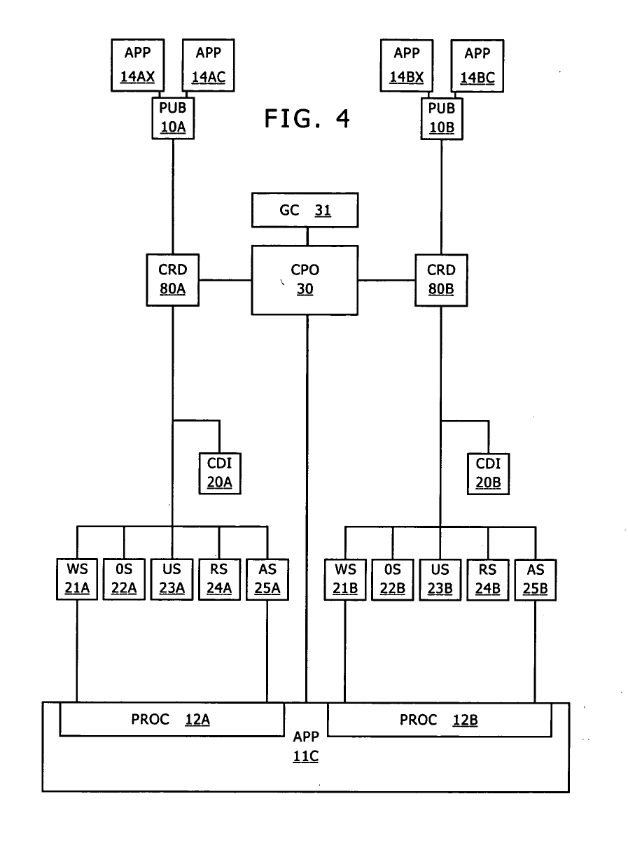

FIG. 2 Operation—Example, “Concurrently Retained Undo Processes,” for Comparison to FIG. 4

Exemplary “concurrently retained undo processes,” performed within the embodiments of FIG. 2 and FIG. 4, further establish that an appropriate organization and population of representative states, auxiliary states, and comparison-distribution instances is dictated by desirable or practical methods of accomplishing objects of an embodiment. To perform a “concurrently retained undo process” as possible with the resources endowed to the embodiment of FIG. 2 requires the following steps.

As earlier stated, a first phase of a “concurrently retained undo” process must register the private work state to the re-do state, which may be performed therefore within FIG. 2 by first moving the table cursor to re-do state 24A or 24B respectively. Private work state 21A or 21B may then be assigned directly to re-do state 24A or 24B respectively, as the separated table organization of FIG. 2 provides for direct assignment across the tables, without the need to utilize a comparison-distribution instance. This first phase thus requires 2 basic steps.

The second necessary phase of a “concurrently retained undo” process must assign undo state 23A or 23B to private work state 21A or 21B respectively. Such a second phase may be performed therefore within FIG. 2 by first moving the table cursor to the undo state, 23A or 23B. The undo state 23A or 23B may then be assigned directly to private work state, 21A or 21B respectively, as the separated table organization of FIG. 2 provides for direct assignment across the tables, without the need to utilize a comparison-distribution instance. This second phase thus requires 2 basic steps; and therefore a “concurrently retained undo” process can be performed within FIG. 2 by 4 basic steps, versus the 7 basic steps possible in the cited, illustrative method explained for FIG. 4.

FIG. 2 Conclusions, Ramifications

The prescribed, illustrated embodiment of FIG. 2 can perform faster “concurrently retained refresh from public status processes” and faster “uninterrupted processing concurrent with performance of concurrently retained refresh from public status processes” than feasible in FIG. 3. Processes involving cross table assignment in FIG. 2 can likewise be performed faster than possible in FIG. 4.

### FIG. 3—“Differentiating” Embodiment Performing “Concurrently Retained Refresh from Public Status Processes” with Fewer Resources

FIG. 3 Objects

Distinguishing characteristics of FIG. 3 are private work areas each featuring one table of comparison distribution instances comprised of two comparison-distribution records. An illustrative object of this arrangement is performance of “concurrently retained refresh from public status processes” with fewer resources, in terms of components interfacing with private tables, than feasible in FIG. 2.

FIG. 3 Operation—“Concurrently Retained Refresh from Public Status Process,” for Comparison to FIG. 2

With the organization of the comparison-distribution tables of FIG. 3, to prepare to perform a “concurrently retained refresh from public status process” operation from public data instance 10A, public data instance 10A can be assigned to comparison-distribution instance 20A, and original state 22A may be assigned to comparison-distribution instance 19A. To prepare to perform a “concurrently retained refresh from public status process” operation from public data instance 10B, public data instance 10B can be assigned to comparison-distribution instance 20B, and original state 22B may be assigned to comparison-distribution instance 19B. Because however both comparison-distribution records belong to the same table served by a hypothetical table component endowed with a single cursor, in FIG. 3 the operation must be performed by moving comparison-distribution table cursors as necessary.

In FIG. 3 therefore, even while fields of the private work state may be concurrently processed by further functions, a “concurrently retained refresh from public status” operation can be performed from public data instance 10A by assigning the value of the corresponding field of the public data instance 10A to private work state 21A, undo state 23A, re-do state 24A, and to original state 22A, wherever the field of the state matches the value of the original state. A “concurrently retained refresh from public status” operation from public data instance 10B can be performed by assigning the value of the corresponding field of the public data instance 10B to private work state 21B, undo state 23B, re-do state 24B, and to original state 22B, wherever the field of the state matches the value of the original state. In the case of FIG. 3, in performing the necessary assignments therefore by focusing on a representative state and comparing for a match to the original state retained in comparison-distribution instances 19A or 19B, and thereupon, in finding a match to the original state, the field of the representative state has not been modified. Therefore, in keeping with the definition of the process, the corresponding field of the public data instance represented in comparison-distribution instances 20A or 20B respectively may be assigned to the focused, representative state, but only by first moving the cursor of the comparison-distribution table to comparison-distribution instance 20A or 20B respectively, and subsequently by returning the cursor to the record of comparison-distribution instance 19A or 19B respectively to perform the necessary comparisons and assignments. Because record cursors must be moved back and forth between comparison-distribution instances as in FIG. 3, the process requires more time-consuming operations than engendered by the embodiment in FIG. 2.

FIG. 3 Conclusions, Ramifications

The prescribed, illustrated embodiment of FIG. 3 can perform “concurrently retained refresh from public status processes” and “uninterrupted processing concurrent with performance of concurrently retained refresh from public status processes” with less private table interfacing resources than used in FIG. 2.

### FIG. 4—“Differentiating” Embodiment Incapable of Providing “Uninterrupted Processing Concurrent with Performance of Concurrently Retained Refresh from Public Status Processes”

FIG. 4 Objects

Distinguishing characteristics of FIG. 4 are private work areas featuring one comparison-distribution table and a single comparison-distribution record, with a single table containing the representative and auxiliary states. An illustrative object of this organization is operations of restricted scope, with fewer resources in terms of number of private tables and number of components interfacing with private tables than characterized in FIG. 2 or FIG. 3.

FIG. 4 Operation—Example, “Concurrently Retained Undo Processes,” for Comparison to FIG. 2

To perform a “concurrently retained undo process” as possible with the resources endowed to the embodiment of FIG. 4 requires the following steps. As earlier stated, a first phase of a “concurrently retained undo” process must register the private work state to the re-do state, which may be performed therefore within FIG. 4 by first assigning private work state 21A or 21B to the respective comparison-distribution instance 20A or 20B. The cursor of the table containing the re-do state must then be moved to re-do state 24A or 24B, respectively. The content of the comparison-distribution instance 20A or 20B may then be assigned to re-do state 24A or 24B respectively. This first phase thus requires 3 basic steps, versus the 2 basic steps of FIG. 2.

The second necessary phase of a “concurrently retained undo” process must assign undo state 23A or 23B to private work state 21A or 21B respectively. Such a second phase may be performed therefore within FIG. 4 by first moving the cursor of the table containing the undo state to the undo state, 23A or 23B. The undo state 23A or 23B may then be assigned to comparison-distribution instance 20A or 20B respectively. The cursor of the table containing the work state may then be moved to private work state 21A or 21B respectively. The content of the comparison-distribution instance 20A or 20B may then be assigned to private work state 21A or 21B respectively. This second phase thus requires 4 basic steps; and therefore a “concurrently retained undo” process can be performed within FIG. 4 by these phases, totaling 7 basic steps, versus the total of 4 basic steps possible in the cited, illustrative method explained for FIG. 2.

FIG. 4 Conclusions, Ramifications

FIG. 4 is incapable of “concurrently retained refresh from public status processes” because FIG. 4 lacks sufficient comparison-distribution instances to perform the operation while negotiating the single states tables of the private work areas. The single record cursor of the illustrative embodiment must leave private work state 21A or 21B, making it impossible for instance for conventional data-aware controls processing the work state to continue processing the work state without interruption.

The prescribed, illustrated embodiment of FIG. 4 provides restricted operations, performed in more steps than possible in FIG. 2 and FIG. 3, with fewer table resources.

### FIG. 5—“Non-differentiating” Embodiment

FIG. 5 Objects

Distinguishing characteristics of FIG. 5 are private work areas featuring one table of a single private work state, 21A, or 21B. FIG. 5 is a non-differentiating, direct cooperative posting embodiment, which posts the private work state to the public data instance in response to “write to public instance events.”

FIG. 5 Operation

A public data instance 10A or 10B is distributed to the private work state, 21A or 21B respectively. There, data is privately processed, without needing to acquire write privilege to the public data instance until affirmed operations are intended to be written. When a “write to public instance event” is fired, the cooperative processing object (CPO) 30 performs non-differentiated, direct cooperative posting.

In non-differentiated, direct cooperative posting, the CPO 30 repeatably 1.) attempts to secure write permission; 2A.) if write permission is acquired, the CPO 30 performs the write operation over a substantially minimal duration; 2B1.) or if write permission is not acquired, the CPO 30 either re-enters step 2A., retrying to acquire write permission; or 2B2.) “times out” (exhausts intended effort), suspending resumable operations.

FIG. 5 Conclusions, Ramifications

FIG. 5 provides cooperative, simultaneous, resumable data processing of a simple form.

### FIG. 6—“Delegated Cooperative Posting”Embodiment

FIG. 6 Objects

Distinguishing characteristics of FIG. 6 are “delegated cooperative posting” performed by “delegated cooperative posting objects” (DCPO) 32A, 32B, processing public data instances 10A or 10B with private work areas featuring one table of a single private work state.

FIG. 6 Operation

A public data instance 10A or 10B is distributed to the private work state, 21A or 21B respectively. There, data is privately processed, without needing to acquire write privilege to the public data instance until affirmed operations are intended to be written. When a “write to public instance event” is fired, the CPO 30 requests that the delegated cooperative posting objects (DCPOs) 32A or 32B, perform “delegated cooperative posting” against public data instance 10A or 10B, respectively.

In “delegated cooperative posting,” the CPO (30) repeatably 1.) attempts to delegate the write process to the dedicated DCPO 32A, 32B; 2A.) if the write process is successfully delegated, the CPO 30 passes control to further processes, if any; 2B1.) or if the write process is not successfully delegated, the CPO 30 either re-enters step 2A., re-trying to delegate the write process; or 2B2.) “times out” (exhausts intended effort), suspending resumable operations. Reasons delegation could fail for instance would include lost communication with a server-resident DCPO, other failures of the external environment, or failure of the DCPO.

In “delegated cooperative posting,” DCPOs 32A, 32B assume responsibility to perform the write operation. Where an embodiment provides original states 22A or 22B, write processes may be “differentiated” by the CPO 30 or DCPO 32A, 32B. In either case, “differentiation” requires either: distinguishing processed fields; distinguishing unprocessed fields; or providing pre-processed and post-processed data states for differentiation.

FIG. 6 Conclusions, Ramifications

FIG. 6 provides cooperative, simultaneous, resumable data processing of a simple form, by way of “delegated cooperative posting.”

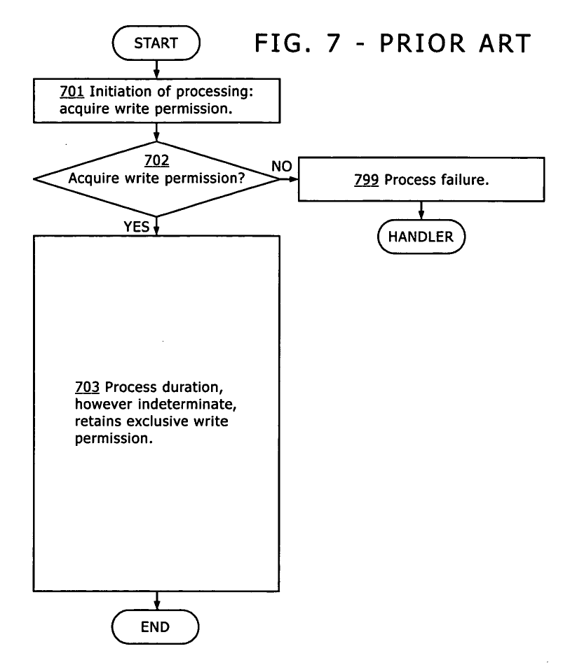

### FIG. 7 —Flow Diagram, Disadvantages of Conventional Systems

FIG. 7 illustrates disadvantages of conventional systems and problems which the present invention solves.

In FIG. 7, the initiation of any process writing to public data requires acquiring write permission 701. If the attempt to acquire write permission 702 fails (“No” path out of logic fork 702), the process fails 799, as the object of writing process results to the public data cannot be performed. On the other hand, if the attempt to acquire write permission 702 succeeds (“Yes” path out of logic fork 702), process duration, however indeterminate, retains the exclusive write permission (step 703), denying however many further processes the vital opportunity to write.

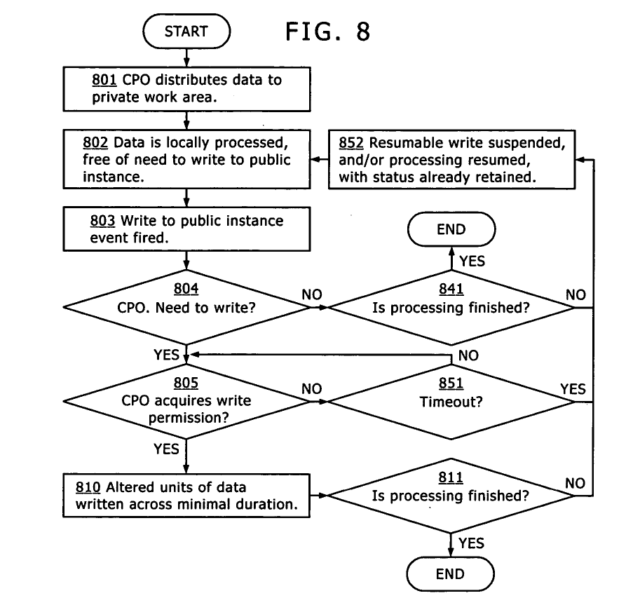

### FIG. 8—Flow Diagram, “Direct,” “Differentiated Cooperative Posting”

FIG. 8 illustrates a flow diagram associated with a direct, differentiated, cooperative posting embodiment. In an initial phase of potential operations targeting public data, the CPO 30 distributes the public data to the representative states of the private work area (step 801). In the private work area, tentative representative states of the data may remain subject to private processing (step 802), if any, without needing to acquire write permission to the public data instance. Confirmed operations are posted by direct, differentiated cooperative posting, invoked by a “write to public instance event,” (step 803).

In “direct,” “differentiated cooperative posting,” the CPO 30 “differentiates” the need to write (logic fork 804), by comparing a private work state to an original state, which original state may alternatively be updated to reflect the value of any fields posted to the public data instance, as herein described as DCPUPS. Differentiated fields, reflecting differences between the private work state and original state, indicate private processing has resulted in a need to write to the public data instance.

At logic fork 804, if no need to write exists, no attempt to write is made, and processing proceeds to termination fork 841.

At termination fork 841, the life cycle of the focused data is concluded (END), for example, to focus on another public data instance. If processing is not concluded at termination fork 841, operations are safely suspended or resumed (step 852), whereafter, tentative representative states of the data may remain subject to private processing (step 802), if any.

At logic fork 804, if a need to write exists, the CPO 30 attempts to acquire permission to write to the public data instance (step 805).

When the CPO 30 attempts to acquire permission to write to the public data instance (step 805), if permission to write is not successfully acquired, the CPO 30 determines if a repeatable attempt to secure write permission has “timed out” (exhausted the intended scope of effort) (optional timeout fork 851). Essentially, a process incapable of repeatably attempting to secure write permission “times out” on the initial effort.

If at optional timeout fork 851 the repeatable attempt to secure write permission has not timed out, again the CPO 30 attempts to acquire permission to write to the public data instance (step 805), so it may, if successful, perform the write operation.

If at optional timeout fork 851 the repeatable attempt to secure write permission has timed out, operations are safely suspended or resumed (step 852), whereafter, tentative representative states of the data may remain subject to private processing (step 802), if any.

When the CPO 30 attempts to acquire permission to write to the public data instance (step 805), if permission to write is successfully acquired, the CPO 30 writes “differentiated” fields of the private work state to the public state over a substantially minimal duration, and immediately releases public data instance write permission to other processes (step 810). Optionally, the CPO 30 may also write posted fields to fields of representative states matching the original state, to reflect in unmodified fields of the representative states that the current, known value of the field is now known to be the original state of the public data, as last determined only by writing new data to the public instance. Processing then proceeds from step 810 to termination fork 811.

At termination fork 811, if processing is finished, then the life cycle of the private isolation of the data is concluded (END), for example, to focus on another public data instance. If processing is not concluded at termination fork 811, operations are safely suspended or resumed (step 852), whereafter, tentative representative states of the data may remain subject to private processing (step 802), if any.

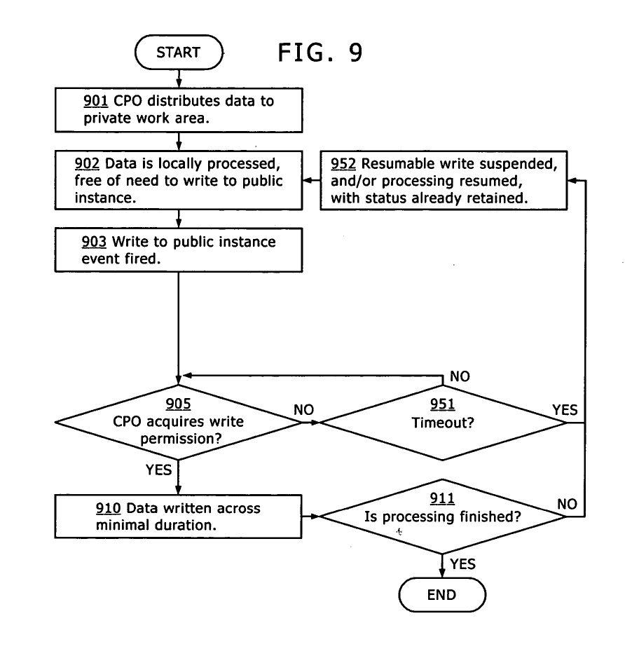

### FIG. 9—Flow Diagram, “Direct,” “Non-differentiated Cooperative Posting”

FIG. 9 illustrates a flow diagram associated with a direct, non-differentiated, cooperative posting embodiment. In an initial phase of potential operations targeting public data, the CPO 30 distributes the public data to the representative states of the private work area (step 901). In the private work area, tentative representative states of the data may remain subject to private processing (step 902), if any, without needing to acquire write permission to the public data instance. Confirmed operations are posted by direct, non-differentiated cooperative posting, invoked by a “write to public instance event” (step 903).

In “non-differentiated cooperative posting,” when a “write to public instance event” 903 is fired, the CPO 30 attempts to acquire permission to write to the public data instance (step 905).

When the CPO attempts to acquire permission to write to the public data instance (step 905), if permission to write is not successfully acquired, the CPO determines if a repeatable attempt to secure write permission has “timed out” (exhausted the intended scope of effort) (optional timeout fork 951). Essentially, a process incapable of repeatably attempting to secure write permission “times out” on the initial effort.

If at optional timeout fork 951 the repeatable attempt to secure write permission has not timed out, again the CPO 30 attempts to acquire permission to write to the public data instance (step 905), so it may, if successful, perform the write operation.

If at optional timeout fork 951 the repeatable attempt to secure write permission has timed out, operations are safely suspended or resumed (step 952), whereafter, tentative representative states of the data may remain subject to private processing (step 902), if any.

When the CPO 30 attempts to acquire permission to write to the public data instance (step 905), if permission to write is successfully acquired, the CPO 30 writes fields of the private work state to the public state over a substantially minimal duration, and immediately releases public data instance write permission to other processes (step 910). Processing then proceeds to termination fork 911.

At termination fork 911, if processing is finished, then the life cycle of the private isolation of the data is concluded (END), for example, to focus on another public data instance. If processing is not concluded at termination fork 911, operations are safely suspended or resumed (step 952), whereafter, tentative representative states of the data may remain subject to private processing (step 902), if any.

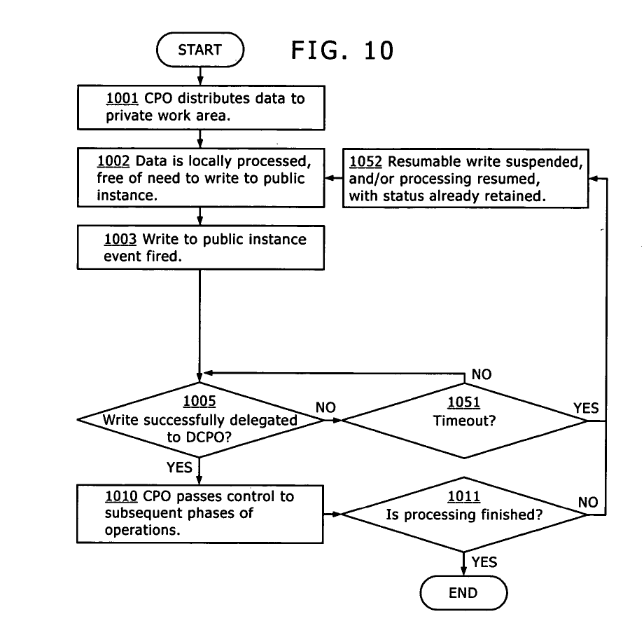

### FIG. 10—Flow Diagram, “Delegated Cooperative Posting”

FIG. 10, illustrates a flow diagram associated with a delegated cooperative posting embodiment. In an initial phase of potential operations targeting an instance of public data, the CPO 30 distributes the public data to the representative states of the private work area (step 1001). In the private work area, tentative representative states of the data may remain subject to private processing (step 1002), if any, without needing to acquire write permission to the public data instance. Confirmed operations are posted by delegated cooperative posting, invoked by a “write to public instance event,” (step 1003).

In “delegated cooperative posting,” when a “write to public instance event” (step 1003) is fired, the CPO 30 attempts to delegate the responsibility to write to a “delegated cooperative posting object” 32A, 32B (step 1005).

When the CPO 30 attempts to delegate the responsibility to write to a “delegated cooperative posting object” 32A, 32B (step 1005), if the responsibility to write is not successfully delegated, the CPO 30 determines if a repeatable attempt to delegate the responsibility to write has “timed out” (exhausted the intended scope of effort) (optional timeout fork 1051). Essentially, a process incapable of repeatably attempting to delegate the responsibility to write “times out” on the initial effort.

If at optional timeout fork 1051 the repeatable attempt to delegate the responsibility to write has not timed out, again the CPO 30 attempts to delegate the responsibility to write to the “delegated cooperative posting object” (step 1005).

If at optional timeout fork 1051 the repeatable attempt to delegate the responsibility to write has timed out, operations are safely suspended or resumed (step 1052), whereafter, tentative representative states of the data may remain subject to private processing (step 1002), if any.

When the CPO 30 attempts to delegate the responsibility to write to a “delegated cooperative posting object” 32A, 32B (step 1005), if the responsibility to write is successfully delegated, the DCPO 32A, 32B writes the result of private processing to the public data instance, and the CPO 30 passes control to subsequent phases of operations, if any (step 1010). Processing then proceeds to termination fork 1011.

At termination fork 1011, if processing is finished, then the life cycle of the private isolation of the data is concluded (END), for example, to focus on another public data instance. If processing is not concluded at termination fork 1011, operations are safely suspended or resumed (step 1052), whereafter, tentative representative states of the data may remain subject to private processing (step 1002), if any.

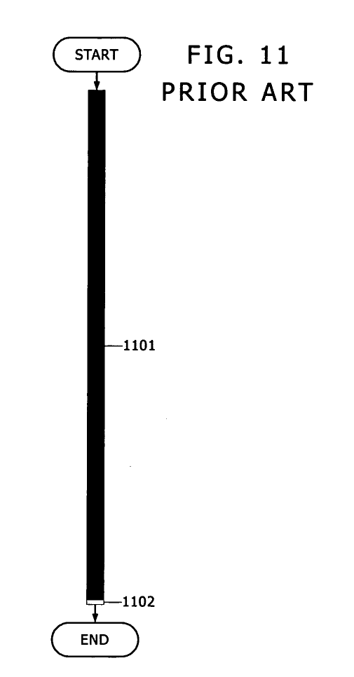

### FIG. 11—Timeline, Write Permission Duration of Conventional System

In conventional systems, an exclusive write permission to public data can be retained for the duration of processing 1101 and relinquished only at the affirmed conclusion of processing 1102, engendering diverse instances and relatively high probabilities of failure in competing processes.

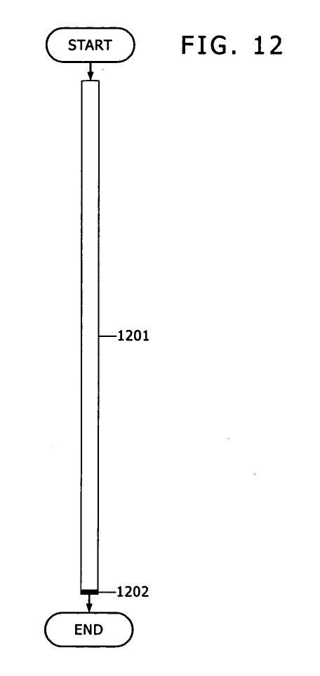

### FIG. 12—Timeline, Write Permission Duration, “Direct Cooperative Posting

In “direct cooperative posting” embodiments, write permission to public data remains available to further processes for the entire duration of private processing 1201. A repeatable attempt to secure the write privilege to public data, and a substantially minimal write duration 1202, ensure write operations are successfully performed in any environment capable of supporting intended operations.

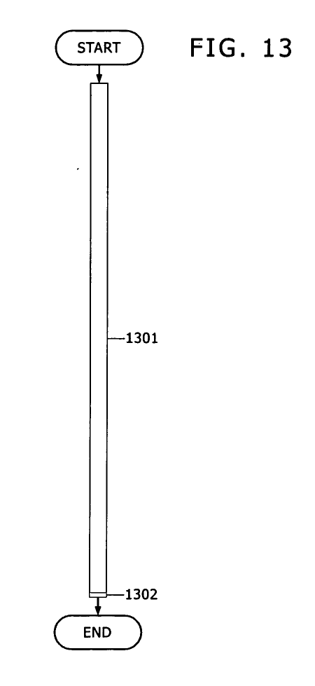

### FIG. 13—Timeline, Write Permission Duration, “Delegated Cooperative Posting” (“DCP”)

In “delegated cooperative posting” embodiments, private processes are indifferent to posting activity 1301. A repeatable attempt to delegate the write responsibility, and a substantially minimal write duration, optionally performed after repeatably attempting to secure write permission, 1302, ensure write operations are successfully performed in any environment capable of supporting intended operations.

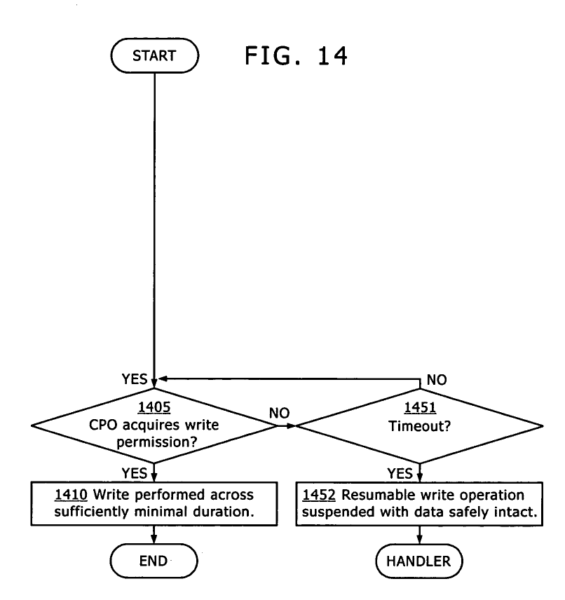

### FIG. 14—Flow Diagram, “Direct Cooperative Posting”

FIG. 14 illustrates a flow diagram associated with a direct cooperative posting embodiment. In either “differentiated” or “non-differentiated” methods of “direct cooperative posting,” the CPO 30 attempts to acquire permission to write to the public data instance (step 1405).

When the CPO 30 attempts to acquire permission to write to the public data instance (step 1405), if permission to write is not successfully acquired, the CPO 30 determines if a repeatable attempt to secure write permission has “timed out” (exhausted the intended scope of effort) (optional timeout fork 1451). Essentially, a process incapable of repeatably attempting to secure write permission “times out” on the initial effort.

If at optional timeout fork 1451 the repeatable attempt to secure write permission has not timed out, again the CPO 30 attempts to acquire permission to write to the public data instance (step 1405), so it may, if successful, perform the write operation.

If at optional timeout fork 1451 the repeatable attempt to secure write permission has timed out, operations are safely suspended or resumed (step 1452), whereafter, tentative representative states of the data may remain subject to private processing, if any.

When the CPO 30 attempts to acquire permission to write to the public data instance (step 1405), if permission to write is successfully acquired, the CPO 30 writes either “differentiated” fields (altered fields) or “non-differentiated” fields (all fields) of the private work state to the public state over a sufficiently minimal duration, and immediately releases public data instance write permission to other processes (step 1410). Alternatively, in differentiated, direct cooperative posting, the CPO 30 may also write posted fields to fields of representative states matching the original state, as herein described as DCPUPS.

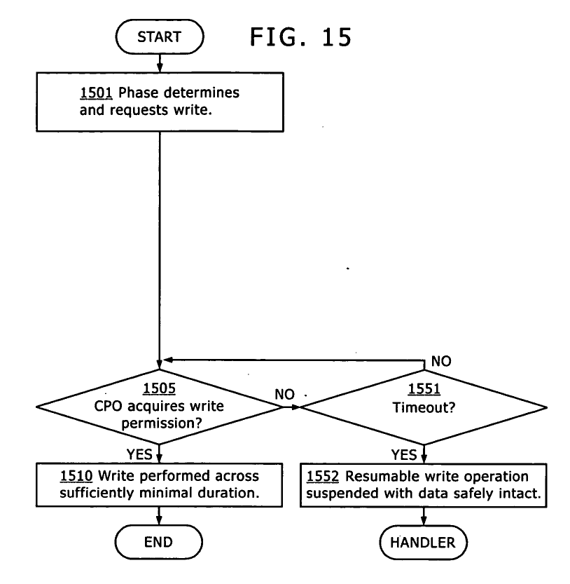

### FIG. 15—Flow Diagram, “Extended, Direct, Cooperative Write-related Operations”

FIG. 15 illustrates a flow diagram associated with an alternative embodiment of extended, direct, cooperative write-related operations. A phase of such an operation determines a need to write to the public data instance (step 1501), and thereupon passes the responsibility to acquire write permission to the capacities endowed the CPO 30.

When the CPO 30 attempts to acquire permission to write to the public data instance (step 1505), if permission to write is not successfully acquired, the CPO 30 determines if a repeatable attempt to secure write permission has “timed out” (exhausted the intended scope of effort) (optional timeout fork 1551). Essentially, a process incapable of repeatably attempting to secure write permission “times out” on the initial effort.

If at optional timeout fork 1551 the repeatable attempt to secure write permission has not timed out, again the CPO 30 attempts to acquire permission to write to the public data instance (step 1505), so, if successful, the write operation can be performed.

If at optional timeout fork 1551 the repeatable attempt to secure write permission has timed out, operations are safely suspended or resumed (step 1552), whereafter, tentative representative states of the data concurrently registered to retentive media may provide for process resumption. Alternatively, the CPO may notify the initiating processes of failure to acquire permission to write, which processes then may handle failure.

When the CPO 30 attempts to acquire permission to write to the public data instance (step 1505), if permission to write is successfully acquired, the write process is performed over a sufficiently minimal duration by either the CPO 30 or the operation. Write permission is immediately released, and control is passed to handlers of the successful write process, if any, (step 1510).

By this method, data processing capacities of the invention are extended to further application processes, not necessarily endowed to the CPO 30.

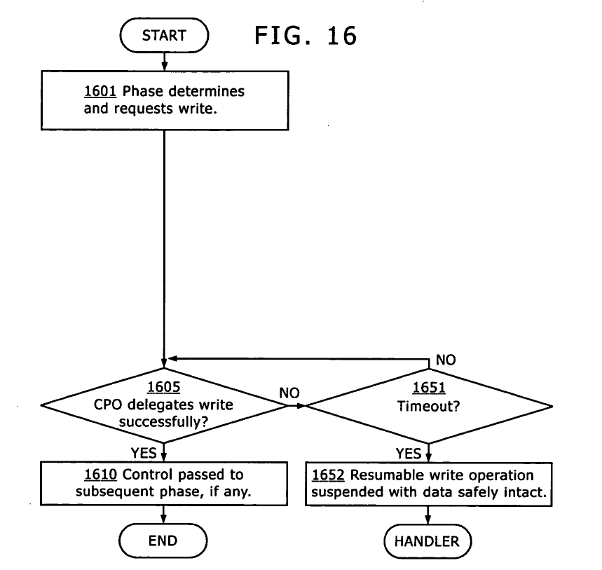

### FIG. 16—Flow Diagram, “Extended, Delegated, Cooperative Write-related Operations”

FIG. 16 illustrates a flow diagram associated with an alternative embodiment of extended, delegated, cooperative write-related operations. A phase of such an operation determines a need to write to the public data instance (step 1601), and thereupon passes the responsibility to write to the CPO 30, which attempts to delegate the responsibility to a “delegated cooperative posting object” (DCPO) 32A, 32B.

When the CPO 30 attempts to delegate the responsibility to write to a “delegated cooperative posting object” 32A, 32B (step 1605), if the responsibility to write is not successfully delegated, the CPO 30 determines if a repeatable attempt to delegate the responsibility to write has “timed out” (exhausted the intended scope of effort) (optional timeout fork 1651). Essentially, a process incapable of repeatably attempting to delegate the responsibility to write “times out” on the initial effort.

If at optional timeout fork 1651 the repeatable attempt to delegate the responsibility to write has not timed out, again the CPO 30 attempts to delegate the responsibility to write to a “delegated cooperative posting object” 32A, 32B (step 1605).

If at optional timeout fork 1651 the repeatable attempt to delegate the responsibility to write has timed out, operations on representative states are safely suspended or resumed (step 1652), whereafter, tentative representative states of the data concurrently registered to retentive media may provide for process resumption. Alternatively, the CPO 30 may notify the initiating processes of failure to delegate the responsibility to write, which processes then may handle failure.

When the CPO 30 attempts to delegate the responsibility to write to a “delegated cooperative posting object” 32A, 32B (step 1605), if the responsibility to write is successfully delegated, the CPO 30 passes control to handlers of the successful write process, if any, (step 1610).

By this method, data processing capacities of the invention are extended to further application processes, not necessarily endowed to the CPO 30.

### FIG. 17—“Cooperative, Thin Client, Locally and Remotely Processed” (“CTCLARP”) Embodiment with Differentiated or Non-differentiated Cooperative Posting

FIG. 17 Objects

Distinguishing characteristics of FIG. 17 are remote private state instances 22A, 23A, 24A, 22B, 23B, 24B, comparison-distribution instances 18A, 20A, 18B, 20B, and cooperative resource descriptors 80A and 80B, managed by remote CPO 30, alternatively acting in conjunction with server-side application, 11S. A local thin client application 11T may communicate directly with the remote CPO 30 or server-side application 11S, or by graphic controls 31 to CPO processes. Private state instances 21A, 25A, 21B, 25B are local to the thin client application 11S. Public data instances 10A, 10B may reside anywhere. Local thin client processes 12A, 12B operate on private work states 21A or 21B respectively, or on auxiliary states 25A or 25B respectively. An illustrative object of this arrangement is that a lighter client application can operate on focused work or auxiliary states. However, any number of representative states, extended representative states, or auxiliary states may reside either locally with the thin client application 11T or remotely with the server-side application 11S as necessary to the purposes of the applications 11T, 11S altogether.

FIG. 17 Operation

The operation of FIG. 17 is as in FIG. 2, except that in addition to data, instructions from the thin client application 11T to the CPO 30 or server-side application 11S may traverse inter-nodal throughput between the thin client application 11T and server-side application 11S or CPO 30.

FIG. 17 Conclusions, Ramifications

With concurrent registration of the states private to the thin client application, ongoing processing status is retained in light “applications” of the genre of contemporary Internet implementations. An advantage of cooperative thin client functionality is elimination of the need for comprehensive handling of conventional system errors, which further makes it all the more possible to turn out lighter thin client and server applications.

### FIG. 18—“Cooperative, Thin Client, Locally; and Remotely Processed” (“CTCLARP”) Embodiment with Differentiated or Non-differentiated Cooperative Posting and Remotely Mirrored States

FIG. 18 Objects

Characteristics distinguishing FIG. 18 from FIG. 17 are remotely mirrored instances of a work state 41A or 41B, mirroring affirmed status of the private work states 21A or 21B respectively, and remotely mirrored instances of an auxiliary state 45A or 45B, mirroring affirmed status of the auxiliary states 25A or 25B respectively. Remotely mirrored states provide for restoring the status of the local thin client application 11T. The thin client application 11T therefore may be destroyed at session termination; and it is not necessary to register the representative or auxiliary states processed locally by the thin client application 11T, because remote mirroring provides for restoration.

FIG. 18 Operation

The operation of FIG. 18 is as in FIG. 17, except that distribution is augmented by “concurrently retained distribution to remotely mirrored states;” and registration of local operations to remotely mirrored states is triggered by “write to remotely maintained state events” (WTRMSE).

FIG. 18 Conclusions, Ramifications

This embodiment is capable of “restoration of remote client navigational status by client instance-and-process-identifying uniform resource indicators,” “restoration of remote client navigational status from concurrently registered navigation logging by uniform resource indicators,” and “absolutely secure client functionality.” Ongoing status can be restored, even after local destruction of the thin client application. An advantage of cooperative thin client functionality is elimination of the need for comprehensive handling of conventional system errors, which further makes it all the more possible to turn out lighter thin client and server applications.

### FIG. 19—“Cooperative, Thin Client, Locally and Remotely Processed” (“CTCLARP”) Embodiment with Delegated Cooperative Posting and Remotely Mirrored States

FIG. 19 Objects

Characteristics distinguishing FIG. 19 from FIG. 18 are differentiated or non-differentiated, delegated cooperative posting, performed by DCPO 32A or 32B.

FIG. 19 Operation

The operation of FIG. 19 is as in FIG. 18, except that delegated cooperative posting to the public data instance is triggered by “write to public instance events” (WTPIE).

FIG. 19 Conclusions, Ramifications

This embodiment is capable of “restoration of remote client navigational status by client instance-and-process-identifying uniform resource indicators,” “restoration of remote client navigational status from concurrently registered navigation logging by uniform resource indicators,” and “global, absolutely secure client functionality.” Ongoing status can be restored, even after local destruction of the thin client application. An advantage of cooperative thin client functionality is elimination of the need for comprehensive handling of conventional system errors, which further makes it all the more possible to turn out lighter thin client and server applications.

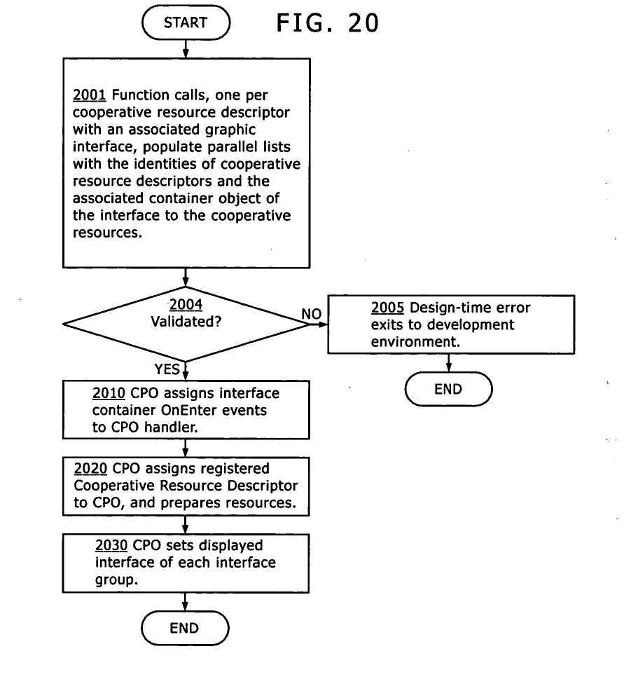

### FIG. 20—Flow Diagram of an Initialization Process for Automatic Resumption of Application Focus and Processing

FIG. 20 Objects

In FIG. 20, objects of an alternative embodiment of the present invention are to prepare an environment in which, as an operator navigates an application, the CPO 30 may automatically manage the application's data resources with a minimum of active, connective resources; and in which environment, status of operations and navigation of the application may be concurrently registered, so that at initialization of the application, previous status is resumed.

FIG. 20 Operation

In FIG. 20, parallel arrays or sufficient equivalents are populated, such that the index position of the element of an array of cooperative resource descriptors corresponds to the index position of the corresponding interface container object containing the interface to the data resources described by a cooperative resource descriptor. In Object Pascal for instance, a sufficient equivalent of an array suitable for this purpose is a TList, which is a dynamic array of pointers. An operation performed on or of an element of a TList therefore translates to performing the operation on or of the listed object.

In FIG. 20, a cooperative resource descriptor describes a focused table of public data and the further resources necessary to cooperatively process focused instances of the public table in a given interface, each which given interface is contained altogether by a given interface container object, such as a panel occupying a page of a tabbed page control. As such a panel, in Object Pascal, becomes the “owner” of the components occupying the panel, the OnEnter event of the panel is triggered automatically when focus is shifted from an exterior object to any object contained within the panel. The OnEnter event of the panel therefore can be used to signify that potential operations within the panel require preparation of cooperative resources subject to those potential operations. Because the required cooperative resources are described by the cooperative resource descriptor, and because the cooperative resource descriptor occupies the same index position of a TList of cooperative resources descriptors as does the panel occupy the same index position of a TList of interface container objects, by looking up the position of an object in one TList, the CPO 30 may automatically identify and process the corresponding object of the other TList. Thus for the CPO 30 to respond to entry of the panel by preparing the required cooperative resources, the CPO 30 may locate the corresponding cooperative resource descriptor object by finding the interface container's index position in a list of associated interface container objects, and by assigning the corresponding element of the cooperative resource descriptor list to the focus of CPO operations.

In the cooperative resource descriptors, cooperative data resources are preferably described in groups or in such an order so as for instance, if table opening and closure order is sensitive, tables which should be opened first or closed last are processed in desirable order. Cooperative resource descriptors describe related resources therefore by an organization which, as processed by the CPO 30, performs operations on the resources in the desirable manner.

For the purposes of this alternative embodiment, cooperative resource descriptors also are endowed with a property suitable for assignment of the OnEnter event a developer might, for other purposes intended by the developer, assign to the interface container object in engineering the application. By assigning the OnEnter event of the interface container object created by the developer, if any, to the cooperative resource descriptor object related to the interface container object, the CPO 30 may properly perform any processes intended by the developer to be further associated with the OnEnter event of the interface container object, with this response to the OnEnter event of the interface container object however being actually conducted to a universal OnEnter handler endowed to the CPO 30 itself.

In FIG. 20, a first phase of the initialization algorithm populates the parallel TLists 2001, one TList being of cooperative resources descriptors (CRD), and the corresponding TList being of associated interface container objects (AICO). In order that developers may troubleshoot errors they may make in indicating associations of cooperative resource descriptors and associated interface container objects, a suitable method for populating the parallel TLists is to use function or procedure calls to populate the TLists, with each function or procedure call processing arguments comprised of the identities of a cooperative resource descriptor and associated interface container object. In FIG. 20, such function calls, one per cooperative resource descriptor with an associated graphic interface, populate parallel lists with the identities of cooperative resource descriptors and the associated container object of the interface to the cooperative resources. Each call to such a function results in the cooperative resource descriptor being assigned to the same index position of the CRD TList as is the associated interface container object assigned to that index position of the AICO TList. The CPO 30 can now identify and process an object of one list corresponding to an object of the other list.

In FIG. 20, an optional step in the process is for instance to validate that multiple listings of interface container objects are not made; and that only valid classes of container objects or resource descriptors are assigned to their respective lists (step 2004). Any errors detected in the validation process 2004 raise an error, present a dialog identifying the error, and exit to the development environment so the developer may rectify their error (step 2005). The validation process may alternatively be performed in processing the function calls which populate the TLists.

The CPO 30 then iterates the TList of associated interface container objects, taking any OnEnter events assigned to the interface container object and assigning those OnEnter events to the associated cooperative resource descriptor's OnEnter property, and assigning the OnEnter event of each interface container to the universal OnEnter handler of the CPO 30 (step 2010.) During operation of the application, the universal OnEnter handler of the CPO 30, thus triggered by the OnEnter event of each such interface container object, looks up the index position of the triggering interface container object in the TList of associated interface container objects, to assign to the CPO 30 the corresponding cooperative resource descriptor 80A, 80B, which then indicates the focus of CPO operations on cooperative resources. Thereupon, the CPO 30 prepares for processing the resources described by the cooperative resource descriptor 80A, 80B, for instance, by opening necessary tables in a necessary order. Thereafter, the CPO 30 performs the OnEnter handler formerly assigned to the interface container object by the developer, if any, by reading the handler of that OnEnter event from the cooperative resource descriptor 80A, 80B. The CPO 30 thus will automatically prepare, focus, and manage resources related to the interface whenever an operator or code triggers the OnEnter event of the interface container. This step of assigning OnEnter events belonging to interface container objects to an OnEnter event property of the corresponding CRD 80A, 80B may alternatively be performed incrementally, in response to the function populating the parallel lists.

The CPO 30 now assigns the last registered cooperative resource descriptor 80A, 80B to the focus of its operations, as such focus was concurrently retained from any previous application session. As the same function calls, populating the parallel lists, always determine the same index order, by concurrently registering the index position of the focused CRD 80A, 80B as an application's interfaces are navigated, at initialization the CPO 30 can re-focus on a terminated session's CRD 80A, 80B by reading a concurrently registered focus expression comprised of an integer indicating the index position of the AICO or CRD 80A, 80B. Thus at initialization, preparation of cooperative resources can be accomplished for instance by triggering the OnEnter event of the cooperative resource descriptor identified by the concurrently registered focus expression, which automatically triggers operations of the CPO 30 OnEnter handler, including preparation of cooperative resources, (step 2020). This prepares cooperative resources related to the interface previously focused in the preceding worksession.

Groups of interfaces can be nested for instance, by placing a tabbed page control within a page of another tabbed page control. Thus by concurrently registering the focused interface container of each group of interface containers in which only one interface container can be focused at once, an entire nested interface can be restored. Therefore a further object of the alternative embodiment is concurrent registration of focused interfaces. By organizing interfaces into such groups, and by concurrently registering the focused member of each group, thus restoring the active member of each group at initialization therefore restores, from however deeply nested a system, the active interface of the application as at termination of the previous worksession (step 2030). In effect, the overall active interface simply bubbles to the top. Alternatively, a single active interface can be registered and restored from a system of available interfaces, where interface containers are not nested.

The initialization process may furthermore resume processes active at termination of the previous session. Processes are readily designed to be resumed from any given phase of completion by starting at an indicated phase, evident in concurrently registered processing data, or evident in a concurrently registered expression of the phase, or evident in both. Initialization of such a process not registered to be active causes the process to start from its beginning. Initialization of such a process registered to be active causes the process to resume processing its uncompleted phase.

FIG. 20 Conclusions, Ramifications

While methods, order, or steps are alternative, the illustrated algorithm restores an application and ongoing processing, even despite inadvertent termination of the previous operating session.

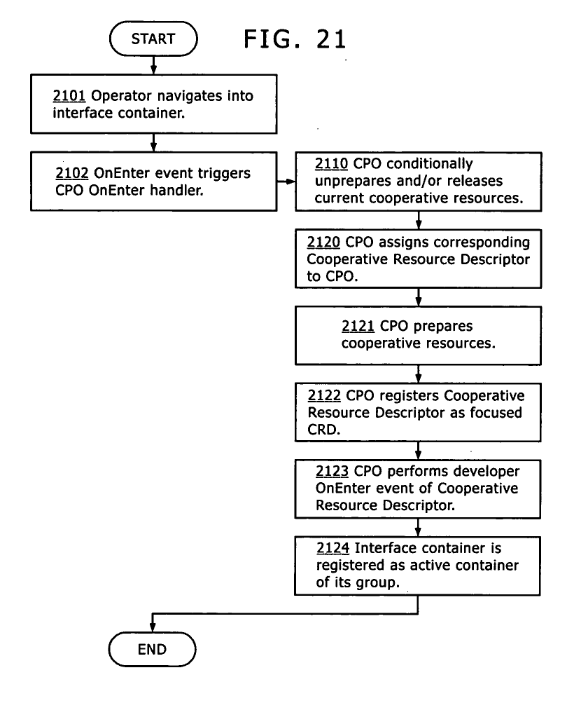

### FIG. 21—Flow Diagram of an Alternative Embodiment in Which a CPO Automatically Manages Cooperative Resources, and Resumable Application Focus and Processing Status are Concurrently Registered

FIG. 21 Objects

In conjunction with an initialization process such as is illustrated in FIG. 20, in FIG. 21, objects of an alternative embodiment of the present invention are that, as an operator navigates an application, a CPO 30 automatically manages the application's data resources with a minimum of active, connective resources; and that the CPO 30 concurrently registers the status of operations and navigation of the application, so that at initialization of the application, its previous status is automatically resumed. FIG. 21 illustrates concurrent retention of focus, and concurrent retention of processing phase status.

FIG. 21 Operation

In the environment described with FIG. 20, in FIG. 21, operator navigation of an application into an interface container managing the application's processing of data (step 2101), triggers the universal OnEnter handler of the CPO (step 2102), which universal OnEnter handler may conditionally, optionally close and may conditionally, optionally free resources related to a previous focused interface (step 2110), before assigning the cooperative resource descriptor indicated by the index position of the entered interface to the focus of CPO operations (step 2120), and, if necessary, preparing the cooperative resources related to the newly focused interface for processing (step 2121).

Having focused on the related cooperative resources, the CPO 30 registers an integer indicating the index position of the currently focused CRD 80A, 80B or AICO to retentive media (step 2122), which concurrent registration process provides for restoring the focus of the CRD 80A, 80B and AICO at initialization within the algorithm illustrated in FIG. 20. Alternatively, in FIG. 21, concurrent registration of the index position of the CRD 80A, 80B or AICO to retentive media may be performed as early in this sequence as an immediate response to the initial OnEnter event, triggered by entry into the interface container.

In FIG. 21, next the CPO 30 performs any OnEnter event intended by the developer, by invoking that event from the CRD (step 2123). The active interface container identifier is registered to its governing group, (step 2124), that initialization processes can restore active interfaces, however deeply nested.

Alternatively, when resumable processes are initiated, data indicating the activity of the process may be concurrently registered to retentive media, indicating phase in concurrently registered processing data, in a concurrently registered expression of the phase, or in both.

FIG. 21 Conclusions, Ramifications

While order and steps are alternative, cooperative resources are automatically managed according to demand. Application focus and processing status are concurrently registered, providing for automatic resumption at initialization. Applications can start faster, engaging only needed resources at initialization. Applications can automatically operate on minimal data resources necessary to momentary focus.

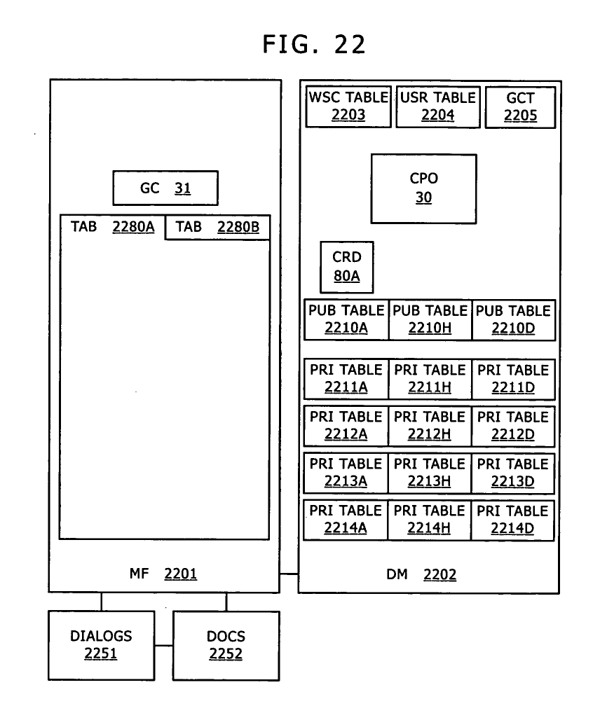

### FIG. 22—Cooperative Client-server or Desktop Application Development Template

FIG. 22 Elements, Objects

A principal object of a cooperative client-server or desktop application development template is to expedite development of cooperative client-server or desktop applications, particularly by finishing, as much as possible, generic respects of the cooperative client-server or desktop applications which can be built from such a template, integrated with functionalities described in this specification.

In FIG. 22, a cooperative client-server or desktop application development template comprises a collection of documentation 2252, and an application having a main form 2201, a data module 2202, and a collection of dialogs 2251.

In keeping with modern Object Pascal, a main form 2201 is a window object often performing initialization and shutdown functions of a substantially event driven, graphically interfaced application. The data module 2202 is a non-visual owner object, visually represented at design time, to which may be added non-visual owned objects such as may interface the application with further public and private work area data resources, as illustrated in FIGS. 22 and 2. In FIG. 22, objects illustrated in the data module 2202 provide a capacity to process the data organizations of FIG. 2.

In FIG. 22, necessary initialization processes are performed in a main form 2201 OnShow event, which is characteristically processed before the main form 2201 is displayed. Initialization processes are performed once only in the OnShow event handler by testing a variable indicating whether the initialization processes have been performed.

Initialization processes performed or optionally performed include determination of the application directory and its subdirectories containing private work area data resources; interpretation and resumption of a concurrently registered connection mode which indicates whether the application was connected to data it can or can not modify; handling of registration issues such as attempted piracy, attempted tampering with anti-piracy measures, expiring trial-ware lifespan, and providing for registration; password access; restoration of connections to data resources comprehensive of connection mode; and running developer routines, including appropriation of application privileges comprehensive of user authority.

Shutdown processes are triggered by a main form 2201 OnClose event, which performs a FormClose method when the application is terminated. The FormClose method relies on the CPO to perform shutdown processes which include posting, closing, and freeing of data resources. Developer FormClose processes may be performed either before or after CPO shutdown processes.

In the collection of dialogs 2251, separate dialogs exist as separate forms, which are parent window objects owning the further child objects populating them. The collection of dialogs 2251 includes an ABOUT dialog which displays information about the installation and provides to connect to the development house over the Internet; an ADD RECORD dialog which displays data-aware controls to the unique, identifying fields of a focused public table, and which implements general methods adding a record to the table as identified by user input in the dialog; a BROWSE FOR DIRECTORY dialog which provides a capacity to manually select and a directory path and to provide the selected path to any process; a CALENDAR dialog, providing to any process, from a calendar object, a manually selected date; a ConnectToData dialog, providing a capacity to manually select and focus the location of the application's public data and private work areas related to that public data; a DATE-TIME dialog, providing to any process, selection of date and time from a visual date-time object; a FIND dialog, providing bi-directional incremental searching from the beginning of a table toward the end of the table (find first), from the end of a table toward the beginning of the table (find last), from the current record to a succeeding record matching the search criteria (find next), or from the current record to a preceding record matching the search criteria (find preceding); a QUICK FIND dialog, providing, character by character, incremental nearest matching of sought records as the operator types record identifying information; an OK dialog, providing for any process to display system messages to which an operator may respond with an OK button; an OK-CANCEL dialog, providing for any process to display system messages to which an operator may respond with an OK button or a CANCEL button; a PASSWORD dialog, providing password input to processes of the application; a PASSWORD LOOKUP dialog, providing password input for a selected user of the application; a PROGRESS INDICATOR WITH OPTIONAL CANCEL PROCESS dialog, providing visual progress indication with optional cancellation of the process; a REGISTRATION dialog, handling pre-built registration functions; and a YES-NO dialog, providing for any process to display system messages to which an operator may respond with a YES button or a NO button. System message dialogs feature tools to e-mail system messages to system administrators, to save the message, or to register optionally logged messages to a pre-built and integrated message log. Pre-built dialogs invoke HELP documentation specific to the processes of the dialog.

Further configuration interfaces are built into tabsheets of a configuration page control. These interfaces provide for monitoring network connection integrity; for setting a polling interval for monitoring network connection integrity; for setting the focused public data directory by way of the ConnectToData dialog; for displaying and connecting processes to a selected directory by way of the BROWSE FOR DIRECTORY dialog; for displaying and setting the name of the HELP subdirectory, and for indicating whether the HELP subdirectory belongs to the focused public data directory or to the application directory; for displaying and setting e-mail addresses for network-wide support, for workstation-specific support, and for displaying and modifying workstation specific subjects and introductory content for system messages mailed from dialogs to support administrators; for disabling or enabling automatic expansion of interface panels; for setting page control tab style and location; for setting main form 2201 window size, location, and startup configuration; for requiring user-specific password access; for managing users and user privileges; and for configuration of CPO behavior including number of re-tries and interval of retries before timing out when attempting to secure write privileges. Pre-built configuration interfaces invoke HELP documentation specific to the processes of the interface.

With the collection of documentation 2252 integrated with the application, developers do not need to write documentation for a diversity of pre-built, functional template capacities. Style of the collection of documentation 2252 may be globally modified by revision of a cascading style sheet, and further modifications can be created or integrated as may or may not be required.

Further dialogs may be added by developers, including specialized search dialogs or add record dialogs which may alternatively be invoked from given individual controls of a collection of graphic controls 31 altogether. Such alternative dialogs are invoked automatically, wherever the developer assigns an alternative developer method to a corresponding, alternative developer method property for the given control, of a cooperative resource descriptor dedicated to the public table such as 80A, indicating a focused public table, 2210A, which public table and its related cooperative resources therefore will be the object of the applied method.

Given data resources are initially distributed to subdirectories of the file directory to which the application belongs.

At creation of the application from the template, or at installation of the application, three public data subdirectories and three corresponding private work area subdirectories exist. A DATA subdirectory of the application directory contains a public table 2210A, which will be the usual focus of actual processing supporting the operations of an enterprise.

Regular public enterprise tables of the application may ultimately be organized in a single public directory. Installations of the application provide dialogs to focus applications on the ultimate public directory by indicating the location of the collection of public tables. A cooperative resource descriptor 80A describing the filename of the public table 2210A then suffices to connect the application with its data by building a pathname inclusive of the public table filename. When a network installation of the application is performed, the original public tables of one local DATA directory are usually copied to a server-resident DATA directory, and each application of the network is then focused on this server-resident DATA directory to enable cooperative operation on the public data by a system of applications of the present invention.

As a result of backup processes, further historical archived copies of each public table 2210A may exist as a backup state table 2210H . A backup must generally comprise a complete set of the public tables if data integrity is to be maintained whenever a backup is to be restored to service in the event the integrity of the usual public enterprise tables altogether, becomes faulted. Backups may be performed regularly, during regular operations, by ORCHESTRATED, STATUS-COMPREHENSIVE, MOMENTARY BACKUP. The public tables of each ORCHESTRATED, STATUS-COMPREHENSIVE, MOMENTARY BACKUP may be stored to a subdirectory of a public BACKUP directory, with the subdirectory name distinguishing each particular backup, and the files contained therein identified by the same nomenclature as the regular enterprise tables 2210A.

By virtue of a ConnectToData dialog with the power to ascertain a destination directory and concurrently register successful connections to corresponding fields of a workstation configuration table 2203 indicating the subject public data directory (DATA), backup data directory (NoEditDATA), or demonstration data directory (DemoDATA), from the moment it is created, an application created from the development template has the capacity to connect to the set of data, and, in the case of backup data, with, or usually without, the power to edit the backup data. Unsuccessful attempts to connect to data are reverted to the last successful connection of the given connection mode. Concurrent registration by the CPO enables automatic resumption of the connection mode and focused tables at application startup. A separate private work area exists in relation to backup data, so as application focus in regard to backup data is maintained without affecting the status and obligations of the regular private work area associated with operations on enterprise data.

Further demonstration copies of each public table 2210A may exist as a demonstration data table 2210D. Demonstration tables may be used for training or trial processing, and may reside either in a local directory or in a public directory. By virtue of a ConnectToData dialog with the power to ascertain a destination directory and assign that directory to a concurrently retained application status variable indicating the subject demonstration data directory, from the moment it is created, an application created from the development template has the capacity to connect to the set of public data in any demonstration subdirectory, with, or usually without, the power to edit the backup data. A separate private work area exists in relation to demonstration data, so as application focus in regard to demonstration data is maintained without affecting the status and obligations of the regular private work area associated with operations on enterprise data.

A LOCAL subdirectory of the application directory contains private tables comprising the necessary private work area. The private work area for regular operations on the enterprise data of table 2210A is indicated in terms of the local table names by cooperative resource descriptor 80A. Therefore the application can connect to its private work area for its enterprise data by building pathnames to the LOCAL directory inclusive of the targeted private work area tables, by determining the application directory, adding the LOCAL directory name, and adding the target filenames to this application and local directory path string.

Whereas for instance, the architecture illustrated in FIG. 2 requires 4 private tables to comprise a private work area in relation to a public table, a private table 2211A, 2212A, 2213A, and 2214A may reside in a LOCAL subdirectory of the application directory, and represent the private work area in respect to regular public enterprise table 2210A. A private table 2211H, 2212H, 2213H, and 2214H may reside in a NoEditLOCAL subdirectory of the application directory, and represent the private work area in respect to historical backup table 2210H. A private table 2211D, 2212D, 2213D, and 2214D may reside in a DemoLOCAL subdirectory of the application directory, and represent the private work area in respect to demonstration table 2210D. Paths to the NoEditLOCAL and DemoLOCAL subdirectories are built likewise by the cooperative resource descriptor 80A, and therefore the application can disconnect from one and connect to any other genre of data, from the moment the application is created. Alternatively, the private work areas related historical backup tables and demonstration tables such as 2210H, or 2210D can belong to the same private work area tables 2211A, 2212A, 2213A, and 2214A of regular public enterprise table 2210A, with additional records of the private work area table distinguished by fields associating the necessary records with the focused historical or demonstration table.

When applications generated from the development template engage public data of the given kind as indicated by a connection mode value, the corresponding private work area subdirectory is automatically assigned to the private work area resources utilized in conjunction with DATA, DemoDATA, or NoEditDATA public data resources. Thus a single set of data-interfacing objects in the data module 2202 may be used interchangeably, to connect to public data residing anywhere, of any such kind, and to appropriately inherit or not inherit powers to modify the public data.

A users table 2204 is contained in the public Data directory, and may contain usernames, user passwords, and user-specific configuration data in fields of each user record. A global configuration table 2205 is contained in the DATA directory, and may contain global configuration data for a network of such applications as a whole. Further public tables may contain data and flags to instruct applications to perform operations such as ORCHESTRATED, STATUS-COMPREHENSIVE, MOMENTARY BACKUPs.

The main form 2201 includes a tabbed page control which includes a tabsheet 2280A containing the interfaces related to public table 2210A, to which tabbed page control may be added further tabsheets such as tabsheet 2280B, for containing interfaces related to further public tables. Further tabsheets and page controls may be added to the application, particularly to provide graphic interfaces to data resources related to further public tables. “Page control” and “tabsheet” (a page of the page control, accessed by a tab) are terminology of modern Object Pascal.

Page controls and tabsheets existing in the template are processed by “AUTOMATIC ASSIGNMENT OF RESOURCE DESCRIPTORS TO THE CPO” as previously described in this specification. To integrate further page controls or tabsheets to “AUTOMATIC ASSIGNMENT OF RESOURCE DESCRIPTORS TO THE CPO,” the developer makes a single function call per each additional interface container associated with a cooperative resource descriptor together with such function calls as already exist in the template's data module 2202, in a single method populating the parallel lists before the CPO 30 will need to rely on registration of any member of either list. “SUBSEQUENT SESSION RESUMPTION WITH INTERFACES AND COOPERATIVE FOCUS INTACT” is likewise built into the template as previously described in this specification.

The data module 2202 includes a workstation configuration table 2203, a users table 2204, a global configuration table 2205, a CPO 30, and a cooperative resource descriptor 80A describing cooperative resources including a public table 2210A.

Objects described broadly here as “tables” are components interfacing the application with actual tables, as such objects represent an actual table to the application. According to properties of the component indicating an actual table, the component described as public table 2210A for instance may be used to interface the application to a public table of a given design and structure, an instance of which may be located in a DATA directory, a DemoDATA directory, or a NoEditDATA directory anywhere. By the ConnectToData dialog, the application will connect to the actual public table represented by the component, which actual table must exist in the targeted directory. System messages are generated by the CPO 30 as necessary, detailing unsuccessful connections in terms of full paths, involved component identities, reasons for unsuccessful connection, and appropriate remedial procedure.

Graphic controls 31 in the main form 2201 may act on the CPO 30.

An object of the illustrative cooperative client-server or desktop application development template of FIG. 22 is to provide an organization inherent to the illustrative embodiment of FIG. 2. Given elements of FIG. 22 therefore correspond to elements of FIG. 2.

In FIG. 22, public table 2210A, described by cooperative resource descriptor 80A, contains the focused public data instance 10A of FIG. 2. Private tables 2211A, 2211H, and 2211D contain the comparison-distribution instance 18A of FIG. 2. Private tables 2212A, 2212H, and 2212D contain the comparison-distribution instance 20A of FIG. 2. Private tables 2213A, 2213H, and 2213D contain the original state 22A, the undo state 23A, the re-do state 24A, and the auxiliary state 25A of FIG. 2. Private tables 2214A, 2214H, and 2214D contain the private work state 21A of FIG. 2.

In alternative implementations of “relational registration of status” as accommodated in FIG. 22, multiple instances of each private state may exist, with the focused instances being associated for instance with the current user, by matching relational indicia in the records of the private work area. Where more than one relational status record may exist in a given table for a given user, each such record may be identified by further indicia, such as an integer field indicating the unique states of the record set. Thus, the CPO 30 focuses on intended private work areas of either relational or non-relational status, for the given connection modes, by the processes described in this specification.

FIG. 22 Development, Testing, Documentation, and Final Preparation of Distributables

Further development of a cooperative client-server or desktop project principally consists of building conventional graphic interfaces for processing data, and of connecting the conventional graphic interfaces to a private work area defined by cooperative resource descriptors of the public data resource and its respective private work area. Additional operations may be integrated as necessary. Public write operations optionally taking advantage of CPO 30 capacities such as “extended, direct, cooperative write-related operations” render thoroughly. cooperative behavior across the application.

Testing issues for a cooperative client-server or desktop project are substantially reduced to ensuring cooperative resources are properly described, as the universal methods of the CPO 30 are extended symmetrically to any cooperative resources. Largely, testing may focus on a fewer unique issues intrinsic to processes not originally belonging to the template. Likewise, further documentation is only required for the fewer unique issues intrinsic to processes not originally belonging to the template.

Final preparation of distributables and development cycle testing of registration-status-related operations is automated by methods which reset the application and its resources to a registered installation; to a new installation; to a full trial lifespan; to a partial trial lifespan; to an expired trial lifespan; and to a trial lifespan subverted by attempted tampering with anti-piracy protection.

To reset the application to a distributable state, developers may for instance run the reset-to-new-installation function from a development menu in the running application. This function, built into the template, causes the CPO 30 to re-initialize all resources related to its operations. Developers may add further functions to this method necessary to re-initializing other data or conditions, which functions for instance may empty given tables to prepare the application for distribution. By clicking the reset-to-new-installation function in the temporary menu at run-time, resources are flawlessly, instantly reset to proper condition. The developer may then close the application, toggle the visible property of the development menu to false, re-compile the application, and re-build the installation application to render a finished distributable in as little as seconds.

FIG. 22 Operation

From the moment it is created, a project generated from the development template, in its corresponding executable, is fully functional in the described respects. The first time the executable is run on a system, it detects if it has been on the system, signs the system if it has not been on the system, and determines remaining trialware lifespan or registered status. CPO 30 properties regulate these functions, and give an application, or a series of releases of an application, a unique signature, including replicated expressions of remaining lifespan and registration authorization keys.

The CPO 30 will automatically manage data resources, including necessary population of tables, comprehensive of user and state instance identities of private work areas. On shutdown, data resources are automatically closed and freed.

During operation, the CPO 30 automatically performs necessary population of public and private tables, concurrent registration of states, “AUTOMATIC ASSIGNMENT OF RESOURCE DESCRIPTORS TO THE CPO,” and “SUBSEQUENT SESSION RESUMPTION WITH INTERFACES AND COOPERATIVE FOCUS INTACT.” Resumable processes are resumed at initialization or otherwise, by processes previously described. By re-invoking data connection and disconnection routines against the resources subject to these routines, the CPO 30 of the application can automatically restore connections to server-resident data after lost network connectivity or other problems, and can disconnect from current public data resources, and connect to other data resources, in any connection mode.

To set up a network installation, the DATA directory may be copied to intended resources. Network installation is completed thereupon by connecting to the copied instance of the DATA directory with the ConnectToData dialog.

FIG. 22 Template Deployment

Cooperative client-server or desktop application development projects are created from a utility which copies the source template, its resources, and directory structure to a development directory, producing from its beginning, an application fully functional in the described respects.

FIG. 22 Conclusions, Ramifications

A cooperative client-server or desktop application capable of extending its cooperative processing capacities to many public data resources may be created almost instantly, and may be extended to process further public data resources with very little effort.

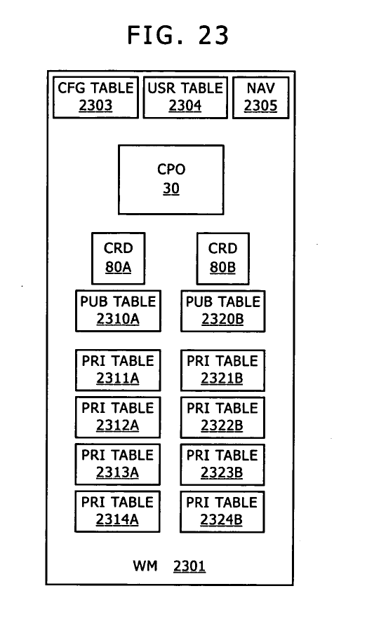

### FIG. 23—Cooperative Server-side Application Development Template

FIG. 23 Elements, Objects

A principal object of a cooperative server-side application development template is to expedite development of cooperative server-side applications, particularly by finishing, as much as possible, generic respects of the cooperative server-side applications which can be built from such a template, integrated with functionalities described in this specification.

In FIG. 23, a cooperative server-side application development template comprises a web module 2301, which is an object capable of spawning separate instances of itself to independently perform the purposes of the spawned instance. The general purpose of a web module 2301 is to return results to individual requests for formatted web content, often dictated by tables of data. (“Web module” is a term of modern Object Pascal.”)

The web module 2301 of the cooperative server-side application development template illustrated in FIG. 23 includes a configuration table 2303, an optional users table 2304, an optional navigation log 2305, a CPO 30, a cooperative resource descriptor 80A describing cooperative resources including a public table 2310A, a private table 2311A, a private table 2312A, a private table 2313A and a private table 2314A, and a cooperative resource descriptor 80B describing cooperative resources including a public table 2320B, a private table 2321B, a private table 2322B, a private table 2323B and a private table 2324B.

An object of the illustrative cooperative server-side application-development template of FIG. 23 is to provide an organization inherent to the illustrative embodiment of FIG. 18. It is also possible in FIG. 23 to provide the organization inherent to FIG. 17. The server-side application generated from the cooperative server-side application development template of FIG. 23 corresponds to the server-side application 11S of FIG. 18, with the CPO 30 belonging to the application instance contained in the web module 2301 of FIG. 23.

In FIG. 23, public table 2310A, described by cooperative resource descriptor 80A, contains the focused public data instance 10A of FIG. 18. Private table 2311A contains the comparison-distribution instance 18A of FIG. 18. Private table 2312A contains the comparison-distribution instance 20A of FIG. 18. Private table 2313A contains the remotely mirrored instance of a work state 41A, the original state 23A, the undo state 23A, the re-do state 24A, and the remotely mirrored instance of an auxiliary state 45A of FIG. 18. Private table 2314A contains the private work state 21A and the auxiliary state 25A of FIG. 18.

In FIG. 23, public table 2320B, described by cooperative resource descriptor 80B, contains the focused public data instance 10B of FIG. 18. Private table 2321B contains the comparison-distribution instance 18B of FIG. 18. Private table 2322B contains the comparison-distribution instance 20B of FIG. 18. Private table 2323B contains the remotely mirrored instance of a work state 41B, the original state 23B, the undo state 23B, the re-do state 24B, and the remotely mirrored instance of an auxiliary state 45B of FIG. 18. Private table 2324B contains the private work state 21B and the auxiliary state 25B of FIG. 18.

FIG. 23 Operation

From the moment it is created, a project generated from the development template, in its corresponding executable, is fully functional in the described respects. A usual object of such an application is to generate XHTML content in response to requests sent to a Web server on which the server-side application resides.

Typically, a server-side application as illustrated in FIG. 23 spawns a new instance of the web module 2301 to handle each request for content, in which content may be embedded markup providing capacities to further interact with server-resident systems, and which distributed content may comprise a thin client application 11T as in FIG. 18, in which data may be processed in graphic controls, and may be managed by the CPO 30 of the spawned web module 2301 instance as states of data are passed back and forth in subsequent requests.

The spawned web module 2301 instance may initialize itself by reading configuration data from the configuration table 2303, which it may share and cooperatively process with other applications. Configuration data may for instance regulate the intervals and numbers of re-tries executed by the CPO 30 of the spawned web module 2301 instances, which configuration data might be regulated according to processing demands, by an exterior, cooperative, administrative application as might be built from a cooperative client-server or desktop application development template as illustrated in FIG. 22. Further initialization functions may open the optional users table 2304 or the optional navigation log 2305 as necessary.

The CPO 30 may process records of public table 2310A with a private work area described by cooperative resource descriptor 80A, or records of public table 2320B with a private work area described by cooperative resource descriptor 80B. “RELATIONAL REGISTRATION OF STATUS” may be implemented.

The spawned web module 23 may implement “RESTORATION OF REMOTE CLIENT NAVIGATIONAL STATUS BY CLIENT INSTANCE-AND-PROCESS-IDENTIFYING UNIFORM RESOURCE INDICATORS (URI),” “RESTORATION OF REMOTE CLIENT NAVIGATIONAL STATUS FROM CONCURRENTLY REGISTERED NAVIGATION LOGGING BY UNIFORM RESOURCE INDICATORS (URI),” “CONCURRENTLY RETENTIVE NAVIGATION BY REGISTERED NAVIGATION LOGGING,” and “ABSOLUTELY SECURE CLIENT FUNCTIONALITY.”

FIG. 23 Template Deployment

Cooperative server-side application development projects are created from a utility which copies the source template, its resources, and directory structure to a development directory, producing from its beginning, an application fully functional in the described respects.

FIG. 23 Conclusions, Ramifications

A server-side application capable of extending its cooperative processing capacities to many public data resources may be created almost instantly, and may be extended to process further public data resources with very little effort.

Populated web modules such as illustrated in FIG. 23 may be integrated with cooperative client-server or desktop applications such as created from the template illustrated in FIG. 22, to render visual server-side applications with the further advantage of graphic interfaces providing administrative functionality.

Scope

The described embodiments are illustrative, and should not be considered restrictive in any way. For example, the variously illustrated embodiments have been described in terms of software running on and/or utilizing dedicated hardware resources. However, in some embodiments any number of these aspects could actually be emulated. For example, any of the following operations could actually be emulated in non-retentive media, with or without subsequent registration of vital data to retentive media:

“COOPERATIVE, SIMULTANEOUS PROCESSING OF PUBLIC DATA”

“RESUMABLE, COOPERATIVE, SIMULTANEOUS PROCESSING OF PUBLIC DATA”

“CONCURRENTLY RETAINED DISTRIBUTION TO THE PRIVATE WORK AREA”

“CONCURRENTLY RETAINED TENTATIVE ACCEPT PROCESSES”

“CONCURRENTLY RETAINED RE-DO PROCESSES”

“CONCURRENTLY RETAINED UNDO PROCESSES”

“CONCURRENTLY RETAINED RESTORE TO ORIGINAL STATUS PROCESSES”

“CONCURRENTLY RETAINED ZERO THROUGHPUT CANCEL PROCESSES”

“CONCURRENTLY RETAINED CANCEL TO CURRENT STATE PROCESSES”

“CONCURRENTLY RETAINED REFRESH FROM PUBLIC STATUS PROCESSES”

“UNINTERRUPTED PROCESSING CONCURRENT WITH PERFORMANCE OF CONCURRENTLY RETAINED REFRESH FROM PUBLIC STATUS PROCESSES”

“CONCURRENTLY RETAINED AUXILIARY STATES”

“CONCURRENTLY RETAINED AUXILIARY STATE PROCESSES”

To facilitate the discussion, both in the description as well as in the claims, references to these and other aspects are intended to include both non-emulated and emulated embodiments. Thus, the scope of the invention is given by the appended claims, and all variations and equivalents which fall within the range of the claims, are intended to be embraced therein.

Ramifications

In conventional systems, no method exists, accounting for contention and process failure in as much as every instance of writing to public data, and comprising an environment in which cooperative, simultaneous processing of data by many processes is generally endowed to the processes of the system. Nor are universally resumable application processes an inherent consequence of processing concurrently registered status, the states of which, in turn provide for simultaneous operation on public data.

Particularly as the objects of cooperative, simultaneous operation on data by many processes and reliable, resumed processing with minimal consumption of inter-nodal throughput are plausibly universal goals into the foreseeable future, embodiments of the present invention may serve as a foundation of application development into the indefinite future. From the moment projects embodying the invention are created, applications are immune to a huge scope of issues confronting conventional applications, at a huge savings in development, support, administrative, and end user costs. Embodiments of the present invention mean we can simply turn a computer “off,” and when we turn it back “on” again, all processes, however complex, will resume as we last left them. Every operator on a network can operate on the same record at the same time. By embodiments of the present invention, the obligations of applications are performed regardless of a truly huge scope of otherwise obstructive or catastrophic events.

The invention has been described with reference to particular embodiments. However, it will be readily apparent to those skilled in the art that it is possible to embody the invention in specific forms other than those of the preferred embodiment described above. This may be done without departing from the spirit of the invention.

For example, an exemplary embodiment of a cooperative client-server or desktop application development template has been disclosed with reference to FIG. 22, and an exemplary embodiment of a cooperative server-side application development template has been disclosed with reference to FIG. 23. However, the various inventive aspects illustrated by these examples can be more generally described as follows:

For instance, there are visual implementations of the technology and there are non-visual implementations of the technology. The templates provide a means for embedding the technology into any present and future abstractions of an application, which allow the developer to use the technology without tying any loose ends together.

The principal examples described herein build around an abstraction of a visual application—an application with graphic interfaces. In the exemplary embodiments, the abstraction comprises the Borland® base classes of a TForm (main graphic interface for a visual application); and a TDataModule (largely a container object for the objects which connect the application to its usually public tables—but in this case, which further connects the application to private tables comprising the private work areas of the above-described technology). The dialogs are generally built on further instances of the TForm class. To integrate the cooperative technology, any combination of a number of things can be done, including: 1) subclassing the TForm and TDataModule classes (in which case, embedded into the very derived subclass objects themselves is code driving the presently-described technology and related to the architecture of the presently-described technology); 2) populating the objects of the original or subclassed abstractions with distinctive objects deploying the presently-described technology (most of the code of the technology as embedded in this kind of implementation exists in a CPO 30 object in the DataModule; cooperative resource descriptor objects as 80A, 80B located in the DataModule represent the tables of the private work area and further resources so as the processes of the CPO 30 can be applied to any public table and its respective private work area; and, as in our description of graphic controls 31 acting on the CPO 30, a graphic control object 31 acting on the CPO 30, or multiple graphic control objects 31 acting on the CPO 30, serve to invoke functionality generally endowed to the CPO 30 and focused on a given public table and its respective private work area by virtue of the identity of the graphic control object 31 acting on the CPO 30 being a property of the cooperative resource descriptor object 80A, 80B, and the cooperative resource descriptor object 80A or 80B being the focus of CPO 30 operations); and 3) adding exposed code to the original abstractions which relieves the developer of putting together the kinds of structures necessary to deploy the technology, and which provides further means and apparatus for the developer to integrate further functionality with any phase of operations so exposed to the developer.

Largely, what is created therefore is a further application abstraction, further embellished with the embedded technology, which may even be made to be fully working from the first click which creates a development project. The technology is documented, for instance, in XHTML, and the dialogs and interfaces of the embellished abstraction invoke the documentation from the moment the development project is created. Startup code initializes and activates the technology; a graphic control object 31 acting on the CPO 30 or multiple graphic control objects 31 acting on the CPO 30 provide graphic interfaces to manually invoke the technology; and, to wield the technology, developer responsibilities therefore are reduced to little more than adding public tables; adding cooperative resource descriptor objects 80A, 80B; adding tables comprising the private work area; adding interfaces to the private work area; and adding unique processes, to which the cooperative behavior of the invention may be extended. From the moment the project is begun, the CPO 30 deploys the technology toward the public tables and private work areas of an application by way of the graphic control object or objects 31 acting on the CPO(s) 30 (more can be added) and the cooperative resource descriptor objects, 80A, 80B indicating the focus of processes.

A further non-visual implementation of the technology however would lack many of these elements, but drive a data-driven web presence. The graphic interfaces of such an “application” are created dynamically, and the abstraction is comprised similarly by an embellishment of a Borland® TWebModule object.

Very many such implementations are possible, but what is done in each case is either creating an application abstraction, or building on existing application abstractions, to wed any useful implementation of the technology, and to relieve the developer of every possible engineering issue which the presently-described technology solves. To the advantage of the developer, that approach may be carried so far forward as to finish the abstraction in every respect which should be treated in a generic fashion. In other words, if an object of the application should be to document the technology to the end user and administrator, that finishing of the abstraction is married to the very prototype from which such a development project is begun.

In another aspect, the exemplary embodiments described herein utilize a mechanism for acquiring the exclusive privilege to write to public data whereby repeatable attempts to obtain the exclusive privilege are made until the exclusive privilege is acquired. The use of this mechanism is not essential to the invention, however. In alternative embodiments, for example, a mechanism can be employed whereby if a write privilege is denied, the request to write to the public data is logged or otherwise scheduled so that the write privilege will be allocated in due time, without the need for repeatable attempts to be made.

Thus, the preferred embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of cooperatively processing public data, comprising:
distributing the public data to private representative states;
without holding an exclusive privilege to write to the public data, generating private states of the public data by processing one or more private representative states of the public data; and
updating the public data by cooperatively posting data from the private representative states.

2. The method of claim 1, further comprising concurrently registering at least one of the one or more generated private states to retentive media.

3. The method of claim 2, wherein said processing of the one or more private representative states of the public data is oriented to a concurrently registered private state, whereby a startup procedure re-triggering any previously running process from a given phase of operation automatically resumes an active process or state, should it be terminated, however inadvertently.

4. The method of claim 2, wherein:
the one or more private representative states of the public data are stored in a table.

5. The method of claim 4, wherein private representative states of the public data are negotiated by means of any number of identifying fields, classifying states relevant to processing.

6. The method of claim 2, further comprising:
retaining one or more of the generated private states in retentive media associated with a remote system.

7. The method of claim 6, wherein retaining one or more of the generated private states in retentive media associated with the remote system is performed in response to detecting a write to remotely maintained state event.

8. The method of claim 2, further comprising causing one or more nodes of cooperative applications to register separate copies of one or more private representative states to retentive media in conjunction with registration of a separate copy of the public data to retentive media.

9. The method of claim 1, further comprising:
using one or more cooperative resource descriptors to negotiate cooperative resources related to public data,
wherein the one or more cooperative resource descriptors relate the cooperative resources to the public data.

10. The method of claim 9, further comprising:
using a common organization of data processing resources in relation to a public data resource; and
in response to identifying any one of the one or more cooperative resource descriptors to focusable processes, negotiating the data processing resources designated by the identified cooperative resource descriptor in accordance with the common organization.

11. The method of claim 10, further comprising:
interchangeably focusing processes operating on the organization of data processing resources; and
managing the availability of resources to processes so as to enable a given organization of data processing resources to be negotiated.

12. The method of claim 9, further comprising:
using a graphic control to invoke a process on a public or private data resource identified by a focused cooperative resource descriptor.

13. The method of claim 9, wherein an intended cooperative resource descriptor, or organization as indicated by a cooperative resource descriptor, is focused automatically in response to an event or condition devised to be unique and to coincide with demand for resources described by the resource descriptor or belonging to the organization.

14. The method of claim 13, further comprising:
concurrently registering to retentive media an identity of the focused cooperative resource descriptor in response to focusing the cooperative resource descriptor; and
after termination of the application, initiating a subsequent session of the application, including re-imposing conditions triggering re-focus of the cooperative resources associated by the cooperative resource descriptor;
whereby the subsequent session of the application is automatically restored with a cooperative focus of the application intact.

15. The method of claim 13, further comprising:
concurrently registering to retentive media an identity of a descriptor of interfaces associated with the organization of cooperative resources needed by the interfaces;
after termination of the application, initiating a subsequent session of the application, including re-imposing conditions triggering re-focus of the cooperative resources associated by the cooperative resource descriptor;
whereby the subsequent session of the application is automatically restored with a cooperative focus of the application intact.

16. The method of claim 1, wherein:
the private representative states include a private work state embodied in retentive media, that represents a present state of processing on the public data;
the private representative states include a private undo state embodied in retentive media, that represents an earlier state of processing on the public data; and
the method further comprises concurrently registering the private work state to the private undo state.

17. The method of claim 1, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes; and
the method further comprises concurrently registering the private re-do state to the private work state.

18. The method of claim 1, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes;
the private representative states include a private undo state embodied in retentive media, that represents an earlier state of processing on the public data; and
the method further comprises concurrently registering the private work state to the private re-do state, and thereafter concurrently registering the private undo state to the private work state.

19. The method of claim 1, wherein:
the private representative states include a private work state embodied in retentive media, that represents a present state of processing on the public data;
the private representative states include a private original state embodied in retentive media;
distributing the public data to the private work area includes distributing the public data to the private original state; and
the method further comprises concurrently registering the private original state to the private work state.

20. The method of claim 1, wherein:
the private representative states include a private work state embodied in retentive media, that represents a present state of processing on the public data;
the private representative states include a private original state embodied in retentive media;
the private representative states include one or more other representative states embodied in retentive media; and
the method further comprises assigning the private original state to the one or more other representative states and to the private work state,
wherein assigning the private original state to the other representative states comprises concurrently registering the private original state to the other representative states, and assigning the private original state to the private work state comprises concurrently registering the private original state to the private work state.

21. The method of claim 1, wherein:
the private representative states are embodied in retentive media; and
the method further comprises, after distributing the public data to the private representative states embodied in retentive media, again distributing the public data to the private representative states embodied in retentive media.

22. The method of claim 1, wherein:
the private representative states are embodied in retentive media; and
the method further comprises, after distributing the public data to the private representative states embodied in retentive media, distributing to the private representative states only those fields of the public data that correspond to unmodified fields of the private representative states.

23. The method of claim 22, wherein:
one or more of the private representative states embodied in retentive media include a private work state that represents a present state of processing on the public data; and
the method further comprises:
detecting that a field of the private work state is presently under processing, and in response thereto treating said field of the private work state as a modified field of the private representative states.

24. The method of claim 1, wherein:
the private representative states includes a private work state that represents a present state of processing on the public data;
the private representative states includes a private original state;
distributing the public data to the private representative states includes distributing the public data to the private original state; and
updating the public data by cooperatively posting data from the private representative states comprises comparing the private work state to the private original state and cooperatively posting to the public data only those fields of the private work state which differ from corresponding fields of the private original state.

25. The method of claim 24, wherein the private work state and the private original state are embodied in retentive media.

26. The method of claim 24, further comprising:
prior to updating the public data, updating the private original state to reflect data previously posted to the public data.

27. The method of claim 24, wherein cooperatively posting to the public data only those fields of the private work state that differ from corresponding fields of the private original state comprises:
repeatably attempting to obtain a privilege to write to the public data until the privilege is obtained;
writing differentiated fields of the private work state to the public data; and
thereupon releasing the privilege to write to the public data,
wherein a duration defined from a first moment when the privilege is obtained until a second moment when the privilege is released extends for no more than a sufficiently minimal duration.

28. The method of claim 27, wherein the method further comprises:
writing to the private original state, data written to the public data.

29. The method of claim 1, wherein:
one or more of the private representative states includes a private work state that represents a present state of processing on the public data;
one or more of the private representative states includes a private last posted state;
distributing the public data to the private representative states embodied in retentive media includes distributing the public data to the private last posted state; and
updating the public data by cooperatively posting data from the private representative states comprises comparing the private work state to the private last posted state, cooperatively posting to the public data only those fields of the private work state which differ from corresponding fields of the private last posted state, and thereupon assigning to the last posted state, fields posted to the public data.

30. The method of claim 29, wherein the private work state and the private last posted state are embodied in retentive media.

31. The method of claim 29, wherein cooperatively posting to the public data only those fields of the private work state that differ from corresponding fields of the private last posted state comprises:
repeatably attempting to obtain a privilege to write to the public data until the privilege is obtained;
writing differentiated fields of the private work state to the public data; and
thereupon releasing the privilege to write to the public data,
wherein a duration defined from a first moment when the privilege is obtained until a second moment when the privilege is released extends for no more than a sufficiently minimal duration.

32. The method of claim 31, wherein the method further comprises:
writing to the private last posted state, data written to the public data.

33. The method of claim 1, wherein cooperatively posting data from the private representative states comprises:
obtaining a privilege to write to the public data;
writing the data from the private representative states to the public data; and
thereupon releasing the privilege to write to the public data,
wherein a duration defined from a first moment when the privilege is obtained until a second moment when the privilege is released extends for no more than a sufficiently minimal duration.

34. The method of claim 33, wherein obtaining the privilege to write to the public data comprises:
repeatably attempting to obtain the privilege to write to the public data until the privilege is obtained.

35. The method of claim 33, further comprising delegating performance of obtaining the privilege to write to the public data to a cooperative processing object.

36. The method of claim 33, further comprising:
delegating, to a cooperative processing object, performance of obtaining the privilege to write to the public data, performance of writing the data from the private representative states to the public data, and performance of releasing the privilege to write to the public data; and
the cooperative processing object further delegating, to a delegated cooperative processing object, performance of obtaining the privilege to write to the public data, performance of writing the data from the private representative states to the public data, and performance of releasing the privilege to write to the public data.

37. The method of claim 36, further comprising:
detecting that performance of obtaining the privilege to write to the public data, performance of writing the data from the private representative states to the public data, and performance of releasing the privilege to write to the public data have been successfully delegated to the delegated cooperative processing object, and in response thereto, the cooperative processing object passing control to a subsequent phase of processing.

38. The method of claim 37, further comprising:
concurrently registering a phase identifier to retentive media so that a process iterating from the registered phase identifier resumes operation.

39. The method of claim 36, further comprising:
concurrently registering a phase identifier to retentive media so that a process iterating from the registered phase identifier resumes operation.

40. The method of claim 1, wherein cooperatively posting data from the private representative states comprises:
delegating performance of cooperative posting to a delegated cooperative posting object,
wherein in response to said delegating, the delegated cooperative posting object performs:
repeatably attempting to obtain a privilege to write to the public data until the privilege is obtained;
writing one or more of the private states to the public data; and
thereupon releasing the privilege to write to the public data,
wherein a duration defined from a first moment when the privilege is obtained until a second moment when the privilege is released extends for no more than a sufficiently minimal duration.

41. The method of claim 40, wherein the delegated cooperative posting object is distinct from a cooperative posting object that performs the delegating step.

42. The method of claim 1, wherein:
one or more of the private representative states embodied in retentive media includes a private work state that represents a present state of processing on the public data;
one or more of the private representative states embodied in retentive media includes a private original state that represents the public data as initially distributed to the private representative states; and
distributing the public data to the private representative states comprises:
distributing a single copy of the public data to an assignment compatible instance of the public data in a local private work area;
distributing the single copy of the public data from the assignment compatible instance of the public data in the local private work area to a remainder of the private representative states;
locally establishing an obligation to post to the public data by detecting a difference between the private original state and the private work state; and
performing cooperative posting to the public data only if the obligation to post to the public data is established.

43. The method of claim 42, further comprising:
updating the private original state to reflect data being posted to the public data.

44. The method of claim 1, further comprising:
storing in the private representative states an auxiliary state that is not representative of the public data, and that is not representative of processing of the public data.

45. The method of claim 44, further comprising using the auxiliary state as part of a process.

46. The method of claim 1, wherein distributing the public data to the private representative states and updating the public data by cooperatively posting data from the private representative states are performed by a cooperative processing object.

47. The method of claim 46, further comprising the cooperative processing object conditionally navigating to a new public data instance based upon successful completion of updating the public data by cooperatively posting data from the private representative states.

48. The method of claim 47, wherein updating the public data by cooperatively posting data from the private representative states is performed in response to a write to public instance event that is invoked by the cooperative processing object in response to detection of an attempted navigation to the new public data instance.

49. The method of claim 1, wherein the private representative states comprise:
a local private work area; and
a remote private work area.

50. The method of claim 1, wherein the public data is stored in a database system.

51. The method of claim 1, wherein distributing the public data to the private representative states and updating the public data by cooperatively posting data from the private representative states are performed by one or more operating system objects.

52. The method of claim 1, further comprising:
a server-side application assigning a unique identification to a client application session;
passing a universal resource indicator to a local application, wherein the universal resource indicator includes the unique identification and a process argument;
associating records of one or more private representative states with the client application session and one or more associated, processed data by means of the unique identification;
passing the universal resource indicator from a client system to the server-side application; and
the server-side system using the universal resource indicator to resume the client application session.

53. The method of claim 52, further comprising:
logging the universal resource indicator to a table in response to the local application requesting a universal resource indicator from the server-side application.

54. The method of claim 53, further comprising:
using the universal resource indicator to identify a last log entry in the table; and
using the identified last log entry in the table to restore a previous, ongoing navigational and/or work status of a local application.

55. The method of claim 54, further comprising:
presenting to the local application a retained history of client navigation.

56. The method of claim 55, wherein the retained history of client navigation is in the form of links comprising one or more universal resource indicators of the history.

57. The method of claim 1, further comprising:
restricting data-oriented operations to permitted, integral data.

58. A machine-readable storage medium having stored thereon one or more instructions for causing a processor to effect a cooperative application development template, the template comprising:
an application abstraction that includes:
logic that interfaces with public data;
logic that interfaces the cooperative application with a private representative state of the public data;
logic that distributes public data to one or more private representative states of the cooperative application; and
logic that makes available to the cooperative application, cooperative posting to the public data of a private representative state,
wherein cooperative posting to the public data of the private representative state comprises:
repeatably attempting to obtain a privilege to write to the public data until the privilege is obtained;
writing the data from the private representative state to the public data; and
thereupon releasing the privilege to write to the public data,
wherein a duration defined from a first moment when the privilege is obtained until a second moment when the privilege is released extends for no more than a sufficiently minimal duration.

59. The machine-readable storage medium of claim 58, wherein the logic that interfaces the cooperative application with the private representative state ensures that a private state generated by the cooperative application is concurrently registered to retentive media.

60. An apparatus for cooperatively processing public data, comprising:
logic that distributes the public data to private representative states;
logic that, without holding an exclusive privilege to write to the public data, generates private states of the public data by processing one or more private representative states of the public data; and
logic that updates the public data by cooperatively posting data from the private representative states.

61. The apparatus of claim 60, further comprising logic that concurrently registers at least one of the one or more generated private states to retentive media.

62. The apparatus of claim 61, wherein said processing of the one or more private representative states of the public data is oriented to a concurrently registered private state, whereby a startup procedure re-triggering any previously running process from a given phase of operation automatically resumes an active process or state, should it be terminated, however inadvertently.

63. The apparatus of claim 61, wherein:
the one or more representative states of the public data are stored in a table.

64. The apparatus of claim 63, further comprising logic that negotiates representative states of the public data by means of any number of identifying fields, classifying states relevant to processing.

65. The apparatus of claim 61, further comprising:
logic that retains one or more of the generated private states in retentive media associated with a remote system.

66. The apparatus of claim 65, wherein the logic that retains one or more of the generated private states in retentive media associated with the remote system operates in response to detecting a write to remotely maintained state event.

67. The apparatus of claim 61, further comprising logic that causes one or more nodes of cooperative applications to register separate copies of one or more private representative states to retentive media in conjunction with registration of a separate copy of the public data to retentive media.

68. The apparatus of claim 60, further comprising:
logic that uses one or more cooperative resource descriptors to negotiate cooperative resources related to public data,
wherein the one or more cooperative resource descriptors relate the cooperative resources to the public data.

69. The apparatus of claim 68, further comprising:
logic that uses a common organization of data processing resources in relation to a public data resource; and
logic that, in response to identifying any one of the one or more cooperative resource descriptors to focusable processes, negotiates the data processing resources designated by the identified cooperative resource descriptor in accordance with the common organization.

70. The apparatus of claim 69, further comprising:
logic that interchangeably focuses processes operating on the organization of data processing resources; and
logic that manages the availability of resources to processes so as to enable a given organization of data processing resources to be negotiated.

71. The apparatus of claim 68, further comprising:
logic that uses a graphic control to invoke a process on a public or private data resource identified by a focused cooperative resource descriptor.

72. The apparatus of claim 68, further comprising logic that automatically focuses an intended cooperative resource descriptor, or organization as indicated by a cooperative resource descriptor, in response to an event or condition devised to be unique and to coincide with demand for resources described by the resource descriptor or belonging to the organization.

73. The apparatus of claim 72, further comprising:
logic that concurrently registers to retentive media an identity of the focused cooperative resource descriptor in response to focusing the cooperative resource descriptor; and
logic that, after termination of the application, initiates a subsequent session of the application, including re-imposing conditions triggering re-focus of the cooperative resources associated by the cooperative resource descriptor;
whereby the subsequent session of the application is automatically restored with a cooperative focus of the application intact.

74. The apparatus of claim 72, further comprising:
logic that concurrently registers to retentive media an identity of a descriptor of interfaces associated with the organization of cooperative resources needed by the interfaces; and
logic that, after termination of the application, initiates a subsequent session of the application, including re-imposing conditions triggering re-focus of the cooperative resources associated by the cooperative resource descriptor;
whereby the subsequent session of the application is automatically restored with a cooperative focus of the application intact.

75. The apparatus of claim 60, wherein:
the private representative states include a private work state embodied in retentive media, that represents a present state of processing on the public data;
the private representative states include a private undo state embodied in retentive media, that represents an earlier state of processing on the public data; and
the apparatus further comprises logic that concurrently registers the private work state to the private undo state.

76. The apparatus of claim 60, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes; and
the apparatus further comprises logic that concurrently registers the private re-do state to the private work state.

77. The apparatus of claim 60, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes;
the private representative states include a private undo state embodied in retentive media, that represents an earlier state of processing on the public data; and
the apparatus further comprises logic that concurrently registers the private work state to the private re-do state, and thereafter concurrently registers the private undo state to the private work state.

78. The apparatus of claim 60, wherein:
the private representative states include a private work state embodied in retentive media, that represents a present state of processing on the public data;
the private representative states include a private original state embodied in retentive media;
the logic that distributes the public data to the private work area includes logic that distributes the public data to the private original state; and
the apparatus further comprises logic that concurrently registers the private original state to the private work state.

79. The apparatus of claim 60, wherein:
the private representative states include a private work state embodied in retentive media, that represents a present state of processing on the public data;
the private representative states include a private original state embodied in retentive media;
the private representative states include one or more other representative states embodied in retentive media; and
the apparatus further comprises logic that assigns the private original state to the one or more other representative states and to the private work state,
wherein the logic that assigns the private original state to the other representative states and to the private work state comprises logic that concurrently registers the private original state to the other representative states, and concurrently registers the private original state to the private work state.

80. The apparatus of claim 60, wherein:
the private representative states are embodied in retentive media; and
the apparatus further comprises logic that, after distributing the public data to the private representative states embodied in retentive media, again distributes the public data to the private representative states embodied in retentive media.

81. The apparatus of claim 60, wherein:
the private representative states are embodied in retentive media; and
the apparatus further comprises logic that, after distributing the public data to the private representative states embodied in retentive media, distributes to the private representative states only those fields of the public data that correspond to unmodified fields of the private representative states.

82. The apparatus of claim 81, wherein:
one or more of the private representative states embodied in retentive media include a private work state that represents a present state of processing on the public data; and
the apparatus further comprises:
logic that detects that a field of the private work state is presently under processing, and in response thereto treats said field of the private work state as a modified field of the private representative states.

83. The apparatus of claim 60, wherein:
the private representative states includes a private work state that represents a present state of processing on the public data;
the private representative states includes a private original state;
the logic that distributes the public data to the private representative states includes logic that distributes the public data to the private original state; and
the logic that updates the public data by cooperatively posting data from the private representative states comprises logic that compares the private work state to the private original state and cooperatively posts to the public data only those fields of the private work state which differ from corresponding fields of the private original state.

84. The apparatus of claim 83, wherein the private work state and the private original state are embodied in retentive media.

85. The apparatus of claim 83, further comprising:
logic that, prior to updating the public data, updates the private original state to reflect data previously posted to the public data.

86. The apparatus of claim 83, wherein the logic that cooperatively posts to the public data only those fields of the private work state that differ from corresponding fields of the private original state comprises:
logic that repeatably attempts to obtain a privilege to write to the public data until the privilege is obtained;
logic that writes differentiated fields of the private work state to the public data; and
logic that thereupon releases the privilege to write to the public data,
wherein a duration defined from a first moment when the privilege is obtained until a second moment when the privilege is released extends for no more than a sufficiently minimal duration.

87. The apparatus of claim 86, wherein the apparatus further comprises:
logic that writes to the private original state, data written to the public data.

88. The apparatus of claim 60, wherein:
one or more of the private representative states includes a private work state that represents a present state of processing on the public data;
one or more of the private representative states includes a private last posted state;
the logic that distributes the public data to the private representative states embodied in retentive media includes logic that distributes the public data to the private last posted state; and
the logic that updates the public data by cooperatively posting data from the private representative states comprises logic that compares the private work state to the private last posted state, cooperatively posts to the public data only those fields of the private work state which differ from corresponding fields of the private last posted state, and thereupon assigns to the last posted state, fields posted to the public data.

89. The apparatus of claim 88, wherein the private work state and the private last posted state are embodied in retentive media.

90. The apparatus of claim 88, wherein the logic that cooperatively posts to the public data only those fields of the private work state that differ from corresponding fields of the private last posted state comprises:
logic that repeatably attempts to obtain a privilege to write to the public data until the privilege is obtained;
logic that writes differentiated fields of the private work state to the public data; and
logic that thereupon releases the privilege to write to the public data,
wherein a duration defined from a first moment when the privilege is obtained until a second moment when the privilege is released extends for no more than a sufficiently minimal duration.

91. The apparatus of claim 90, wherein the method further comprises:
logic that writes to the private last posted state, data written to the public data.

92. The apparatus of claim 60, wherein the logic that cooperatively posts data from the private representative states comprises:
logic that obtains a privilege to write to the public data;
logic that writes the data from the private representative states to the public data; and
logic that thereupon releases the privilege to write to the public data,
wherein a duration defined from a first moment when the privilege is obtained until a second moment when the privilege is released extends for no more than a sufficiently minimal duration.

93. The apparatus of claim 92, wherein the logic that obtains the privilege to write to the public data comprises:
logic that repeatably attempts to obtain the privilege to write to the public data until the privilege is obtained.

94. The apparatus of claim 92, further comprising logic that delegates performance of obtaining the privilege to write to the public data to a cooperative processing object.

95. The apparatus of claim 92, further comprising:
logic that delegates, to a cooperative processing object, performance of obtaining the privilege to write to the public data, performance of writing the data from the private representative states to the public data, and performance of releasing the privilege to write to the public data; and
the cooperative processing object, wherein the cooperative processing object further delegates, to a delegated cooperative processing object, performance of obtaining the privilege to write to the public data, performance of writing the data from the private representative states to the public data, and performance of releasing the privilege to write to the public data.

96. The apparatus of claim 95, further comprising:
logic that detects that performance of obtaining the privilege to write to the public data, performance of writing the data from the private representative states to the public data, and performance of releasing the privilege to write to the public data have been successfully delegated to the delegated cooperative processing object, and in response thereto, causes the cooperative processing object to pass control to a subsequent phase of processing.

97. The apparatus of claim 96, further comprising:
logic that concurrently registers a phase identifier to retentive media so that a process iterating from the registered phase identifier resumes operation.

98. The apparatus of claim 95, further comprising:
logic that concurrently registers a phase identifier to retentive media so that a process iterating from the registered phase identifier resumes operation.

99. The apparatus of claim 60, wherein the logic that cooperatively posts data from the private representative states comprises:
logic that delegates performance of cooperative posting to a delegated cooperative posting object; and
the delegated cooperative posting object,
wherein in response to said delegating, the delegated cooperative posting object performs:
repeatably attempting to obtain a privilege to write to the public data until the privilege is obtained;
writing one or more of the private states to the public data; and
thereupon releasing the privilege to write to the public data,
wherein a duration defined from a first moment when the privilege is obtained until a second moment when the privilege is released extends for no more than a sufficiently minimal duration.

100. The apparatus of claim 99, wherein the delegated cooperative posting object is distinct from a cooperative posting object that performs the delegating step.

101. The apparatus of claim 60, wherein:
one or more of the private representative states embodied in retentive media includes a private work state that represents a present state of processing on the public data;
one or more of the private representative states embodied in retentive media includes a private original state that represents the public data as initially distributed to the private representative states; and
the logic that distributes the public data to the private representative states comprises:
logic that distributes a single copy of the public data to an assignment compatible instance of the public data in a local private work area;
logic that distributes the single copy of the public data from the assignment compatible instance of the public data in the local private work area to a remainder of the private representative states;
logic that locally establishes an obligation to post to the public data by detecting a difference between the private original state and the private work state; and
logic that performs cooperative posting to the public data only if the obligation to post to the public data is established.

102. The apparatus of claim 101, further comprising:
logic that updates the private original state to reflect data being posted to the public data.

103. The apparatus of claim 60, further comprising:
logic that stores in the private representative states an auxiliary state that is not representative of the public data, and that is not representative of processing of the public data.

104. The apparatus of claim 103, further comprising logic that uses the auxiliary state as part of a process.

105. The apparatus of claim 60, further comprising a cooperative processing object that comprises the logic that distributes the public data to the private representative states and the logic that updates the public data by cooperatively posting data from the private representative states.

106. The apparatus of claim 105, wherein the cooperative processing object further comprises logic that conditionally navigates to a new public data instance based upon successful completion of updating the public data by cooperatively posting data from the private representative states.

107. The apparatus of claim 106, wherein the logic that updates the public data by cooperatively posting data from the private representative states operates in response to a write to public instance event that is invoked by the cooperative processing object in response to detection of an attempted navigation to the new public data instance.

108. The apparatus of claim 60, wherein the private representative states comprise:
a local private work area; and
a remote private work area.

109. The apparatus of claim 60, wherein the public data is stored in a database system.

110. The apparatus of claim 60, comprising one or more operating system objects that include the logic that distribute the public data to the private representative states and the logic that updates the public data by cooperatively posting data from the private representative states.

111. The apparatus of claim 60, further comprising:
a server-side application that assigns a unique identification to a client application session;
logic that passes a universal resource indicator to a local application, wherein the universal resource indicator includes the unique identification and a process argument;
logic that associates records of one or more private representative states with the client application session and one or more associated, processed data by means of the unique identification; and
logic that passes the universal resource indicator from a client system to the server-side application,
wherein the server-side system further comprises logic that uses the universal resource indicator to resume the client application session.

112. The apparatus of claim 111, further comprising:
logic that logs the universal resource indicator to a table in response to the local application requesting a universal resource indicator from the server-side application.

113. The apparatus of claim 112, further comprising:
logic that uses the universal resource indicator to identify a last log entry in the table; and
logic that uses the identified last log entry in the table to restore a previous, ongoing navigational and/or work status of a local application.

114. The apparatus of claim 113, further comprising:
logic that presents to the local application a retained history of client navigation.

115. The apparatus of claim 114, wherein the retained history of client navigation is in the form of links comprising one or more universal resource indicators of the history.

116. The apparatus of claim 60, further comprising:
logic that restricts data-oriented operations to permitted, integral data.

117. A machine-readable storage medium having stored thereon one or more instructions for causing a processor to cooperatively process public data by performing:
distributing the public data to private representative states;
without holding an exclusive privilege to write to the public data, generating private states of the public data by processing one or more private representative states of the public data; and
updating the public data by cooperatively posting data from the private representative states.

118. The machine-readable storage medium of claim 117, wherein the one or more instructions further cause the processor to perform concurrently registering at least one of the one or more generated private states to retentive media.

119. The machine-readable storage medium of claim 118, wherein said processing of the one or more private representative states of the public data is oriented to a concurrently registered private state, whereby a startup procedure re-triggering any previously running process from a given phase of operation automatically resumes an active process or state, should it be terminated, however inadvertently.

120. The machine-readable storage medium of claim 118, wherein:
the one or more private representative states of the public data are stored in a table.

121. The machine-readable storage medium of claim 120, wherein the one or more instructions further cause the processor to perform negotiating private representative states of the public data by means of any number of identifying fields, classifying states relevant to processing.

122. The machine-readable storage medium of claim 118, wherein the one or more instructions further cause the processor to perform:
retaining one or more of the generated private states in retentive media associated with a remote system.

123. The machine-readable storage medium of claim 122, wherein retaining one or more of the generated private states in retentive media associated with the remote system is performed in response to detecting a write to remotely maintained state event.

124. The machine-readable storage medium of claim 118, wherein the one or more instructions further cause the processor to perform causing one or more nodes of cooperative applications to register separate copies of one or more private representative states to retentive media in conjunction with registration of a separate copy of the public data to retentive media.

125. The machine-readable storage medium of claim 117, wherein the one or more instructions further cause the processor to perform:
using one or more cooperative resource descriptors to negotiate cooperative resources related to public data,
wherein the one or more cooperative resource descriptors relate the cooperative resources to the public data.

126. The machine-readable storage medium of claim 125, wherein the one or more instructions further cause the processor to perform:
using a common organization of data processing resources in relation to a public data resource; and
in response to identifying any one of the one or more cooperative resource descriptors to focusable processes, negotiating the data processing resources designated by the identified cooperative resource descriptor in accordance with the common organization.

127. The machine-readable storage medium of claim 126, wherein the one or more instructions further cause the processor to perform:
interchangeably focusing processes operating on the organization of data processing resources; and
managing the availability of resources to processes so as to enable a given organization of data processing resources to be negotiated.

128. The machine-readable storage medium of claim 125, wherein the one or more instructions further cause the processor to perform:
using a graphic control to invoke a process on a public or private data resource identified by a focused cooperative resource descriptor.

129. The machine-readable storage medium of claim 125, wherein the one or more instructions cause the processor to perform automatically focusing an intended cooperative resource descriptor, or organization as indicated by a cooperative resource descriptor, in response to an event or condition devised to be unique and to coincide with demand for resources described by the resource descriptor or belonging to the organization.

130. The machine-readable storage medium of claim 129, wherein the one or more instructions further cause the processor to perform:
concurrently registering to retentive media an identity of the focused cooperative resource descriptor in response to focusing the cooperative resource descriptor; and
after termination of the application, initiating a subsequent session of the application, including re-imposing conditions triggering re-focus of the cooperative resources associated by the cooperative resource descriptor;
whereby the subsequent session of the application is automatically restored with a cooperative focus of the application intact.

131. The machine-readable storage medium of claim 129, wherein the one or more instructions further cause the processor to perform:
concurrently registering to retentive media an identity of a descriptor of interfaces associated with the organization of cooperative resources needed by the interfaces; and
after termination of the application, initiating a subsequent session of the application, including re-imposing conditions triggering re-focus of the cooperative resources associated by the cooperative resource descriptor;
whereby the subsequent session of the application is automatically restored with a cooperative focus of the application intact.

132. The machine-readable storage medium of claim 1, wherein:
the private representative states include a private work state embodied in retentive media, that represents a present state of processing on the public data;
the private representative states include a private undo state embodied in retentive media, that represents an earlier state of processing on the public data; and
the one or more instructions further cause the processor to perform concurrently registering the private work state to the private undo state.

133. The machine-readable storage medium of claim 117, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes; and
the one or more instructions further cause the processor to perform concurrently registering the private re-do state to the private work state.

134. The machine-readable storage medium of claim 117, wherein:
the private representative states include a private work state embodied in retentive media, that represents a present state of processing on the public data;
the private representative states include a private re-do state embodied in retentive media, that represents an earlier state of processing that, if an undo process was performed, existed just prior to performance of an undo process, or otherwise exists as originally distributed and potentially modified thereafter by other processes;
the private representative states include a private undo state embodied in retentive media, that represents an earlier state of processing on the public data; and
the one or more instructions further cause the processor to perform concurrently registering the private work state to the private re-do state, and thereafter concurrently registering the private undo state to the private work state.

135. The machine-readable storage medium of claim 117, wherein:
the private representative states include a private work state embodied in retentive media, that represents a present state of processing on the public data;
the private representative states include a private original state embodied in retentive media;
distributing the public data to the private work area includes distributing the public data to the private original state; and
the one or more instructions further cause the processor to perform concurrently registering the private original state to the private work state.

136. The machine-readable storage medium of claim 117, wherein:
the private representative states include a private work state embodied in retentive media, that represents a present state of processing on the public data;
the private representative states include a private original state embodied in retentive media;
the private representative states include one or more other representative states embodied in retentive media; and
the one or more instructions further cause the processor to perform assigning the private original state to the one or more other representative states and to the private work state,
wherein assigning the private original state to the other representative states comprises concurrently registering the private original state to the other representative states, and assigning the private original state to the private work state comprises concurrently registering the private original state to the private work state.

137. The machine-readable storage medium of claim 117, wherein:
the private representative states are embodied in retentive media; and
the one or more instructions further cause the processor to perform, after distributing the public data to the private representative states embodied in retentive media, again distributing the public data to the private representative states embodied in retentive media.

138. The machine-readable storage medium of claim 117, wherein:
the private representative states are embodied in retentive media; and
the one or more instructions further cause the processor to perform, after distributing the public data to the private representative states embodied in retentive media, distributing to the private representative states only those fields of the public data that correspond to unmodified fields of the private representative states.

139. The machine-readable storage medium of claim 138, wherein:
one or more of the private representative states embodied in retentive media include a private work state that represents a present state of processing on the public data; and
the one or more instructions further cause the processor to perform:
detecting that a field of the private work state is presently under processing, and in response thereto treating said field of the private work state as a modified field of the private representative states.

140. The machine-readable storage medium of claim 117, wherein:
the private representative states includes a private work state that represents a present state of processing on the public data;
the private representative states includes a private original state;
distributing the public data to the private representative states includes distributing the public data to the private original state; and
updating the public data by cooperatively posting data from the private representative states comprises comparing the private work state to the private original state and cooperatively posting to the public data only those fields of the private work state which differ from corresponding fields of the private original state.

141. The machine-readable storage medium of claim 140, wherein the private work state and the private original state are embodied in retentive media.

142. The machine-readable storage medium of claim 140, wherein the one or more instructions further cause the processor to perform:
prior to updating the public data, updating the private original state to reflect data previously posted to the public data.

143. The machine-readable storage medium of claim 140, wherein cooperatively posting to the public data only those fields of the private work state that differ from corresponding fields of the private original state comprises:
repeatably attempting to obtain a privilege to write to the public data until the privilege is obtained;
writing differentiated fields of the private work state to the public data; and
thereupon releasing the privilege to write to the public data,
wherein a duration defined from a first moment when the privilege is obtained until a second moment when the privilege is released extends for no more than a sufficiently minimal duration.

144. The machine-readable storage medium of claim 143, wherein the one or more instructions further cause the processor to perform:
writing to the private original state, data written to the public data.

145. The machine-readable storage medium of claim 117, wherein:
one or more of the private representative states includes a private work state that represents a present state of processing on the public data;
one or more of the private representative states includes a private last posted state;
distributing the public data to the private representative states embodied in retentive media includes distributing the public data to the private last posted state; and
updating the public data by cooperatively posting data from the private representative states comprises comparing the private work state to the private last posted state, cooperatively posting to the public data only those fields of the private work state which differ from corresponding fields of the private last posted state, and thereupon assigning to the last posted state, fields posted to the public data.

146. The machine-readable storage medium of claim 145, wherein the private work state and the private last posted state are embodied in retentive media.

147. The machine-readable storage medium of claim 145, wherein cooperatively posting to the public data only those fields of the private work state that differ from corresponding fields of the private last posted state comprises:
repeatably attempting to obtain a privilege to write to the public data until the privilege is obtained;
writing differentiated fields of the private work state to the public data; and
thereupon releasing the privilege to write to the public data,
wherein a duration defined from a first moment when the privilege is obtained until a second moment when the privilege is released extends for no more than a sufficiently minimal duration.

148. The machine-readable storage medium of claim 147, wherein the one or more instructions further cause the processor to perform:
writing to the private last posted state, data written to the public data.

149. The machine-readable storage medium of claim 117, wherein cooperatively posting data from the private representative states comprises:
obtaining a privilege to write to the public data;
writing the data from the private representative states to the public data; and
thereupon releasing the privilege to write to the public data,
wherein a duration defined from a first moment when the privilege is obtained until a second moment when the privilege is released extends for no more than a sufficiently minimal duration.

150. The machine-readable storage medium of claim 149, wherein obtaining the privilege to write to the public data comprises:
repeatably attempting to obtain the privilege to write to the public data until the privilege is obtained.

151. The machine-readable storage medium of claim 149, wherein the one or more instructions further cause the processor to perform delegating performance of obtaining the privilege to write to the public data to a cooperative processing object.

152. The machine-readable storage medium of claim 149, wherein the one or more instructions further cause the processor to perform:
delegating, to a cooperative processing object, performance of obtaining the privilege to write to the public data, performance of writing the data from the private representative states to the public data, and performance of releasing the privilege to write to the public data; and
the cooperative processing object further delegating, to a delegated cooperative processing object, performance of obtaining the privilege to write to the public data, performance of writing the data from the private representative states to the public data, and performance of releasing the privilege to write to the public data.

153. The machine-readable storage medium of claim 152, wherein the one or more instructions further cause the processor to perform:
detecting that performance of obtaining the privilege to write to the public data, performance of writing the data from the private representative states to the public data, and performance of releasing the privilege to write to the public data have been successfully delegated to the delegated cooperative processing object, and in response thereto, the cooperative processing object passing control to a subsequent phase of processing.

154. The machine-readable storage medium of claim 153, wherein the one or more instructions further cause the processor to perform:
concurrently registering a phase identifier to retentive media so that a process iterating from the registered phase identifier resumes operation.

155. The machine-readable storage medium of claim 152, wherein the one or more instructions further cause the processor to perform:
concurrently registering a phase identifier to retentive media so that a process iterating from the registered phase identifier resumes operation.

156. The machine-readable storage medium of claim 117, wherein cooperatively posting data from the private representative states comprises:
delegating performance of cooperative posting to a delegated cooperative posting object,
wherein in response to said delegating, the delegated cooperative posting object performs:
repeatably attempting to obtain a privilege to write to the public data until the privilege is obtained;
writing one or more of the private states to the public data; and
thereupon releasing the privilege to write to the public data,
wherein a duration defined from a first moment when the privilege is obtained until a second moment when the privilege is released extends for no more than a sufficiently minimal duration.

157. The machine-readable storage medium of claim 156, wherein the delegated cooperative posting object is distinct from a cooperative posting object that performs the delegating step.

158. The machine-readable storage medium of claim 117, wherein:
one or more of the private representative states embodied in retentive media includes a private work state that represents a present state of processing on the public data;
one or more of the private representative states embodied in retentive media includes a private original state that represents the public data as initially distributed to the private representative states; and
distributing the public data to the private representative states comprises:
distributing a single copy of the public data to an assignment compatible instance of the public data in a local private work area;
distributing the single copy of the public data from the assignment compatible instance of the public data in the local private work area to a remainder of the private representative states;
locally establishing an obligation to post to the public data by detecting a difference between the private original state and the private work state; and
performing cooperative posting to the public data only if the obligation to post to the public data is established.

159. The machine-readable storage medium of claim 158, wherein the one or more instructions further cause the processor to perform:
updating the private original state to reflect data being posted to the public data.

160. The machine-readable storage medium of claim 117, wherein the one or more instructions further cause the processor to perform:
storing in the private representative states an auxiliary state that is not representative of the public data, and that is not representative of processing of the public data.

161. The machine-readable storage medium of claim 160, wherein the one or more instructions further cause the processor to perform using the auxiliary state as part of a process.

162. The machine-readable storage medium of claim 117, wherein distributing the public data to the private representative states and updating the public data by cooperatively posting data from the private representative states are performed by a cooperative processing object.

163. The machine-readable storage medium of claim 162, wherein the one or more instructions further cause the processor to perform: the cooperative processing object conditionally navigating to a new public data instance based upon successful completion of updating the public data by cooperatively posting data from the private representative states.

164. The machine-readable storage medium of claim 163, wherein updating the public data by cooperatively posting data from the private representative states is performed in response to a write to public instance event that is invoked by the cooperative processing object in response to detection of an attempted navigation to the new public data instance.

165. The machine-readable storage medium of claim 117, wherein the private representative states comprise:
a local private work area; and
a remote private work area.

166. The machine-readable storage medium of claim 117, wherein the public data is stored in a database system.

167. The machine-readable storage medium of claim 117, wherein distributing the public data to the private representative states and updating the public data by cooperatively posting data from the private representative states are performed by one or more operating system objects.

168. The machine-readable storage medium of claim 117, wherein the one or more instructions further cause the processor to perform:
a server-side application assigning a unique identification to a client application session;
passing a universal resource indicator to a local application, wherein the universal resource indicator includes the unique identification and a process argument;
associating records of one or more private representative states with the client application session and one or more associated, processed data by means of the unique identification;
passing the universal resource indicator from a client system to the server-side application; and
the server-side system using the universal resource indicator to resume the client application session.

169. The machine-readable storage medium of claim 168, further comprising:
logging the universal resource indicator to a table in response to the local application requesting a universal resource indicator from the server-side application.

170. The machine-readable storage medium of claim 169, wherein the one or more instructions further cause the processor to perform:
using the universal resource indicator to identify a last log entry in the table; and
using the identified last log entry in the table to restore a previous, ongoing navigational and/or work status of a local application.

171. The machine-readable storage medium of claim 170, wherein the one or more instructions further cause the processor to perform:
presenting to the local application a retained history of client navigation.

172. The machine-readable storage medium of claim 171, wherein the retained history of client navigation is in the form of links comprising one or more universal resource indicators of the history.

173. The machine-readable storage medium of claim 117, wherein the one or more instructions further cause the processor to perform:
restricting data-oriented operations to permitted, integral data.
